(19) United States
(12) Patent Application Publication
(10) Pub. No.: US 2024/0416241 A1
(43) Pub. Date: Dec. 19, 2024

(54) NON-TRANSITORY COMPUTER READABLE MEDIUM, INFORMATION PROCESSING METHOD, AND GAMING DEVICE

(71) Applicant: CYGAMES, INC., Tokyo (JP)

(72) Inventors: Kosuke Hirahata, Tokyo (JP); Yuki Tamura, Tokyo (JP); Yujiro Deguchi, Tokyo (JP)

(73) Assignee: CYGAMES, INC., Tokyo (JP)

(21) Appl. No.: 18/817,863

(22) Filed: Aug. 28, 2024

Related U.S. Application Data
(63) Continuation of application No. PCT/JP2023/005484, filed on Feb. 16, 2023.

(30) Foreign Application Priority Data
Mar. 17, 2022 (JP) 2022-043027

(51) Int. Cl. A63F 13/58; A63F 13/45; A63F 13/69; A63F 13/825

(52) U.S. Cl. CPC A63F 13/58; A63F 13/45; A63F 13/69; A63F 13/825

(57) ABSTRACT

A non-transitory computer readable medium stores a program causing a computer to execute: setting, in each of a plurality of turns in a training game, a plurality of commands that can be selected by a player; associating one or more game mediums associated with character identification information with one or more of the plurality of commands; updating a parameter of a training target character based on a command selected by the player among the plurality of commands and a game medium associated with the command selected by the player; starting a bonus state when a command associated with a prescribed game medium is selected; and causing, based on the selection of the command associated with the prescribed game medium during the bonus state, a bonus event including the execution of a bonus visual effect and the imparting of a bonus to occur.

### CROSS REFERENCE TO RELATED APPLICATIONS

This application is a continuation application of International Application No. PCT/JP2023/005484, filed on Feb. 16, 2023, which claims priority to Japanese Patent Application No. 2022-043027, filed on Mar. 17, 2022, the entire contents of which are incorporated by reference herein.

### BACKGROUND ART

### Technical Field

The present invention relates to an information processing program, an information processing method, and a gaming device.

In the related art, there is a known game in the genre referred to as training games, as indicated in, for example, Patent Literature 1. In a training game, multiple types of training categories are provided and a player can train a training target character by selecting one of the training categories.

In addition, in the training game disclosed in Patent Literature 1, the player can also include support cards in a deck. One support character is linked to a support card, and, when prescribed conditions are met during the training game, an event in which the support character appears occurs.

### CITATION LIST

### Patent Literature

Patent Literature 1: JP 6563579 B

### SUMMARY OF INVENTION

### Technical Problem

In the above-described training game, options for the player when organizing the deck tend to be limited. As a result, even if the game is repeatedly played, there is no considerable difference in the game development, and thus, there is a problem in that the motivation to play the game decreases.

An object of the present invention is to provide an information processing program, an information processing method, and a gaming device with which it is possible to diversify the game development and to enhance the play motivation of a player.

### Solution to Problem

In order to solve the above-described problem, provided is an information processing program that causes a computer to execute:
processing for allowing, in a training game constituted of a plurality of turns, a player to select a plurality of commands in each turn;
processing for associating a game medium associated with character identification information with one of the plurality of commands;
processing for updating a parameter of a training target character on the basis of one of the commands that the player has selected and the game medium associated with the selected command;
processing for starting a bonus state when start conditions that include at least that the command associated with the prescribed game medium is selected are met; and
processing for causing, on the basis of the selection of the command associated with the prescribed game medium during the bonus state, a bonus event including the execution of a bonus visual effect and the imparting of a bonus to occur.

The information processing program may additionally cause a computer to execute
processing for determining, in the case in which the bonus event occurs, one of a plurality of characters associated with the prescribed game medium to be the character to be displayed in the bonus visual effect.

The information processing program may additionally cause a computer to execute
processing for canceling the setting of a specific section when ending conditions that include at least that a prescribed number of the turns have passed from when the bonus state is set are met.

The information processing program may additionally cause a computer to execute:
processing for updating a specific parameter on the basis of the selection of the command associated with the prescribed game medium; and
processing for determining whether or not to start the bonus state on the basis of the value of the specific parameter, wherein
the processing for starting the bonus state may start the specific section assuming that the start conditions are met in the case in which it is determined that the bonus state starts.

In order to solve the above-described problem, provided is an information processing method executed by one or a plurality of computers, wherein the computers execute:
processing for allowing, in a training game constituted of a plurality of turns, a player to select a plurality of commands in each turn;
processing for associating a game medium associated with character identification information with one of the plurality of commands;
processing for updating a parameter of a training target character on the basis of one of the commands that the player has selected and the game medium associated with the selected command;
processing for starting a bonus state when start conditions that include at least that the command associated with the prescribed game medium is selected are met; and
processing for causing, on the basis of the selection of the command associated with the prescribed game medium during the bonus state, a bonus event including the execution of a bonus visual effect and the imparting of a bonus to occur.

In order to solve the above-described problem, provided is a gaming device in which one or a plurality of computers execute:
processing for allowing, in a training game constituted of a plurality of turns, a player to select a plurality of commands in each turn;
processing for associating a game medium associated with character identification information with one of the plurality of commands;
processing for updating a parameter of a training target character on the basis of one of the commands that the player has selected and the game medium associated with the selected command;
processing for starting a bonus state when start conditions that include at least that the command associated with the prescribed game medium is selected are met; and
processing for causing, on the basis of the selection of the command associated with the prescribed game medium during the bonus state, a bonus event including the execution of a bonus visual effect and the imparting of a bonus to occur.

### Effects of Disclosure

With the present invention, it is possible to diversity the game development and enhance the play motivation of a player.

### BRIEF DESCRIPTION OF DRAWINGS

FIG. 1 is an explanatory diagram showing, in outline, the configuration of an information processing system.

FIG. 2A is a diagram for explaining the hardware configuration of a player terminal. FIG. 2B is a diagram for explaining the hardware configuration of a server.

FIG. 3A is a diagram for explaining an example of a home screen. FIG. 3B is a diagram for explaining an example of an option setting screen. FIG. 3C is a diagram for explaining an example of a profile setting screen. FIG. 3D is a diagram for explaining an example of a home setting screen.

FIG. 4 is a diagram for explaining a flow of rough proceeding of a training game.

FIG. 5A is a diagram for explaining a training target character selection screen. FIG. 5B is a first diagram for explaining a character detail screen. FIG. 5C is a second diagram for explaining the character detail screen.

FIG. 6A is a diagram for explaining an ability parameter (initial value) table. FIG. 6B is a diagram for explaining an aptitude parameter (initial value) table. FIG. 6C is a diagram for explaining a skill table. FIG. 6D is a diagram for explaining a character-owned event table.

FIG. 7A is a first diagram for explaining an inheritance-character selection screen. FIG. 7B is a first diagram for explaining a trained character list screen. FIG. 7C is a second diagram for explaining the inheritance-character selection screen. FIG. 7D is a third diagram for explaining the inheritance-character selection screen.

FIG. 8 is a diagram for explaining an inheritance lineage.

FIG. 9 is a diagram for explaining factor information.

FIG. 10A is a diagram for explaining a compatibility determination subject and FIG. 10B is a diagram for explaining compatibility determination items.

FIG. 11A is a diagram for explaining sorting conditions. FIG. 11B is a diagram for explaining refining conditions.

FIG. 12 is a first diagram for explaining a character detail dialog.

FIG. 13 is a second diagram for explaining the character detail dialog.

FIG. 14 is a third diagram for explaining the character detail dialog.

FIG. 15 is a diagram for explaining a skill display dialog.

FIG. 16A is a first diagram for explaining a support-card organization screen. FIG. 16B is a diagram for explaining a support-card selection screen. FIG. 16C is a second diagram for explaining the support-card organization screen.

FIG. 17A is a diagram for explaining a support card table. FIG. 17B is a diagram for explaining a support effect table. FIG. 17C is a diagram for explaining an owned skill table. FIG. 17D is a diagram for explaining a support event table.

FIG. 18A is a diagram for explaining a final confirmation screen. FIG. 18B is a diagram for explaining a preset selection screen.

FIG. 19 is a diagram for explaining a selection item table.

FIG. 20A is a diagram for explaining a game screen. FIG. 20B is a diagram for explaining a special race screen.

FIG. 21A is a first diagram for explaining a training screen. FIG. 21B is a second diagram for explaining the training screen. FIG. 21C is a diagram for explaining a training result notification screen. FIG. 21D is a diagram for explaining an event screen.

FIG. 22A is a first diagram for explaining an inheritance event. FIG. 22B is a second diagram for explaining the inheritance event. FIG. 22C is a third diagram for explaining the inheritance event. FIG. 22D is a fourth diagram for explaining the inheritance event.

FIG. 23A is a first diagram for explaining a skill screen. FIG. 23B is a second diagram for explaining the skill screen.

FIG. 24A is a first diagram for explaining an outing screen. FIG. 24B is a diagram for explaining a friend outing event screen.

FIG. 25 is a diagram for explaining execution patterns of friend outing events.

FIG. 26A is a second diagram for explaining the outing screen. FIG. 26B is a third diagram for explaining the outing screen. FIG. 26C is a fourth diagram for explaining the outing screen.

FIG. 27A is a first diagram for explaining an affiliated-character event screen. FIG. 27B is a second diagram for explaining the affiliated-character event screen. FIG. 27C is a first diagram for explaining an all-affiliated-character event screen. FIG. 27D is a second diagram for explaining the all-affiliated-character event screen.

FIG. 28 is a diagram for explaining execution patterns of affiliated character events and an all-affiliated-character event.

FIG. 29A is a first diagram for explaining an individual-race selection screen. FIG. 29B is a diagram for explaining an individual-race start screen. FIG. 29C is a first diagram for explaining an individual-race result screen. FIG. 29D is a second diagram for explaining the individual-race result screen.

FIG. 30 is a diagram for explaining an example of an item exchange screen.

FIG. 31 is a diagram for explaining a rough flow of turn-start processing.

FIG. 32 is a diagram for explaining a deployment table.

FIG. 33A is a diagram for explaining a training level table. FIG. 33B is a diagram for explaining a fixed increase amount (speed) table. In addition, FIG. 33C is a diagram for explaining a fixed increase amount table (power). FIG. 33D is a diagram for explaining a bonus addition rate.

FIG. 34 is a diagram for explaining a second event table.

FIG. 35 is a diagram for explaining an event associated with a group support card.

FIG. 36 is a diagram for explaining a bonus zone.

FIG. 37A is a diagram for explaining a deployed character icon of the group support card. FIG. 37B is a diagram for explaining a bonus visual effect.

FIG. 38 is a diagram for explaining a deployment table.

FIG. 39A is a diagram for explaining a notification about the rival-character deployment on the game screen. FIG. 39B is a diagram for explaining a notification about the rival-character deployment on the individual-race selection screen.

FIG. 40A is a first diagram for explaining a training completion screen. FIG. 40B is a second diagram for explaining the training completion screen. FIG. 40C is a third diagram for explaining the training completion screen.

FIG. 41 is a diagram for explaining the memory configuration of a player terminal and functions thereof as a computer.

FIG. 42 is a diagram for explaining the memory configuration of a server and functions thereof as a computer.

FIG. 43 is a sequence diagram for explaining processing in the player terminal and the server related to a training game.

FIG. 44 is a flowchart for explaining training stage processing in the server.

FIG. 45 is a flowchart for explaining turn-start processing in the server.

FIG. 46 is a flowchart for explaining friendship-training determination processing in the server.

FIG. 47 is a flowchart for explaining training stage processing in the player terminal.

FIG. 48 is a flowchart for explaining turn-start processing in the player terminal.

FIG. 49 is a flowchart for explaining during-turn processing in the server.

FIG. 50 is a flowchart for explaining outing selection processing in the server.

FIG. 51 is a flowchart for explaining outing-related-event execution processing in the server.

FIG. 52 is a flowchart for explaining bonus-zone setting processing in the server.

FIG. 53 is a flowchart for explaining during-turn processing in the player terminal.

### DESCRIPTION OF EMBODIMENT

An aspect of an embodiment of the present invention will be described below with reference to the drawings. Values, etc. indicated in said embodiment are merely examples for facilitating understanding, and do not limit the present invention unless otherwise specifically mentioned. Note that, in the present description and the drawings, elements having substantially the same functions and configurations have the same reference signs attached thereto and are not described repeatedly, and, in addition, elements that are not directly relevant to the present invention are not shown.

### (Overall Configuration of Information Processing System S)

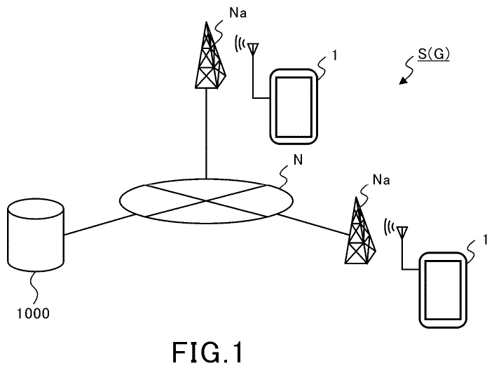

FIG. 1 is an explanatory diagram showing, in outline, the configuration of an information processing system S. The information processing system S is a so-called client server system including player terminals 1 that serve as clients, in other words, game terminals, a server 1000, and a communication network N having communication base stations Na.

In the information processing system S of this embodiment, the player terminals 1 and the server 1000 serve as a game device G. Functions in game proceeding control are respectively allocated to the player terminals 1 and the server 1000 and a game can proceed as a result of cooperation between the player terminals 1 and the server 1000.

The player terminals 1 can establish communication with the server 1000 via the communication network N. The player terminals 1 include a wide range of electronic appliances that are capable of communicatively connecting to the server 1000 in a wireless or wired manner. Examples of the player terminals 1 include smartphones, mobile phones, tablet devices, personal computers, and game machines. This embodiment will be described in the context of a case where smartphones are used as the player terminals 1.

The server 1000 is communicatively connected to the plurality of player terminals 1. The server 1000 accumulates various kinds of information for each player who plays the game. In addition, the server 1000 performs, mainly on the basis of operations input from the player terminals 1, processing such as updating of the accumulated information and causing the player terminals 1 to download images and various kinds of information.

The communication base stations Na are connected to the communication network N and transmit information to and receive information from the player terminals 1 in a wireless manner. The communication network N consists of a mobile phone network, an internet network, a local area network (LAN), a dedicated line, or the like and realizes wireless or wired communication connection between the player terminals 1 and the server 1000.

### (Hardware Configurations of Player Terminal 1 and Server 1000)

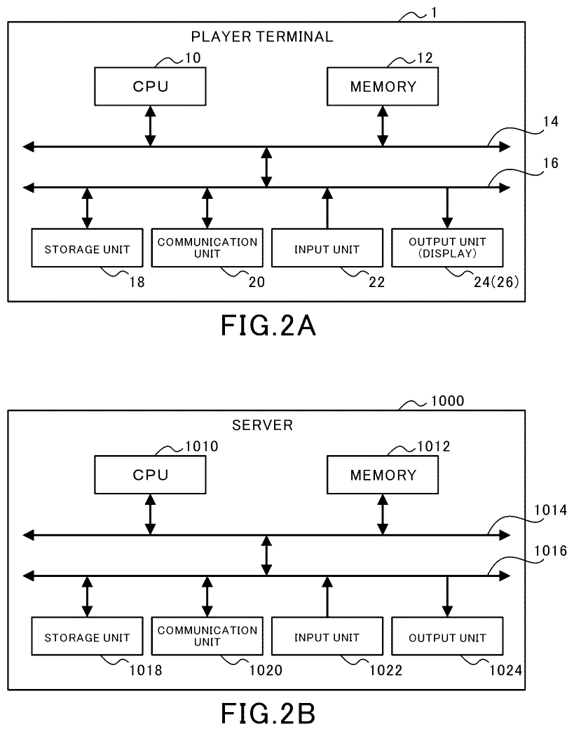

FIG. 2A is a diagram for explaining the hardware configuration of a player terminal 1. In addition, FIG. 2B is a diagram for explaining the hardware configuration of the server 1000. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

In addition, as shown in FIG. 2B, the server 1000 is configured to include a CPU 1010, a memory 1012, a bus 1014, an input/output interface 1016, a storage unit 1018, a communication unit 1020, an input unit 1022, and an output unit 1024.

Note that the configurations and functions of the CPU 1010, the memory 1012, the bus 1014, the input/output interface 1016, the storage unit 1018, the communication unit 1020, the input unit 1022, and the output unit 1024 of the server 1000 are substantially the same as those of the CPU 10, the memory 12, the bus 14, the input/output interface 16, the storage unit 18, the communication unit 20, the input unit 22, and the output unit 24 of the player terminal 1, respectively. Therefore, the following description will be directed to the hardware configuration of the player terminal 1, while omitting a description of the server 1000.

The CPU 10 runs a program stored in the memory 12 to control the proceeding of the game. The memory 12 is configured of a read only memory (ROM) or a random access memory (RAM) and stores the program and various kinds of data needed to control the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory such as a dynamic random access memory (DRAM) and stores various kinds of programs and data. In the player terminal 1, the programs and data stored in the storage unit 18 are loaded into the memory 12 (RAM) by the CPU 10.

The communication unit 20 is communicatively connected to a communication base station Na in a wireless manner and transmits information to and receives information from the server 1000, such as various kinds of data and programs, via the communication network N. In the player terminal 1, programs, etc. received from the server 1000 are stored in the memory 12 or the storage unit 18.

The input unit 22 is configured of a unit via which player operations are input (operations are accepted), for example, a touchscreen, buttons, a keyboard, a mouse, a cross keypad, an analog controller, or the like. In addition, the input unit 22 may be a dedicated controller that is provided in the player terminal 1 or connected (externally) to the player terminal 1. Furthermore, the input unit 22 may be configured of an acceleration sensor that detects tilting or movement of the player terminal 1 or a microphone that detects the player's voice. In other words, the input unit 22 includes a wide range of devices that enable the input of the player's intents in distinguishable manners.

The output unit 24 is configured to include a display device and a speaker. Note that the output unit 24 may be a device connected (externally) to the player terminal 1. In this embodiment, the player terminal 1 includes a display 26 as the output unit 24 and a touchscreen as the input unit 22, the touchscreen being provided so as to be overlaid on the display 26.

### (Game Specifics)

Next, the game provided by the information processing system S, that is, the game device G, in this embodiment will be described. A player can own characters obtained by means of a lottery, a so-called gacha, and characters distributed from the administration side. In addition, the player can own support cards obtained by means of a lottery and support cards distributed from the administration side.

Although details will be described later, a training game is provided in the game according to this embodiment. In the training game, a player can train characters that the player owns. In addition, the training game in this embodiment has gaming properties wherein the player trains characters while entering the characters in races modeled after horse racing.

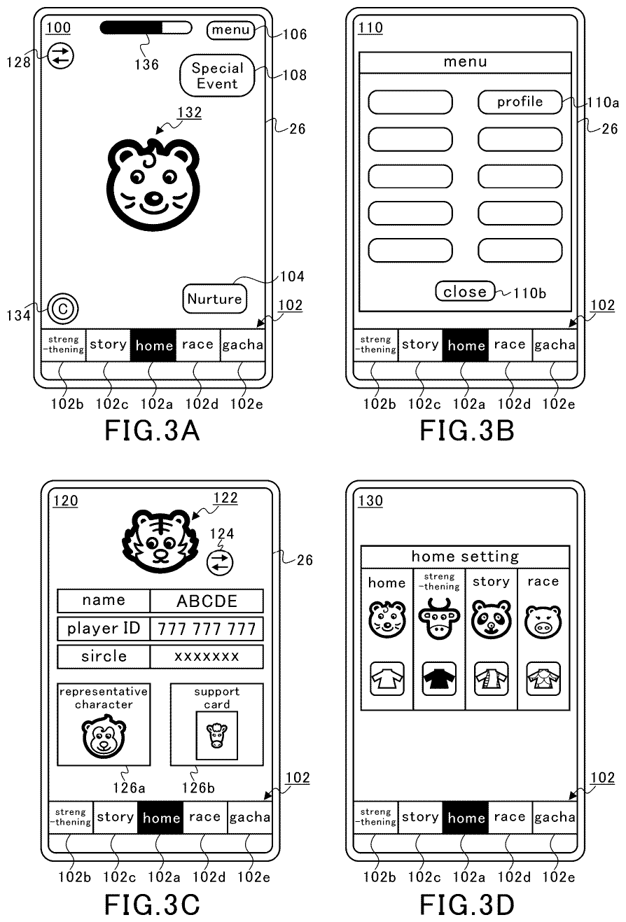

FIG. 3A is a diagram for explaining an example of a home screen 100. When a game application is started up in a player terminal 1, the home screen 100 is displayed on the display 26. A menu bar 102 is displayed at a bottom section of the home screen 100. The menu bar 102 is provided with a plurality of operation portions that the player can operate (tap).

Here, the menu bar 102 is provided with a home-screen selection operation portion 102a, an enhancement-screen selection operation portion 102b, a story-screen selection operation portion 102c, a racing-game selection operation portion 102d, and a gacha-screen selection operation portion 102e. Note that, in the menu bar 102, the operation portion that corresponds to the displayed screen is displayed in an emphasized manner so that the displayed screen on the display 26 can be distinguished.

When the home-screen selection operation portion 102a is tapped, the home screen 100 shown in FIG. 3A is displayed on the display 26.

When the enhancement-screen selection operation portion 102b is tapped, an enhancement screen (not shown) is displayed. On the enhancement screen, support cards and characters the player owns can be enhanced. The player can increase the levels set for the characters and the support cards by enhancing the characters and the support cards. Various kinds of parameters are set for the characters and the support cards, and the parameters are increased as a result of increases in the levels. By increasing the parameters of the characters and the support cards, the player can train the characters into characters having more powerful statuses in the training game.

When the story-screen selection operation portion 102c is tapped, a story screen (not shown) is displayed. Here, a story image is provided for each of the characters that appear in the game. On the story screen, the player can select and view a story by selecting a character and a story image.

When the racing-game selection operation portion 102d is tapped, a racing-game selection screen (not shown) is displayed. In this embodiment, various racing games in which a trained character trained in the training game, described later, can be entered are provided. The player can select, on the racing-game selection screen, a racing game in which a trained character is to be entered. Examples of the racing games include a team competition game in which a team organized with a plurality of trained characters competes against teams of other players selected by a computer. The team competition game has gaming properties wherein the player competes against the other players for ranking.

When the gacha-screen selection operation portion 102e is tapped, a gacha screen (not shown) is displayed. On the gacha screen, the player can play a so-called gacha lottery in which the player can acquire characters and support cards through a lottery by using an in-game currency.

In addition, on the home screen 100, a training-game operation portion 104 is provided at the top of the menu bar 102. When the training-game operation portion 104 is tapped, a training game screen is displayed and the training game, described later, is started. The training game is roughly divided into a preparation stage and a training stage, and, in the preparation stage, the player, first, selects one character from among the characters the player owns and sets the selected character to be the training target character.

In addition, in the preparation stage, the player sets a deck to be used when training the training target character. A deck is organized by using a plurality of inheritance characters, described later in detail, and a plurality of support cards. Therefore, in the training game, the inheritance characters and the support cards included in the deck are used.

When the settings of the training target character and the deck (the inheritance characters and the support cards) are completed, the training game proceeds to the training stage from the preparation stage, and the game for training the training target character is started. In the training game, the parameters of the training target character can be changed. The training target character for which training is completed in the training game becomes a trained character. The player can own a plurality of trained characters. As indicated above, the player can organize the trained characters that the player owns into a team and use in the team competition game, etc.

As has been described above, the main objective of the game of this embodiment is to generate trained characters by means of the training game and to increase the ranking in the team competition game by employing the trained characters.

In addition, this embodiment includes a function for sharing the trained characters or the support cards among the players and a function for sharing information among a plurality of players. The player can set the trained characters and the support cards to be usable for other players in the training game. Specifically, as shown in FIG. 3A, a setting operation portion 106 is provided at an upper right section of the home screen 100. When the setting operation portion 106 is tapped, an option setting screen 110 is displayed.

FIG. 3B is a diagram for explaining an example of the option setting screen 110. The option setting screen 110 is a screen on which various kinds of information can be confirmed and set. The option setting screen 110 is provided with a plurality of operation portions, and, when an operation portion is tapped, information corresponding to the operation portion can be confirmed and set.

The operation portions on the option setting screen 110 include a profile-setting operation portion 110a and a close operation portion 110b. When the close operation portion 110b is tapped, the option setting screen 110 is closed and the home screen 100 is displayed. When the profile-setting operation portion 110a is tapped, a profile setting screen 120 is displayed.

FIG. 3C is a diagram for explaining an example of the profile setting screen 120. On the profile setting screen 120, the player can confirm and set his/her own profile information. The profile information includes a profile character, a player name, a player ID, an affiliated circle, a representative character, and a rental card.

The profile character serves as the character that is displayed when other players view the information about the player. For example, the profile character is displayed when a circle function, which provides a place for sharing information with the other players, is used. On the profile setting screen 120, a currently set profile character image 122 is displayed. A change button 124 is provided near the profile character image 122. When the change button 124 is tapped, a profile-character change screen (not shown) is displayed. The player can change the prolife character on the profile-character change screen.

In addition, on the profile setting screen 120, the player name set by the player, the player ID given to the player, and the name of the circle with which the player is affiliated are displayed. In addition, the profile setting screen 120 is provided with a representative-character setting operation portion 126a and a rental-card setting operation portion 126b.

When the representative-character setting operation portion 126a is tapped, a representative character setting screen (not shown) is displayed. On the representative character setting screen, the player can set one of the trained characters that the player has trained to be the representative character. The representative-character setting operation portion 126a displays an icon image indicating the currently set representative character. Note that, although details will be described later, the representative character can be included in the decks as an inheritance character in the training games played by the other players.

When the rental-card setting operation portion 126b is tapped, a rental-card setting screen (not shown) is displayed. On the rental card setting screen, the player can set one of the support cards that the player owns to be a rental card. The rental-card setting operation portion 126b displays an icon image indicating the currently set rental card. Note that, as indicated above, the support card set to be the rental card can be included in decks of the other players and is used in the training games played by the other players.

Note that, although a detailed description will be omitted, when the setting of the profile information is changed on the profile setting screen 120, setting change information is transmitted to the server 1000. In the server 1000, the profile information is saved for each player.

In addition, as shown in FIG. 3A, on the home screen 100, a setting icon 128 is displayed. When the setting icon 128 is tapped, a home setting screen 130 is displayed.

FIG. 3D is a diagram for explaining an example of the home setting screen 130. On the home setting screen 130, the player can set home-screen setting characters 132 to be displayed on the home screen 100. The player can set four home-screen setting characters 132 to be displayed on the home screen 100.

Although illustration is omitted, when a flicking operation in the left-to-right direction is input on the home screen 100, the screen displayed on the display 26, in other words, the display on the home screen 100, is changed. The home screen 100 displays the currently set four home-screen setting characters 132. Functions as the respective operation portions displayed on the menu bar 102 are allocated to the home-screen setting characters 132. Therefore, when one of the home-screen setting characters 132 displayed on the home screen 100 is tapped, the screen is changed as with when one of the operation portions in the menu bar 102 is tapped.

The home setting screen 130 displays character images that respectively correspond to the currently set four home-screen setting characters 132 and the corresponding operation portions in a distinguishable manner. When one of the character images displayed on the home setting screen 130 is tapped, a character selection screen (not shown) is displayed. On the character selection screen, the player can select the home-screen setting characters 132. In addition, on the home setting screen 130, the player can set costumes of the home-screen setting characters 132.

In addition, as shown in FIG. 3A, the home screen 100 displays a circle icon 134. When the circle icon 134 is tapped, a circle screen is displayed. On the circle screen, the player can exchange information with other players affiliated with the same circle.

In addition, in this embodiment, various limited-time events are held on an irregular basis. During a period in which a limited-time event is being held, the home screen 100 displays a limited-time event icon 108. When the limited-time event icon 108 is tapped, a limited-time event screen (not shown) is displayed. On the limited-time event screen, the player can exchange, for example, event points provided for a limited time with various rewards.

When the training-game operation portion 104 is tapped on the home screen 100, a training game screen is displayed and the training game is started. Note that the player can play the training game by using game points. A prescribed amount (for example, +1) of the game points is given to the player every time a prescribed amount of time (for example, 10 min.) passes. There is an upper limit value (for example, 100) set for the amount of game points the player can own, and the player can own the game points within the range restricted by the upper limit value. At a top section of the home screen 100, a game-point display bar 136 is provided and a proportion of the currently owned game points relative to the upper limit value is visually displayed.

Note that the game points are deducted by a prescribed amount (for example, −30) at the point of time at which the training game is started. Therefore, in the case in which the player does not own a required amount of the game points, the player cannot start the training game. However, the player can own items for restoring the game points and the player can restore the game points by using the items. These items are given as, for example, rewards of the training game and the team competition game or are acquired by using the in-game currency. In the following, the training game will be described in detail.

### (Training Game)

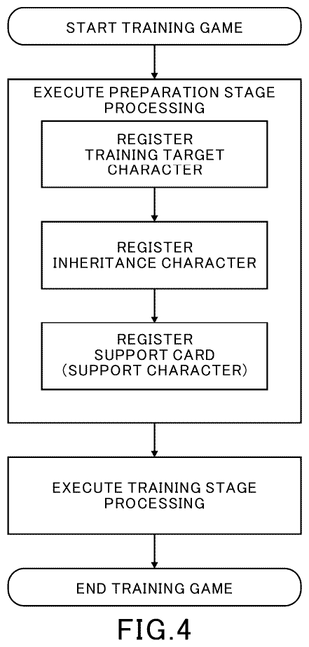

FIG. 4 is a diagram for explaining a rough flow of the training game. The training game is roughly divided into a setting game and a training main game. Although details will be described later, the training main game is a game in which one training target character that the player has selected from among the characters that the player owns is trained.

In addition, the setting game is for the player to register the training target character and the deck (the inheritance characters and the support cards) and corresponds to the preparation stage of the training game. In the following, processing performed in the setting game is referred to as the preparation stage processing and processing performed in the training main game will be referred to as the training stage processing. Here, in order to facilitate understanding, rough flows of the preparation stage processing and the training stage processing will be described first.

### <Preparation Stage Processing>

In the preparation stage processing, training-target character registration and deck (the inheritance characters and the support cards) registration are mainly performed. Note that the support cards are for the purpose of assisting training of the training target character. Each of the support cards is always associated with one or more characters, and the characters associated with the support cards registered in the preparation stage processing assist training the training target character. In the following, the characters associated with the support cards will be referred to as support characters.

### <Training Target Character Registration>

When the player taps the training-game operation portion 104 on the home screen 100, a scenario selection screen (not shown) is displayed. In this embodiment, a plurality of scenarios are provided in the training main game. Final goals, mid-game goals, etc. are set for each of the scenarios of the training main game and the player needs to sequentially clear the set goals. The respective goals, the length of periods for achieving the goals, etc. are different for each of the scenarios. The player can select, on the scenario selection screen, one of the plurality of scenarios. Here, a case in which a prescribed scenario is selected will be described.

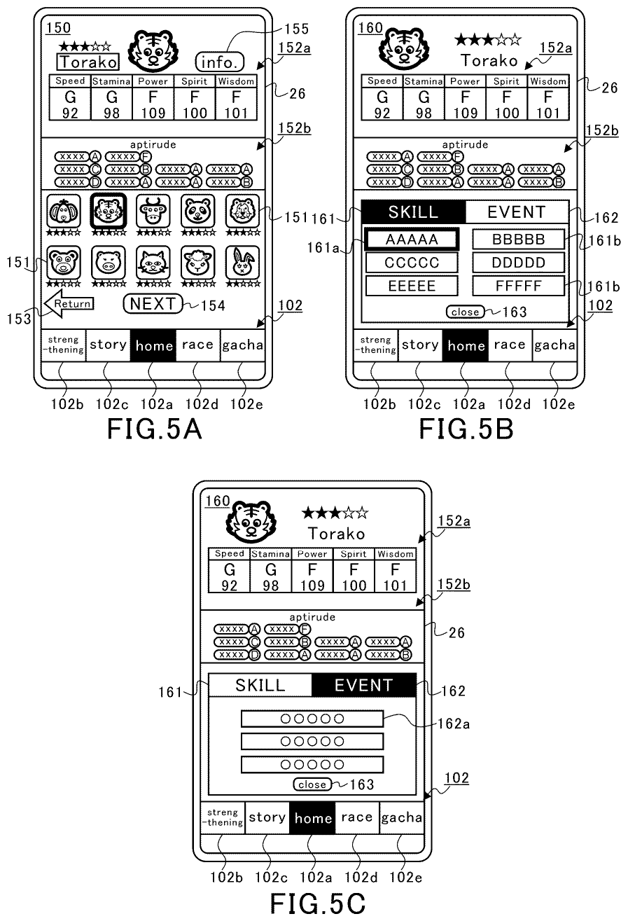

FIG. 5A is a diagram for explaining a training-target-character selection screen 150. In a center section of the training-target-character selection screen 150, a plurality of character icons 151 are displayed, and the characters that the player owns are displayed in a list. In addition, in a top section of the training-target-character selection screen 150, an ability-parameter display portion 152a and an aptitude-parameter display portion 152b are displayed. In addition, in a bottom section of the training-target-character selection screen 150, a return operation portion 153 indicated as “Return” and a next operation portion 154 indicated as “NEXT” are displayed.

In this embodiment, initial values are set for ability parameters of each of the characters, the ability-parameter display portion 152a numerically displays the initial values of the ability parameters of a character corresponding to the character icon 151 selected by the player. In this embodiment, greater numerical values of the ability parameters indicate higher abilities.

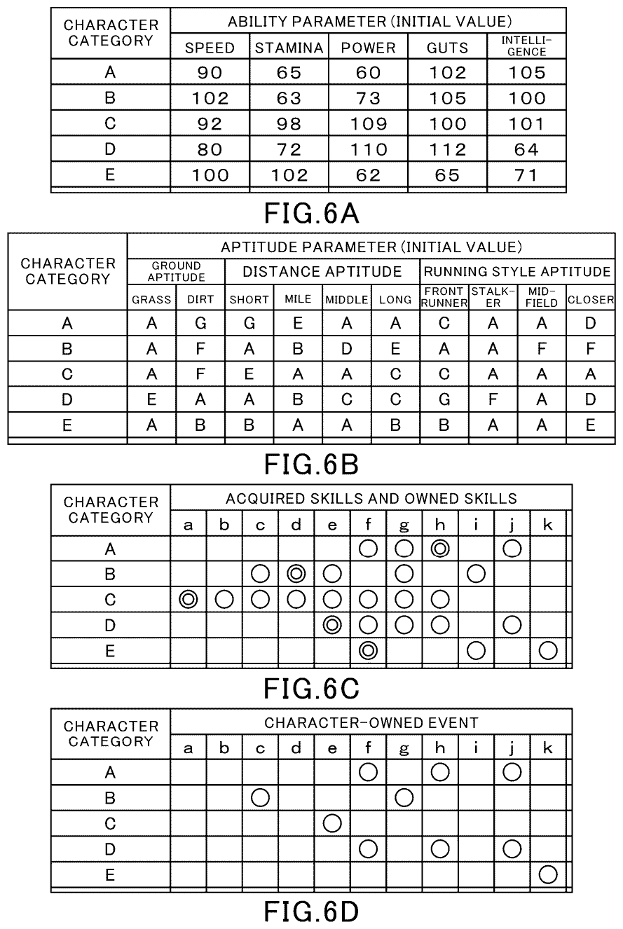

FIG. 6A is a diagram for explaining an ability parameter (initial value) table. In this embodiment, as show in FIG. 6A, the ability parameter (initial value) table stores the initial values of the ability parameters for each of the characters. Thus, the initial values of the ability parameters in the ability-parameter display portion 152a are displayed on the basis of the initial values of the ability parameters stored in the ability parameter (initial value) table.

In this embodiment, the initial values of the ability parameters are respectively set for a plurality of abilities for each of the characters. Specifically, the ability-parameter display portion 152a is provided with five types of ability parameters, speed, stamina, power, guts, and intelligence, indicated as, “Speed”, “Stamina”, “Power”, “Spirit”, and “Wisdom”, respectively.

Note that, the initial values of the ability parameters of each of the characters increase due to operations by the player, etc. For example, the characters are provided with 5 steps of levels, and the player can increase the levels of the characters by using the in-game currency and prescribed items. In this case, in association with increases in the levels of the characters, the initial values of the ability parameters increase. FIG. 6A shows the initial values for the case in which the characters are at a prescribed level. Note that the player can increase the values of the ability parameters in the training main game. In other words, the purpose of the training main game is to train the characters so as to have the ability parameters with higher numerical values.

In addition, in this embodiment, aptitude parameters (initial values) are set for each of the characters, and, as shown in FIG. 5A, the aptitude-parameter display portion 152b displays, by alphabets, the initial values of the aptitude parameters of a character corresponding to the character icon 151 selected by the player.

FIG. 6B is a diagram for explaining an aptitude parameter (initial value) table. In this embodiment, as shown in FIG. 6B, the aptitude parameter (initial value) table stores the initial values of the aptitude parameters for each of the characters. The initial values of the aptitude parameters are set to be one of 7 steps indicated by alphabets A-G. Note that the initial values of the aptitude parameters are such that A represents the highest aptitude and G represents the lowest aptitude. The aptitude-parameter display portion 152b displays the initial values of the aptitude parameters on the basis of the initial values of the aptitude parameters stored in the aptitude parameter (initial value) table.

In this embodiment, the initial values of the aptitude parameters are respectively set for a plurality of aptitude types for each of the characters. Specifically, as the aptitude parameters, aptitude parameters related to respective ground aptitudes for grass and dirt, aptitude parameters related to respective distance aptitudes for short distance, mile, middle distance, and long distance, and aptitude parameters related to respective running styles of front runner, stalker, midfield, and closer are provided.

In the training game, the player can enter the training target character in various races. When doing so, the race development would be advantageous for the training target character when the aptitudes of the training target character matching the race conditions are higher.

Note that the initial values of the aptitude parameters of each of the characters may be configured such that said initial values can be increased by using the in-game currency. In addition, the values of the aptitude parameters may change in the training main game. In addition, in the training main game, there may be a case in which the aptitude parameters are set to be S which indicates a higher aptitude than A.

FIG. 5B is a first diagram for explaining a character detail screen 160. In addition, FIG. 5C is a second diagram for explaining the character detail screen 160. When the character icon 151 on the training-target-character selection screen 150 is pressed and held, the character detail screen 160 is displayed on the display 26. The character detail screen 160 displays details of the abilities of a character corresponding to the character icon 151 pressed and held on the training-target-character selection screen 150.

In a center section of the character detail screen 160, a skill operation portion 161 and an event operation portion 162 are displayed. As shown in FIG. 5B, when the character detail screen 160 is initially displayed, the skill operation portion 161 is displayed in an emphasized manner, and skills provided for each of the characters are displayed. The skills are abilities that are activated in the case in which prescribed conditions are met while an individual race, which will be described later, is being executed. Skill activation makes the race development advantageous for each of the characters.

FIG. 6C is a diagram for explaining a skill table. As shown in FIG. 6C, the skill table stores the skills for each of the characters that the player owns. Thus, as shown in FIG. 5B, the character detail screen 160 displays the skills on the basis of the skills stored in the skill table. Note that the skills are not activated simply by owning the skills, and it becomes possible to activate the skills only if said skills are acquired. In the following, skills that are in a state in which the characters can activate the skills will be referred to as the acquired skills.

One acquired skill is set for each of the characters from the start of the training main game. In addition, apart from the acquired skill, a plurality of owned skills are set for each of the characters. An owned skill is a skill that can be acquired by using skill points (described later) after starting the training main game. In other words, the owned skills could become acquired skills in exchange with the skill points.

In this embodiment, the skill corresponding to a “double circle” on the skill table shown in FIG. 6C is displayed on the character detail screen 160 in FIG. 5B as the acquired skill. In addition, the skills corresponding to a “circle” on the skill table shown in FIG. 6C are displayed on the character detail screen 160 in FIG. 5B as the owned skills. In this embodiment, as shown on the character detail screen 160 in FIG. 5B, the acquired skill is displayed in an emphasized manner so that the acquired skill can be easily distinguished from the owned skills.

Note that, although FIG. 5B shows a case in which one acquired skill is displayed in an acquired-skill display field 161a and seven owned skills are displayed in owned-skill display fields 161b as the skills provided for each of the characters, it is not limited thereto, and, for example, the number of the acquired skills and the owned skills may be different among the respective characters. In addition, for example, the number of the acquired skills or the owned skills of the respective characters may increase as a result of increases in the levels of the characters, the use of the in-game currency and the items, etc.

In addition, when the player taps the event operation portion 162 on the character detail screen 160, as shown in FIG. 5C, the contents on the character detail screen 160 change and character-owned event display fields 162a that indicate character owned events provided for each of the characters are displayed. In this case, as shown in FIG. 5C, the event operation portion 162 is displayed in an emphasized manner. A character-owned event occurs when prescribed conditions are met in the training main game, and causes a story related to a character that appears in the training game to be displayed and the values of the ability parameters to change.

FIG. 6D is a diagram for explaining a character-owned event table. As shown in FIG. 6D, the character-owned event table stores the character-owned events for each of the characters that the player owns. Thus, as shown in FIG. 5C, the character-owned events are displayed on the character detail screen 160 on the basis of the character-owned events stored on the character-owned event table. Note that the character-owned events may include a clue event that makes it possible to own or acquire a skill, an ability event that increases or decreases the numerical values of the ability parameters of a character, etc.

Note that the character-owned events displayed on the character detail screen 160 shown in FIG. 5C may all be executed while executing the training main game, may at least partially be executed while executing the training main game, or may not be executed at all while executing the training main game in the case in which the prescribed conditions are not met. In addition, for example, the number of the character-owned events provided for each of the characters may increase due to increases in the levels of the characters, the use of the in-game currency and the items, etc. In addition, in the case in which prescribed conditions are met, a character-owned event that is not displayed as the character-owned events may be executed during the training main game.

In addition, as shown in FIGS. 5B and 5C, in a bottom section of the character detail screen 160, a close operation portion 163 indicated as “close” is displayed. In the case in which the close operation portion 163 on the character detail screen 160 is tapped, the display of the character detail screen 160 is terminated and the training-target-character selection screen 150 is displayed on the display 26.

In addition, when the return operation portion 153 is tapped on the training-target-character selection screen 150 shown in FIG. 5A, the home screen 100 shown in FIG. 3A is displayed on the display 26. In addition, the training-target-character selection screen 150 is provided with a training-information display button 155. When the training-information display button 155 is tapped, a training-information display screen (not shown) is displayed. On the training-information display screen, the player can confirm information about a character selected on the training-target-character selection screen 150.

The training-information display screen is provided with a clear goal tab. Although details will be described later, the training main game consists of a plurality of turns, and the player needs to train the training target character or enter the training target character in a race in each turn.

Also, a plurality of clear goals are respectively set for the individual characters. When the clear goal tab is tapped, clear goals set for the selected character are displayed on the training information display screen in a list. In each turn, a race in which the training target character can be entered is set in advance.

In addition, when the training target character, which is the training target, is entered in a race, said training target character can acquire fans, victory points, and special currency. In each race, base acquisition amounts of fans, victory points, and special currency are set in accordance with the arrival orders, and the numerical values of fans, victory points, and special currency to be acquired are greater for higher arrival orders.

In addition, a difficulty level is set for a race, and greater amounts of fans, victory points, and special currency can be acquired in a race with a higher difficulty level. For example, among the races, there are races in GI, GII, and GIII grades, which are referred to as graded races. The grade increases in the order of GIII, GII, and GI. The difficulty level is higher for a race in a higher grade, and greater amounts of fans, victory points, and special currency can be acquired.

Here, the number of fans that can be acquired by entering a race is calculated by adding a bonus acquisition amount to the base acquisition amount set in accordance with the arrival order. Specifically, a correction value is determined on the basis of the race result, and the bonus acquisition amount is calculated by multiplying the base acquisition amount by the correction value. The sum of this bonus acquisition amount and the base acquisition amount is the number of fans the training target character acquires. For example, in the case in which the race result was the first place, the correction value increases as the difference between the training target character and the character in the second place increases. In addition, in the case in which the race result is the second to fifth place, the correction value increases as the difference between the training target character and the character in the first place decreases.

In addition, the training target character activates a skill at a prescribed probability during a race. At this time, the correction value increases as the number of activated skills increases. Accordingly, in each race, the conditions for adding the number of fans are set, and the number of fans to be acquired increases in accordance with various kinds of race results other than the arrival order and the progress during a race. However, the number of fans that the training target character acquires is at least equal to or greater than the base acquisition amount corresponding to the arrival order.

Note that there are races in which the number of fans is defined as an entry condition. In the case in which the number of fans that the training target character has acquired is less than the number of fans defined as the entry condition, the player cannot enter the training target character in said race. A race having a higher difficulty level requires a greater number of fans to enter the race.

As has been indicated above, a plurality of clear goals are set for each of the characters. By clearing the clear goals, the player can continue the training main game to the final turn. On the other hand, in the case in which the player cannot clear the clear goals, the training main game is terminated in that turn.

As has been described above, the player can select the training target character while confirming various types of information about the respective characters on the training-target-character selection screen 150 shown in FIG. 5A. Then, when the next operation portion 154 is tapped on the training-target-character selection screen 150, the selected character is set to be the training target character and an inheritance-character selection screen 170 is displayed on the display 26.

### <Inheritance Character Registration>

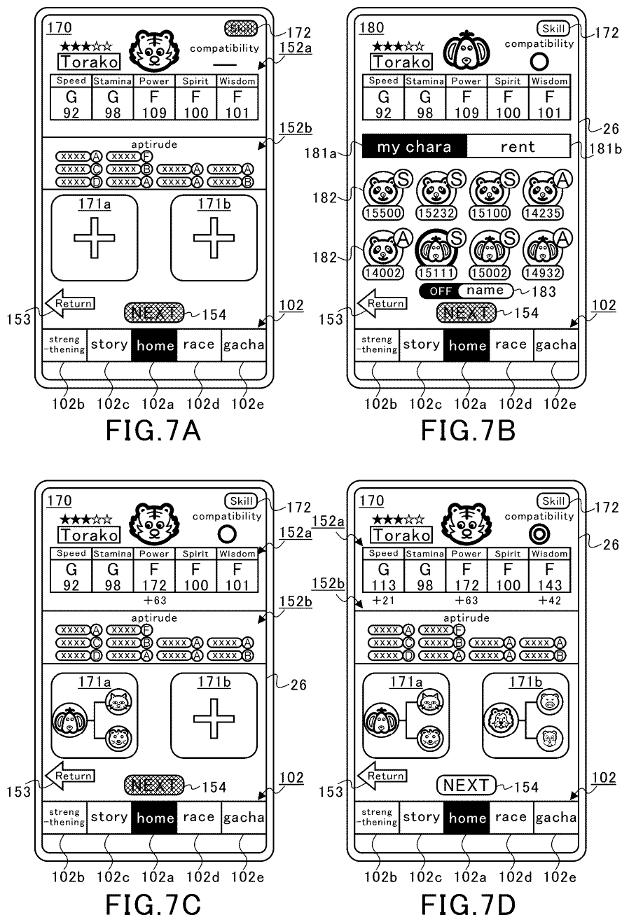

FIG. 7A is a first diagram for explaining the inheritance-character selection screen 170. FIG. 7B is a first diagram for explaining a trained character list screen 180. FIG. 7C is a second diagram for explaining the inheritance-character selection screen 170. FIG. 7D is a third diagram for explaining the inheritance-character selection screen 170. The inheritance-character selection screen 170 is a screen for the player to register inheritance characters.

An inheritance character is a character from which the training target character inherits ability values, skills, etc. The player can select two inheritance characters from the trained characters that the player owns, the representative characters of friends, such as followers, and the representative characters of other players extracted in accordance with prescribed extraction conditions, include the selected characters in the deck, and thus, register said characters. Note that, in one round of the training game, the player can include, at maximum, only one of the representative characters of other players in the deck as the inheritance character.

The inheritance-character selection screen 170 is provided with the ability-parameter display portion 152a, the aptitude-parameter display portion 152b, a first inheritance-character selection area 171a, and a second inheritance-character selection area 171b. When the screen transitions to the inheritance-character selection screen 170 from the training-target-character selection screen 150, the first inheritance-character selection area 171a and the second inheritance-character selection area 171b are displayed in an empty state, as shown in FIG. 7A.

When the first inheritance-character selection area 171a or the second inheritance-character selection area 171b is tapped, the trained character list screen 180 shown in FIG. 7B is displayed. The trained character list screen 180 is provided with a my character tab 181a and a rental tab 181b. In addition, below the my character tab 181a and the rental tab 181b, a trained-character-list display area is provided. In the trained-character-list display area, trained character icons 182 are displayed.

In the state in which the my character tab 181a is selected, the trained character icons 182 corresponding to the trained characters that the player owns are displayed, as shown in FIG. 7B. In addition, although the illustration is omitted, in the state in which the rental tab 181b is selected, trained character icons 182 corresponding to the representative characters of the friends, in other words, the trained characters that the friends have trained, are displayed.

In addition, when a trained character icon 182 is tapped, the trained character corresponding to the trained character icon 182 is provisionally selected. In addition, when the trained character icon 182 is tapped, the inheritance-character selection screen 170 is displayed, as shown in FIG. 7C. At this time, for example, in the case in which the first inheritance-character selection area 171a is tapped to display the trained character list screen 180 and the trained character icon 182 is tapped on the trained character list screen 180, an image indicating the provisionally selected trained character is displayed in the first inheritance-character selection area 171a.

In this state, for example, when the second inheritance-character selection area 171b is tapped to display the trained character list screen 180 and the trained character icon 182 is tapped on the trained character list screen 180, an image indicating the provisionally selected trained character is displayed on the second inheritance-character selection area 171b, as shown in FIG. 7D.

In addition, information related to the inheritance characters used to train the trained characters is stored in association with the corresponding trained characters. The first inheritance-character selection area 171a displays the information related to the inheritance characters used to train the trained characters.

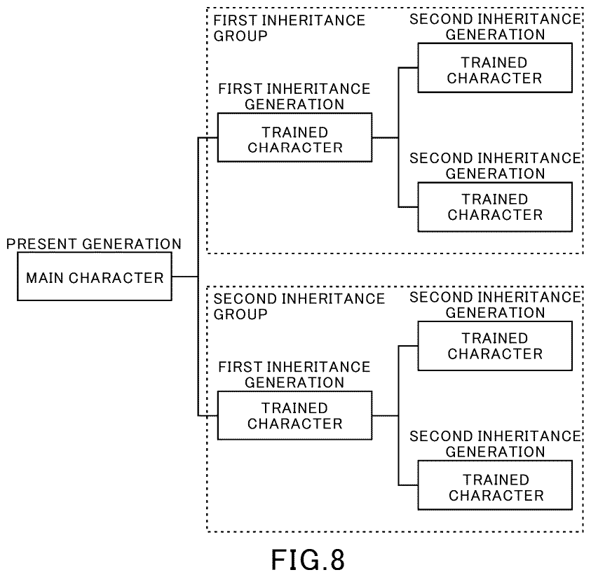

FIG. 8 is a diagram for explaining an inheritance lineage. In the training game, various kinds of effects, such as increasing values of the ability parameters and the aptitude parameters of the training target characters, are brought about on the basis of factor information of the inheritance characters. In this case, two inheritance characters are set for one training target character; however, these inheritance characters are previously generated trained characters. Therefore, when the trained characters to be set to be the inheritance characters are generated, two inheritance characters are also set for said trained characters.

As shown in FIG. 8, a training target character that serves as the training target of a training main game to be started is assumed to be in the present generation. In addition, the two trained characters that are set to be the inheritance characters for the training target character of the present generation are assumed to be in a first inheritance generation. Furthermore, for the trained characters in the first inheritance generation, two trained characters are set to be the inheritance characters when training of said trained characters is started. The two trained characters that are set to be the inheritance characters when the trained characters in the first inheritance generation are generated are assumed to be in a second inheritance generation.

In this case, as shown in FIG. 8, the trained characters in the first inheritance generation and the second inheritance generation have effects on the training target character in the present generation. As has been indicated above, because two inheritance characters (first inheritance generation) are set for one training target character, a total of six trained characters have effects on one training target character.

For example, one of the two trained characters in the first inheritance generation and the two trained characters in the second inheritance generation, which are the inheritance characters of said trained character, constitute a first inheritance group. Similarly, the other one of the two trained characters in the first inheritance generation and the two trained characters in the second inheritance generation, which are the inheritance characters of said trained character, constitute a second inheritance group.

As shown in FIG. 7D, the first inheritance-character selection area 171a shows icons that respectively correspond to one trained character in the first inheritance generation and two trained characters in the second inheritance generation constituting the first inheritance group. Similarly, the second inheritance-character selection area 171b shows icons that respectively correspond to one trained character in the first inheritance generation and two trained characters in the second inheritance generation constituting the second inheritance group.

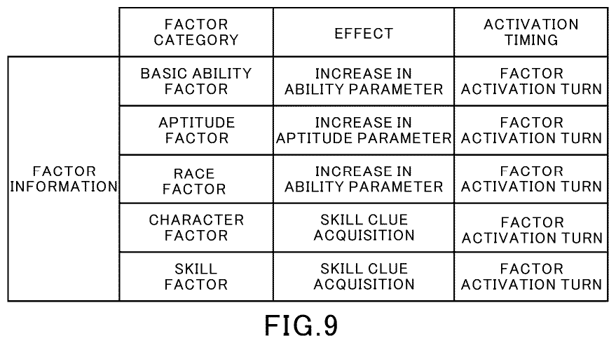

FIG. 9 is a diagram for explaining the factor information. Although details will be described later, when the training game is completed, the training target character serving as the training target is registered as a trained character; however, at this time, the trained character is stored in association with the factor information. Specifically, when the training of the trained character is completed, factors that the trained character acquires are determined by means of a lottery. Then, the factor information indicating the factors won by means of the lottery is associated with the trained character. In other words, when the training game is completed, the trained character can acquire the factors won by means of the lottery.

However, the factors that the trained character has acquired do not affect the abilities of said trained character themselves. For example, the trained character can be entered in a racing game such as a team competition game. At this time, in the race, a simulation, in other words, computation processing, for determining the arrival order and the race development is performed on the basis of the ability parameters, the aptitude parameters, the acquired skills, etc. of all of the trained characters entering the race. Because the factors that the trained characters possess are not employed in the computation processing, even if a trained character possesses numerous factors, this would not make the race progression advantageous for said trained character.

In the case in which said trained character is set to be an inheritance character, the factors that the trained character possesses affect only the training target character serving as the training target. The factors that the trained character can acquire are classified into a plurality of categories. FIG. 9 shows, as the factor categories, the basic ability factor, the aptitude factor, the race factor, the character factor, and the skill factor. One of a plurality of steps are set for the respective factors. Here, three steps, namely, level 1, level 2, and level 3, are provided as the factor levels.

Note that the factor levels are determined by means of a lottery. At this time, the factor levels may be determined by means of a lottery for the respective acquired factors after the factors that the trained character acquires are determined. Alternatively, winning ratios are set for respective combination patterns between the factors and the factor levels, and any one of the combination patterns may be determined on the basis of the set winning ratios. Accordingly, the factors to be acquired and the factor levels thereof are simultaneously determined.

Regarding the factor levels, level 3 indicates the highest effect and level 1 indicates the lowest effect. In the lottery for determining the factor levels, the winning probability of level 3 is set to be the lowest and the winning probability of level 1 is set to be the highest. However, the winning probabilities of the factors to be acquired and the winning probabilities of the factor levels may be changed depending on the training game results. In this case, for example, the factor levels may be determined to be higher for a trained character having higher ability parameters and evaluation points.

The basic ability factors increase the ability parameters of the training target character. Five types of basic ability factors, namely, the speed factor, the stamina factor, the power factor, the guts factor, and the intelligence factor, are provided. A trained character always acquires one of the five basic ability factors. The five basic ability factors respectively correspond to the five ability parameters, namely, the speed, the stamina, the power, the guts, and the intelligence. For example, in the case in which a trained character in the first inheritance generation or the second inheritance generation possesses the speed factor, the speed ability parameter of the training target character increases.

At this time, the amount by which the speed ability parameter increases differs depending on the factor level of the speed factor. For example, the speed ability parameter of the training target character increases by “7” in the case in which the factor level of the speed factor is level 1, the ability parameter increases by “13” in the case of level 2, and the ability parameter increases by “21” in the case of level 3. Therefore, in the case in which, of a total of six trained characters including two in the first inheritance generation and four in the second inheritance generation, all of the trained characters possess the speed factors in level 3, the speed ability parameter of the training target character maximally increases by 126 (increase value of 21 multiplied by six trained characters).

However, an activation timing and an activation condition are set for each of the factors. Therefore, even if an inheritance character possesses a factor, the effect thereof is not brought about on the training target character in the case in which the activation condition is not met at the activation timing.

As has been described above, the training main game is constituted of a plurality of turns, and prescribed turns thereof are set to be factor activation turns. For example, three turns, namely, the first turn, the 30th turn, and the 54th turn, in the training main game are set to be the factor activation turns. In these factor activation turns, whether or not a factor is activated is determined for each factor, and, in the case in which it is determined that a factor is activated, the activation condition of said factor is met, and the effect corresponding to the factor is brought about.

Note that whether or not a basic ability factor is activated is determined by means of a lottery. At this time, the probability at which the player wins the lottery for determining whether or not a basic ability factor is activated, in other words, the probability at which the basic ability factor is activated (hereinafter referred to as the activation probability), may be different for the three factor activation turns. Here, in the first turn, the activation probability of a basic ability factor is set at 100% regardless of the factor levels. In addition, in the 30th turn and the 54^{th} turn, the activation probabilities of a basic ability factor are different depending on the factor levels. In one example, in the 30^{th} turn and the 54^{th} turn, the activation probability of level-3 basic ability factors is set at 100%, the activation probability of level-2 basic ability factors is set at 90%, and the activation probability of level-1 basic ability factors is set at 80%.

On the inheritance-character selection screen 170, the amounts by which the ability parameters increase in the first turn are displayed. For example, in FIG. 7C, one inheritance character that constitutes the first inheritance group is provisionally selected. In this case, the types of the ability parameters that increase in the first turn due to the provisionally selected inheritance character and the amounts by which the ability parameters increase are displayed. Here, “+63” is displayed below the power ability parameter, and it is indicated that the power ability parameter increases by 63 points in the first turn. In addition, a value obtained as a result of the addition of the amount by which the ability parameter increases in the first turn is displayed in the ability-parameter display portion 152a.

In addition, in FIG. 7D, two inheritance characters that constitute the first inheritance group and the second inheritance group are provisionally selected. In this case, the types of the ability parameters that increase in the first turn due to the provisionally selected two inheritance characters and the amounts by which the ability parameters increase are displayed. Here, “+21”, “+63”, and “+42” are respectively displayed below the speed, power, and intelligence ability parameters, and it is indicated that the speed, power, and intelligence ability parameters increase by 21 points, 63 points, and 42 points, respectively, in the first turn.

Note that, on the inheritance-character selection screen 170, the amounts by which the ability parameters increase due to the inheritance characters that constitute the first inheritance group and the amounts by which the ability parameters increase due to the inheritance characters that constitute the second inheritance group are displayed in a distinguishable manner. For example, in FIG. 7D, the notation of “+63” displayed below the power ability parameter and the notations of “+21” and “+42” displayed below the speed and intelligence ability parameters are distinguished by colors.

The aptitude factors shown in FIG. 9 increase the aptitude parameters of the training target character. Six aptitude factors, namely, the grass factor, the dirt factor, the short distance factor, the mile factor, the middle distance factor, and the long distance factor, are provided. A trained character always acquires one of the six aptitude factors. The six aptitude factors respectively correspond to the grass aptitude, the dirt aptitude, the short distance aptitude, the mile aptitude, the middle distance aptitude, and the long distance aptitude. For example, in the case in which the trained characters in the first inheritance generation or the second inheritance generation include a trained character having the grass factor, the aptitude parameter of the grass aptitude of the training target character increases.

Note that an activation timing and an activation condition are also set for each of the aptitude factors, and whether or not each of the aptitude factors is activated is determined in the same factor activation turns as the basic ability factors. In the case in which it is determined that an aptitude factor is activated, the corresponding aptitude parameter increases by one step. In one example, in the first turn, the activation probabilities of the aptitude factors are set at 100% regardless of the factor levels.

For example, assume that the aptitude factors of the three trained characters belonging to the first inheritance group are the grass factor, the short distance factor, and the mile factor, respectively, and the aptitude factors of the three trained characters belonging to the second inheritance group are the grass factor, the short distance factor, and the middle distance factor, respectively. In this case, the grass aptitude and the short distance aptitude of the training target character respectively increase by two steps, and the mile aptitude and the middle distance aptitude thereof respectively increase by one step.

In addition, for example, assume that the aptitude factors of the three trained characters belonging to the first inheritance group all are the grass factor and the aptitude factors of the three trained characters belonging to the second inheritance group all are the short distance factor. In this case, the grass aptitude and the short distance aptitude of the training target character respectively increase by three steps. In addition, as another example, assume that the aptitude factors of the three trained characters belonging to the first inheritance group all are the grass factor and the aptitude factors of the three trained characters belonging to the second inheritance group are the grass factor, the short distance factor, and the mile factor, respectively. In this case, the grass aptitude of the training target character increases by four steps and the short distance aptitude and the mile aptitude respectively increase by one step.

However, in the first turn, a limit is provided for the amounts by which the aptitude parameters increase. Specifically, in the first turn, the upper limit of all of the aptitude parameters is set at A. Therefore, in the case in which the initial value of the grass aptitude of the training target character is A, even if an inheritance character possesses the grass factor, the grass aptitude would not increase in the first turn.

In contrast, in the 30^{th} turn and the 54^{th} turn, whether or not each of the aptitude factors is activated is determined on the basis of the factor levels. In one example, in the 30^{th} turn and the 54^{th} turn, the activation probability of level-3 aptitude factors is set at 5%, the activation probability of level-2 aptitude factors is set at 3%, and the activation probability of level-1 aptitude factors is set at 1%. In the 30^{th} turn and the 54^{th} turn, when it is determined that an aptitude factor is activated by means of a lottery, the aptitude parameter corresponding to the aptitude factor increases. Note that, in the 30^{th} turn and the 54^{th} turn, the upper limits of the respective aptitudes are increased from A to S. Therefore, in the 30^{th} turn and the 54^{th} turn, the values of the aptitude parameters can increase to S as a result of the aptitude factor activation.

Note that the values of the aptitude parameters that have increased in the first turn are displayed on the aptitude-parameter display portion 152b of the inheritance-character selection screen 170.

The race factors increase the ability parameters of the training target character. The race factors are respectively set for, for example, races with high difficulty levels (hereinafter referred to as the factor subject races), such as GI, among the races the training target character can be entered in the training main game. When the training game is completed, a lottery for determining whether or not the race factors are acquired is performed for each of the factor subject races in which the training target character won the first place. By winning this lottery, the trained character can acquire the race factors.

Note that factor levels are also provided for the race factors, the factor levels are determined by means of a lottery for each of the race factors for which acquisition thereof has been determined. In addition, here, there is no upper limit to the number of the race factors that one trained character can acquire and the trained character can acquire a plurality of race factors.

The respective race factors are provided in advance with the ability parameters that increase as a result of activation thereof and the amounts by which the ability parameters increase. For example, the race factors include those that increase the speed ability parameter and the power ability parameter. At this time, the amounts by which the ability parameters increase are higher for the race factors with higher factor levels.

In addition, activation timings and activation conditions are also set for the race factors, and whether or not the race factors are activated is determined for each of the race factors in the factor activation turns. In the case in which it is determined that the race factors are activated, the ability parameters corresponding to the race factors increase. Note that the factor activation turns of the race factors are limited to the 30^{th} turn and the 54^{th} turn. In addition, the activation probabilities of the race factors in the factor activation turns are different depending on the factor levels and the activation probabilities are higher for higher factor levels.

The character factor is a factor unique to a character and, for example, only in the case in which a character that has been enhanced to a prescribed level is trained as the training target character, the character factor set for said character is always imparted to the trained character when the training game is completed. Note that, because only one character factor is set for one character, the maximum number of the character factor that one trained character can acquire is 1. In addition, in the case in which a trained character is generated on the basis of a character that has not been enhanced to the prescribed level, it is not possible to acquire the character factor.

In addition, the character factor can be activated in factor activation turns that are set in advance and is activated by winning a lottery executed in the factor activation turns. When the character factor is activated, a clue event set for each character factor occurs and, as indicated above, a clue for a skill can be acquired.

The skill factors are imparted on the basis of the acquired skills that the trained character has acquired. Specifically, when the training game is completed, a lottery for determining whether or not the skill factors are acquired is performed for each of the acquired skills that the trained character has acquired. By winning this lottery, the skill factors are imparted to the trained character. In other words, the trained character can acquire some or all of the skill factors corresponding to the acquired skills that have been acquired. Note that, when it is determined that the skill factors are acquired, the factor levels of the said skill factors are determined by means of a lottery.

In addition, the skill factors can be activated in factor activation turns that are set in advance and are activated by winning a lottery executed in the factor activation turns. At this time, the winning probabilities are higher for the skill factors with higher factor levels. When the skill factors are activated, clue events set for each of the skill factors occur and clues for the skills can be acquired. Accordingly, the training target character can acquire the same skills as the acquired skills that the inheritance character, etc. have acquired.

As has been described above, whether or not the skill factors are acquired is determined within the range of the acquired skills that the trained character have acquired. Therefore, the possibility of acquiring the skill factors is also higher for a trained character having a greater number of acquired skills. However, because whether or not the skills factors are acquired is determined by means of a lottery, there are cases in which the skill factors cannot be acquired even if the number of the acquired skills is high.

Note that, here, the trained character acquires the skill factors apart from the acquired skills, the skills that the training target character can acquire may be determined on the basis of the acquired skills that the trained characters serving as the inheritance characters possess without providing the skill factors.

As has been described above, the ability parameters of the training target character considerably change depending on the inheritance characters included in the deck. In addition, even if the abilities of the trained characters themselves are high, because whether or not the factors are acquired is determined by means of a lottery, trained characters having high abilities are not necessarily suitable as the inheritance characters. On the other hand, even in the case in which the abilities of trained characters themselves are not high, there are cases in which such trained characters effectively serve as the inheritance characters as a result of acquiring numerous factors with high factor levels. Accordingly, by allowing the inheritance characters to be included in the deck, interests are stimulated not only in simply training powerful trained characters but also in training trained characters that are effective as the inheritance characters.

Furthermore, in this embodiment, compatibilities among the training target character, the trained characters in the first inheritance generation, and the trained characters in the second inheritance generation are determined. Also, a combination of highly compatible characters is advantageous in terms of the factor activation conditions.

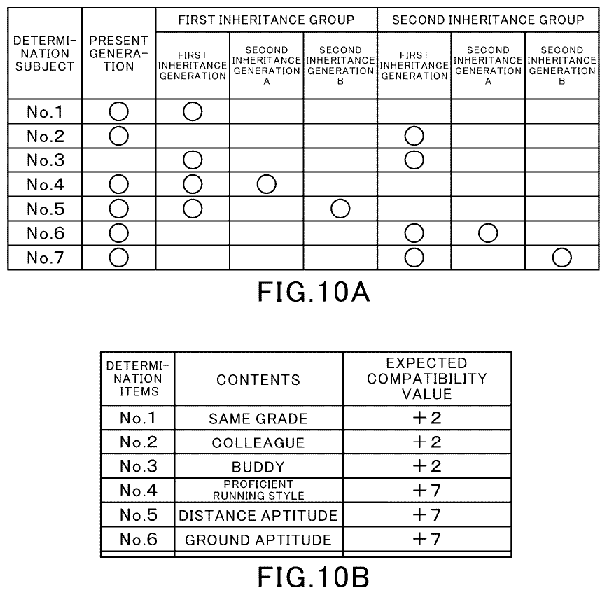

FIG. 10A is a diagram for explaining a compatibility determination subjects, and FIG. 10B is a diagram for explaining compatibility determination items. As shown in FIG. 10A, in this embodiment, seven determination subjects from No. 1 to No. 7 are provided. The first determination subjects (No. 1) are the training target character of the present generation and the trained character of the first inheritance generation in the first inheritance group. The second determination subjects (No. 2) are the training target character of the present generation and the trained character of the first inheritance generation in the second inheritance group.

The third determination subjects (No. 3) are the trained character of the first inheritance generation in the first inheritance group and the trained character of the first inheritance generation in the second inheritance group. The fourth determination subjects (No. 4) are the training target character of the present generation, the trained character of the first inheritance generation in the first inheritance group, and one of the trained characters (trained character A) of the second inheritance generation in the first inheritance group. The fifth determination subjects (No. 5) are the training target character of the present generation, the trained character of the first inheritance generation in the first inheritance group, and the other trained character (trained character B) of the second inheritance generation in the first inheritance group.

The sixth determination subjects (No. 6) are the training target character of the present generation, the trained character of the first inheritance generation in the second inheritance group, and one of the trained characters (trained character A) of the second inheritance generation in the second inheritance group. The seventh determination subjects (No. 7) are the training target character of the present generation, the trained character of the first inheritance generation in the second inheritance group, and the other trained character (trained character B) of the second inheritance generation in the second inheritance group.

For each of the above-described determination subjects, whether or not conditions are met for each of a plurality of determination items is determined. FIG. 10B shows examples of the determination items. In this embodiment, according to the world view of the game, the setting is such that the characters that can be selected as the training target character are students and the respective characters train at a school.

Also, as shown in FIG. 10B, the respective characters have attributes that are set in advance, such as grade, colleague, and buddy, as shown in FIG. 10B. For example, the determination items include specifics such as whether or not the two or three characters serving as the determination subjects belong to the same grade, whether or not said characters are colleagues, and whether or not said characters are buddies. In addition, the determination items include whether or not the characters serving as the determination subjects match with each other in terms of running style that said characters are good at, the distance aptitude, and the ground aptitude.

Also, the respective determination items are associated with expected compatibility values and the expected compatibility values are accumulated for the determination items for which the characters serving as the determination subjects are compatible with each other. Here, the expected compatibility values are different depending on the determination items; however, the expected compatibility values may be the same for all of the determination items.

For example, when determining the compatibility, first, whether or not the training target character of the present generation, which is the first determination subject, and the trained characters of the first inheritance generation in the first inheritance group are compatible for all of the determination items is determined. At this time, the expected compatibility values associated with the determination items for which said characters are compatible with each other are accumulated and counted. Accordingly, the expected compatibility values are sequentially counted from the first determination subjects to the seventh determination subjects, and the factor activation probabilities are corrected on the basis of the finally calculated expected compatibility value. Specifically, a higher expected compatibility value results in higher activation probabilities for all of the factors and a lower expected compatibility value results in lower activation probabilities for all of the factors.

Note that the activation probabilities may be calculated by using the calculated expected compatibility value as a correction value. In addition, for example, a correction value for correcting the factor activation probabilities may be set for each compatibility level and the compatibility level may be determined on the basis of the calculated expected compatibility value.

Accordingly, because the factor activation probabilities vary depending on the compatibility between the training target character and the inheritance characters or the compatibility of the inheritance characters with respect to each other, the combination of two inheritance characters considerably influence the training of the training target character. In other words, the compatibility between the characters is important information for making decisions about the selection of the inheritance characters.

As shown in FIGS. 7B, 7C, and 7D, in the state in which the inheritance characters are selected, a compatibility mark that indicates the degree of compatibility is displayed in the upper right side of the inheritance-character selection screen 170 and the trained character list screen 180. Here, the compatibility level with respect to the selected character is indicated by three types of compatibility marks, a double circle, a circle, and a triangle. Note that, as shown in FIG. 7A, in the state in which no inheritance character is selected, the compatibility mark is not displayed.

In addition, as shown in FIG. 7B, a display switching button 183 is provided on the trained character list screen 180. When the display switching button 183 is operated, a display-condition setting screen (not shown) is displayed. On the display-condition setting screen, the player can change the trained character icons 182 to be displayed on the trained character list screen 180, in other words, the player can perform setting for sorting and refining the sorting of the trained characters that can be selected as the inheritance characters.

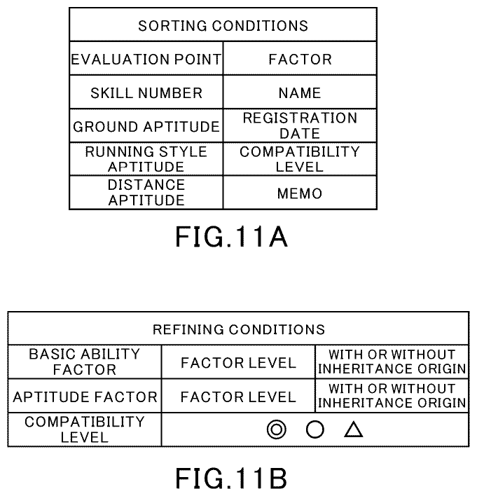

FIG. 11A is a diagram for explaining sorting conditions. FIG. 11B is a diagram for explaining refining conditions. On the display-condition setting screen, the player can select and set the sorting conditions shown in FIG. 11A. Here, as the sorting conditions, any one of the evaluation point, the factor, the number of skills, the name, the ground aptitude, the registration date, the running style aptitude, the compatibility level, the distance aptitude, and the memo can be selected and set. When the sorting condition is set, the trained character list screen 180 is displayed. At this time, the display order of the trained character icons 182 on the trained character list screen 180 is changed in accordance with the sorting condition.

In addition, on the display-condition setting screen, the player can select and set the refining conditions shown in FIG. 11B. Here, as the refining conditions, the basic ability factor, the aptitude factor, and the compatibility level are provided. Note that, when the basic ability factor or the aptitude factor is set as the refining condition, only the trained characters having the factors selected by the player are displayed on the trained character list screen 180.

At this time, the player can set the factor level, for example, in the case in which the factor level is set to be level 3 when refining the sorting, only the trained characters having, among the factors selected by the player, the factors in which the factor level is level 3 are displayed on the trained character list screen 180. Note that the player can refine the sorting of the trained characters by selecting whether the trained characters themselves have the factors or the inheritance characters of the trained characters have the factors.

In addition, the player can refine the sorting in accordance with the compatibility level. Here, the sorting can be refined so as to specify the trained characters for which the compatibility is indicated by the double circle, the trained characters for which the compatibility is indicated by the circle, and, additionally, the trained characters for which the compatibility is indicated by the triangle. Accordingly, the sorting and the refining thereof can be performed under various conditions, and thus, the convenience for the player is enhanced.

In addition, on the trained character list screen 180 shown in FIG. 7B, when the trained character icon 182 is pressed and held, detailed information of a trained character corresponding to the trained character icon 182 is displayed.

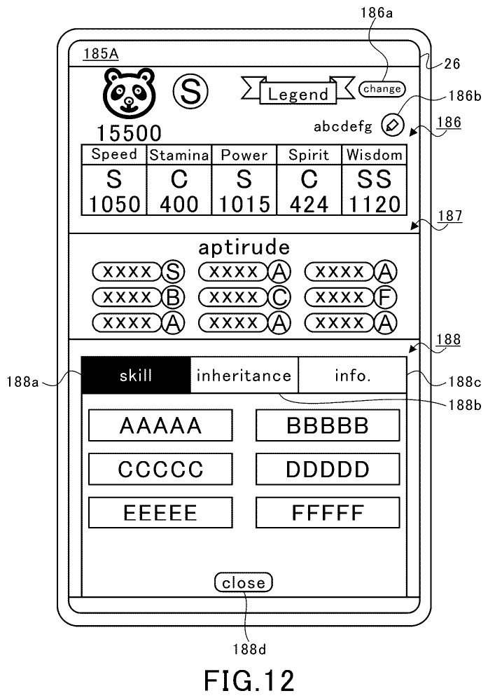

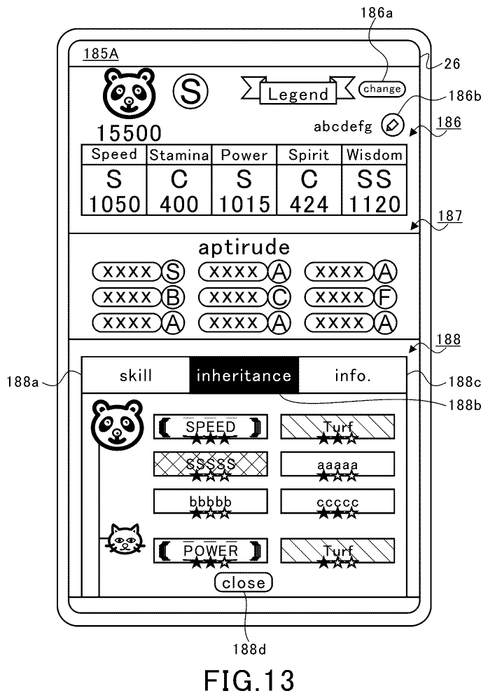

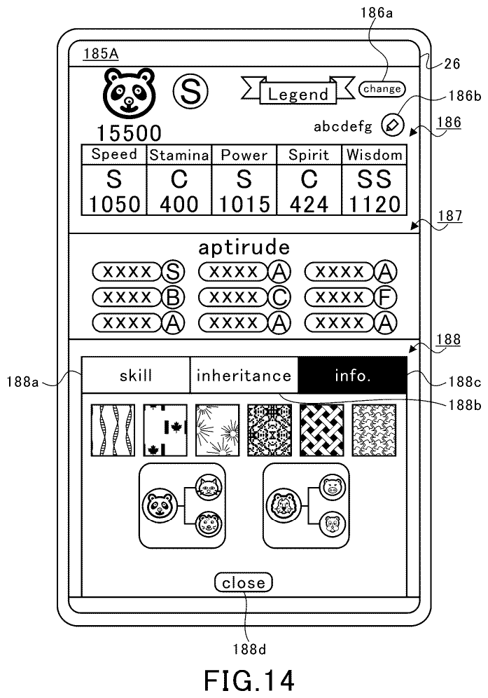

FIG. 12 is a first diagram for explaining a character detail dialog 185A. FIG. 13 is a second diagram for explaining the character detail dialog 185A. FIG. 14 is a third diagram for explaining the character detail dialog 185A. In the character detail dialog 185A, the detailed information of the trained character is displayed. In a top section of the character detail dialog 185A, an ability parameter display field 186 that shows the ability parameters of the trained character is displayed.

In an upper left section of the ability parameter display field 186, an icon of a character that serves as the basis of the trained character, the evaluation point of the trained character, and the training rank thereof are displayed. In addition, in an upper right section of the ability parameter display field 186, a nickname change button 186a and a memo input button 186b are provided. When the nickname change button 186a is tapped, a nickname list screen (not shown) is displayed. On the nickname list screen, a list of nicknames that the trained character has acquired is displayed. Note that, in the training main game, numerous nicknames are provided and acquisition conditions are set for all of the nicknames.

In the training main game, nicknames for which the acquisition conditions have been met are imparted to the trained character. The player can select any one of the nicknames that the trained character has acquired and set the nickname to said trained character. On the nickname list screen, the player can change the nickname to be set for the trained character. On the left side of the nickname change button 186a, the currently set nickname (in this case, “Legend”) is displayed.

Note that examples of the nickname acquisition conditions include: that the training target character has acquired a prescribed number of fans; that the training target character has an ability parameter or an aptitude parameter at a value equal to or greater than a prescribed value; that the training target character has acquired a prescribed skill; that the training target character has achieved a race victory number equal to or greater than a prescribed number; and that the training target character has achieved a prescribed arrival order (for example, the first place) in a specific race.

In addition, when the memo input button 186b is tapped, a text input screen (not shown) is displayed. On the text input screen, for example, hiragana, katakana, numbers, English characters, etc. can be input in nine letters or less. The letters input on the text input screen are stored in association with the trained character as a memo. In the case in which a memo is stored for the trained character, the memo (in this case, abcdefg) is displayed on the left side of the memo input button 186b.

Note that the sorting conditions of the trained character icons 182 on the trained character list screen 180 include the above-described memo. Therefore, the player can even more easily search for the trained characters to be used as the inheritance characters by registering the trained characters in association with the memo.

In addition, below the ability parameter display field 186, an aptitude-information display field 187 is displayed. In the aptitude-information display field 187, aptitude parameters respectively related to the ground aptitudes for grass and dirt, aptitude parameters respectively related to the distance aptitudes for short distance, mile, middle distance, and long distance, and aptitude parameters respectively related to the running style aptitudes for front runner, stalker, midfield, and closer are displayed.

Below the aptitude-information display field 187, a miscellaneous-information display field 188 is displayed. In the miscellaneous-information display field 188, a skill display tab 188a, an inheritance-information display tab 188b, a training-information display tab 188c, and a close operation portion 188d are provided. As shown in FIG. 12, when the skill display tab 188a is tapped, the acquired skills of the trained character are displayed in the miscellaneous-information display field 188. In addition, as shown in FIG. 13, when the inheritance-information display tab 188b is tapped, the inheritance information of the trained character is displayed.

Note that, in the miscellaneous-information display field 188, the inheritance information is displayed on the basis of the trained characters that can be set as the inheritance characters and the inheritance characters employed in training the trained characters. The inheritance information includes information about the inheritance characters used to train said trained characters, the factor information of the trained characters, and the factor information of the inheritance characters. Here, the inheritance information is displayed in a list for each of the trained characters.

Specifically, the factor information associated with the trained characters and the factor information associated with the inheritance characters of said trained character are displayed for each of the characters. Therefore, by scrolling the miscellaneous-information display field 188 in the top-to-bottom direction, the player can confirm the factor information of each of the three characters.

In the miscellaneous-information display field 188, the basic ability factors, the aptitude factors, and the character factors are displayed in different colors. For example, the basic ability factors are displayed in blue, the aptitude factors are displayed in red, and the character factors are displayed in green. Note that, in the miscellaneous-information display field 188, each of the race factors and the skill factors are displayed in white. In addition, stars indicating factor levels are displayed superimposed on each factor information.

In addition, as shown in FIG. 14, when the training-information display tab 188c is tapped, the training information of the trained characters is displayed. Note that the training information includes the categories of the support cards used when training said trained characters, the characters in the first inheritance generation and the second inheritance generation, records of individual races in the training game, and, additionally the evaluation points.

Accordingly, in the character detail dialog 185A, the player can confirm various types of information related to the trained characters. Therefore, the player can easily ascertain the information associated with the inheritance characters to be included in the deck, and thus, it is possible to enhance the convenience for the player.

Note that, when the close operation portion 188d is tapped in the character detail dialog 185A, the character detail dialog 185A is closed and the trained character list screen 180 is displayed on the display 26. In addition, as shown in FIGS. 7A, 7B, 7C, and 7D, on the upper right section of the inheritance-character selection screen 170 and the trained character list screen 180, a skill display button 172 is provided. When the skill display button 172 is tapped, skills that the trained character provisionally selected as an inheritance character could potentially acquire are displayed in a list.

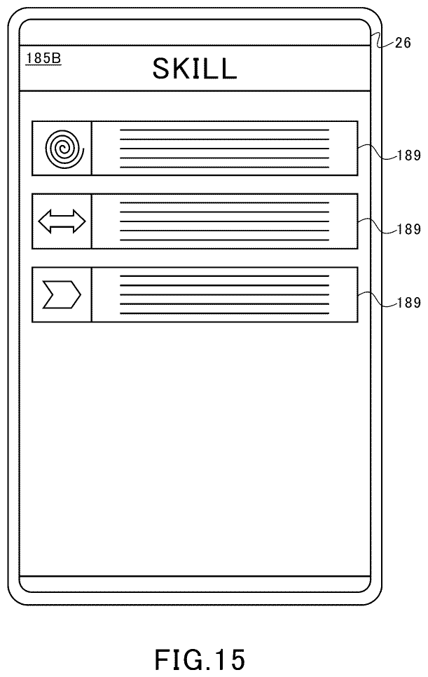

FIG. 15 is a diagram for explaining a skill display dialog 185B. In the skill display dialog 185B, icons corresponding to the skills and skill-description display fields 189 indicating details of the skills are displayed. As the skills displayed in the skill-description display fields 189, all skills that the training target character could potentially acquire in the case in which the currently selected trained character is used as an inheritance character are displayed in a list.

In other words, in the skill display dialog 185B, information related to skills associated with the character factors or the skill factors that the trained character possesses is displayed in a list. As shown in FIG. 7C, in the case in which the skill display button 172 is tapped in a state in which one trained character is selected as an inheritance character, skills associated with the character factors and the race factors that said trained character (inheritance character) possesses are displayed in the skill display dialog 185B.

On the other hand, as shown in FIG. 7D, in the case in which the skill display button 172 is tapped in a state in which two trained characters are selected as inheritance characters, the skills associated with the character factors and the race factors that the two trained characters (inheritance characters) respectively possess are displayed in the skill display dialog 185B.

As has been described above, in this embodiment, the inheritance information (factor information) is displayed in a list in the character detail dialog 185A for each of the trained characters that can be set as an inheritance character. In addition, the information (skills) associated with the inheritance information (factor information) is displayed in a list in the skill display dialog 185B. At this time, the character detail dialog 185A and the skill display dialog 185B are displayed on the basis of the trained characters that can be set as the inheritance characters and the inheritance characters that are employed to generate the trained characters. The displays in the character detail dialog 185A and the skill display dialog 185B enhance the convenience for the player.

Note that, here, the skills that can be acquired as a result of factor activations are displayed in the skill display dialog 185B. However, in the skill display dialog 185B, factor information for obtaining clues of the skills may be displayed instead of the information related to the skills. In either case, the inheritance information (factor information) is classified into a plurality of categories (factor categories), and, in the skill display dialog 185B, the inheritance information (character factors and race factors) classified into prescribed categories or the information (information related to the skills) associated with the inheritance information may be displayed. Accordingly, it is considered that the skill display dialog 185B displays, after extracting some inheritance information, information about the extracted inheritance information.

Also, in the state in which two trained characters are provisionally selected, the next operation portion 154 provided in the inheritance-character selection screen 170 is enabled. When the enabled next operation portion 154 is tapped, the trained characters in the provisionally selected state are provisionally registered in the deck as the inheritance characters and a support-card organization screen 190, described later, is displayed.

Note that, on the inheritance-character selection screen 170, the player must always select two trained characters as the inheritance characters. In the state in which two inheritance characters are not in the provisionally selected state, as shown in FIGS. 7A and 7C, the next operation portion 154 is grayed out and the player operation thereof is not accepted. In addition, on the inheritance-character selection screen 170, the return operation portion 153 is provided and, when the return operation portion 153 is tapped, the training-target-character selection screen 150 is displayed.

### <Support Card Registration>

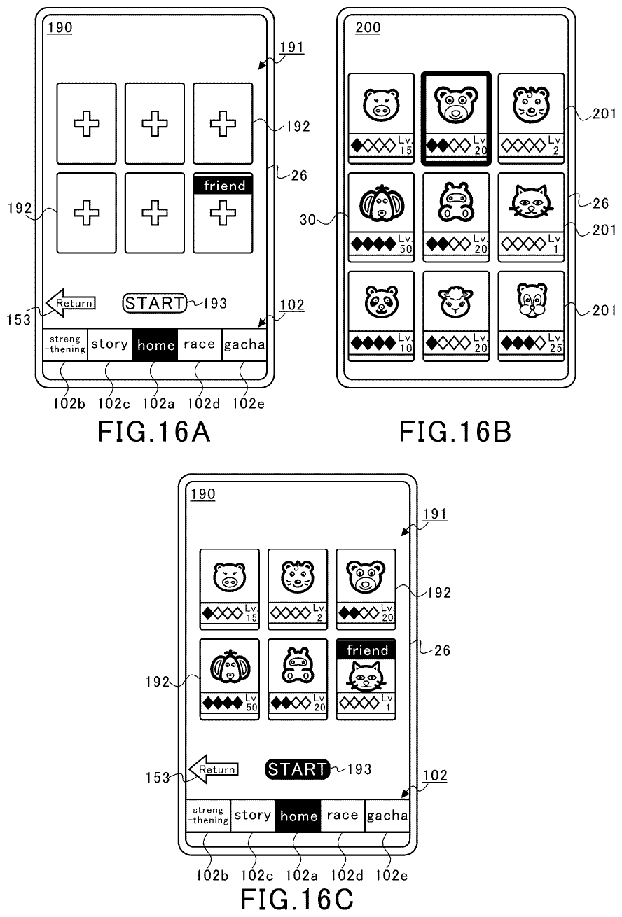

FIG. 16A is a first diagram for explaining the support-card organization screen 190. When two inheritance characters are registered on the inheritance-character selection screen 170, the support-card organization screen 190 shown in FIG. 16A is displayed. In a center section of the support-card organization screen 190, a support-card display area 191 is provided. The support-card display area 191 includes a plurality of support-card display frames 192. In addition, in a bottom section of the support-card organization screen 190, the return operation portion 153 indicated as “Return” and a start operation portion 193 indicated as “START” are displayed.

In the support-card display area 191, the plurality of (in this case, six) support-card display frames 192 are displayed. As many support-card display frames 192 as the support cards that the player can set are displayed. Note that the support-card display frames 192 are displayed empty when the support-card organization screen 190 is initially displayed.

In this embodiment, the player can set six types of the support cards in the deck. Note that, of the six types that the player can set, some (for example, five types) can be selected from the support cards that the player owns. In addition, of the six types that the player can set, some others (for example, one type) can be selected from the support cards that other players, such as the friends, have set as the rental cards.

FIG. 16B is a diagram for explaining a support-card selection screen 200. When a support-card display frame 192 (excluding the support-card display frame 192 displayed in the lower right section) is tapped on the support-card organization screen 190 in FIG. 16A, the support-card selection screen 200 shown in FIG. 16B is displayed on the display 26. On the support-card selection screen 200, card icons 201 corresponding to the support cards that the player owns are displayed in a list. By tapping a card icon 201 displayed on the support-card selection screen 200, the player can select the support card.

Note that, although the illustration is omitted, when the support-card display frame 192 displayed in the lower right section is tapped on the support-card organization screen 190, support cards that are set as the rental cards by the friends or players extracted on the basis of a prescribed conditions, such as a lottery, are displayed on the support-card selection screen 200. By tapping a support card displayed on the support-card selection screen 200 at this time, the player can select one support card belonging to a friend. Accordingly, the player can use a support card that another player owns in the training game.

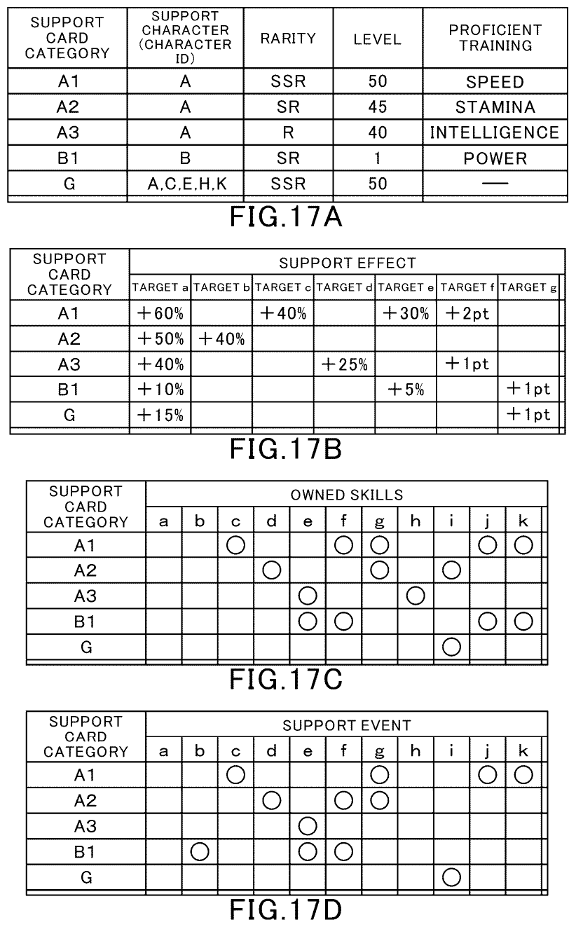

FIG. 17A is a diagram for explaining a support card table. As shown in FIG. 17A, the support card table stores the types (specifically, character ID), the rarity, the level, and the proficient training of the support characters in association with each other in accordance with the categories (specifically, support card IDs) of the support cards that the player owns.

Each of the support cards is associated with at least one support character (character ID). In other words, a support card ID is always associated with one or more character IDs. Here, support cards each associated with one support character and a support card associated with five support characters are provided. However, it is not limited thereto, and a support card may be associated with, for example, two to four or six or more support characters.

The support cards in the categories A1, A2, and A3 shown in FIG. 17A all are associated with a character A. In addition, the support card in the category G is associated with five characters, namely, characters A, C, E, H, and K. In the following, there are cases in which a support card associated with a plurality of characters, as with the support card in the category G, will be referred to as a group support card. Note that, here, a proficient training is not set for the group support card. However, a proficient training may be set for the group support card as with other support cards.

In this embodiment, the rarity is set for each of the support cards. The rarity is provided in three steps, namely, rare (R), super rare (SR), and super special rare (SSR). Note that R corresponds to the lowest rarity and SSR corresponds to the highest rarity. In this embodiment, support cards with higher rarity tend to have greater support effects, described later. In addition, in this embodiment, support cards with higher rarity tend to have a greater number of owned skills and a greater number of support events, described later.

The level of the support cards is provided in 50 steps from level 1 to level 50. The player can increase the level of the support cards, and the level increased by the player is stored for each of the support cards. Note that the level of the support cards can be increased by using the in-game currency, the items, etc. Note that an upper limit is provided to the level of the support cards depending on the rarity thereof.

For example, level 20 is set as the upper limit for rarity-R support cards, level 25 is set as the upper limit for rarity-SR support cards, and level 30 is set as the upper limit for rarity-SSR support cards.

Note that the upper limit of the levels can be increased in a step-wise manner in the case in which prescribed conditions are met. For example, the upper limit of the rarity-R support cards may be allowed to be increased to level 40 at a maximum, the upper limit of the rarity-SR support cards may be allowed to be increased to level 45 at a maximum, and the upper limit of the rarity-SSR support cards may be allowed to be increased to level 50 at a maximum.

FIG. 17B is a diagram for explaining a support effect table. As shown in FIG. 17B, the support effect table stores support effect in accordance with the categories of the support cards that the player owns.

The support effects increase various kinds of statuses in the training main game. The support cards are provided with a plurality of support effect targets. Examples of the support effect targets include the physical strength, the speed, the stamina, the power, the guts, the intelligence, etc.

FIG. 17C is a diagram for explaining an owned skill table. As shown in FIG. 17C, in the owned skill table, owned skills are set for each of the support cards that the player owns. In this embodiment, the owned skills are set for the respective support cards, as with the characters that can be set as the training target character owning the owned skills. In the training main game, occurrences of clue events make it possible for the training target character to own the owned skills set for the respective support cards.

FIG. 17D is a diagram for explaining a support event table. As shown in FIG. 17D, the support event table stores support events that could occur in accordance with the support cards that the player owns. A support event is an event that could potentially occur while the training main game is being executed. In the case in which a support event has occurred, there are cases in which the values of various kinds of statuses of the training target character increase or decrease.

For example, the occurrence of a support event may be determined in accordance with the turn number or the occurrence of a support event may be determined by a prescribed lottery. In addition, a plurality of support events may be selected so as to occur in 1 turn. In any case, the support event that occurs may be determined in accordance with a prescribed determination method set in advance.

Note that support events may include a first clue event that could occur at the start of a turn of the training game, a second clue event that could occur after training is executed (described later) in the training game, a first ability event that could occur at the start of a turn in the training game, a second ability event that could occur after training is executed in the training game, etc. The first clue event and the second clue event are events that make it possible to own or acquire the skills. In addition, the first ability event and the second ability event are events that increase or decrease the numerical values of the ability parameters of a character. In the following, the first clue event and the first ability event will collectively be referred to as first events and the second clue event and the second ability event will collectively be referred to as second events.

FIG. 16C is a second diagram for explaining the support-card organization screen 190. In this embodiment, when all six support cards are selected, as shown in FIG. 16C, it becomes possible to operate the start operation portion 193. In contrast, in the case in which all six support cards are not selected, as shown in FIG. 16A, it is not possible to operate the start operation portion 193.

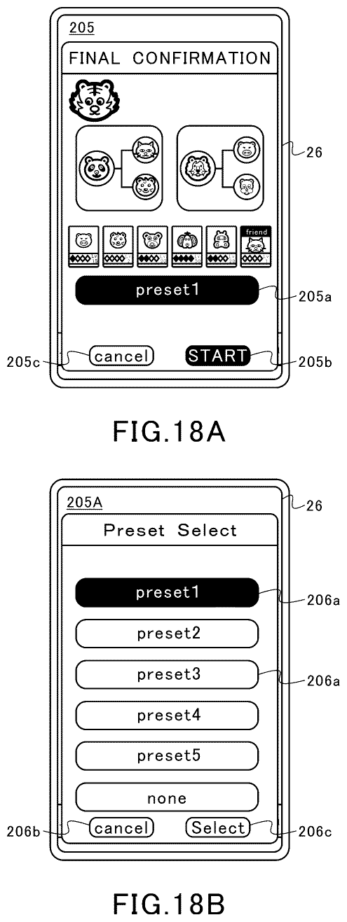

Note that when the return operation portion 153 is operated on the support-card organization screen 190, the inheritance-character selection screen 170 shown in FIG. 7D is displayed on the display 26. In addition, as shown in FIG. 16C, when the start operation portion 193 is tapped on the support-card organization screen 190, the selected support cards are provisionally registered and a final confirmation screen 205 (FIG. 18A) is displayed.

FIG. 18A is a diagram for explaining the final confirmation screen 205. FIG. 18B is a diagram for explaining a preset selection screen 205A. On the final confirmation screen 205, the training target character, the trained characters constituting the first inheritance group, the trained characters constituting the second inheritance group, and the support cards that the player has selected are displayed. In addition, on the final confirmation screen 205, a preset display portion 205a is displayed. The preset display portion 205a indicates a currently selected present number.

Here, a preset refers to reservation information for the race in which the training target character is to be entered in the training main game. The player can create a preset by selecting an arbitrary race from all of the races. It is possible to save a plurality of presets, and one of the saved presents can be selected on the final confirmation screen 205. Specifically, when the preset display portion 205a is tapped, the preset selection screen 205A shown in FIG. 18B is displayed.

On the preset selection screen 205A, preset read-out buttons 206a corresponding to the saved presents are displayed. The player can set the preset by tapping a select operation portion 206c after tapping one of the preset read-out buttons 206a. Note that, when the select operation portion 206c is tapped, the preset selection screen 205A is closed and the final confirmation screen 205 is displayed. In addition, when a cancel operation portion 206b on the preset selection screen 205A is tapped, the preset selection screen 205A is displayed without changing the preset.

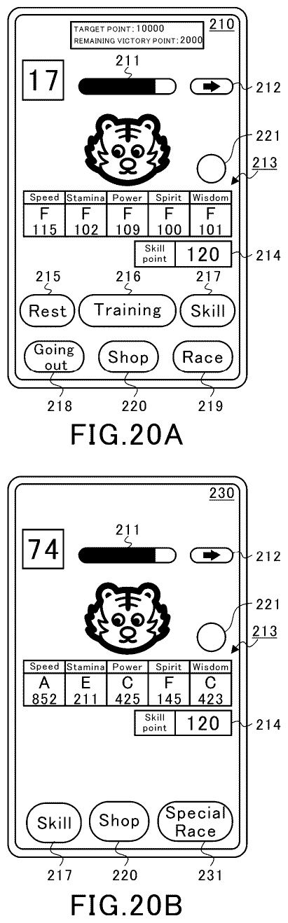

Note that, when the cancel operation portion 205c is tapped on the final confirmation screen 205, the support-card organization screen 190 is displayed. On the other hand, when a start operation portion 205b is tapped, a game screen 210 (FIG. 20A) is displayed on the display 26.

Note that this embodiment has a restriction so that the category of a character set as the training target character and the categories of characters set as the support characters do not overlap when registering support cards. Specifically, the character IDs are associated with the characters that can be set as the training target character. In addition, the character IDs of one or more characters that serve as the support characters are always associated with the support cards.

Here, one training target character and six support cards are registered. At this time, there cannot be any overlap between the character ID of the training target character and the character IDs of the support characters. Therefore, the player cannot include, for example, a support card associated with the same character as the training target character in the deck. In addition, the player cannot include a plurality of support cards with which the same characters are associated in the deck.

Furthermore, a plurality of character IDs associated with a group support card do not overlap with each other and all are different. In the case in which a group support card is included in the deck, there cannot be any overlap between all of the character IDs associated with the group support card, the character IDs associated with other support cards, and the character ID associated with the training target character. Accordingly, the player must organize the deck so that the character IDs do not overlap between the training target character and the support characters, as well as among the support characters.

Then, when the training target character, the inheritance characters, and the support cards are registered, the preparation stage processing is ended.

### <Training Stage Processing>

When the preparation stage processing is ended, the training stage processing starts. In the training stage processing, the training target character can be trained. Note that, in the following, in order to facilitate the understanding, first, a basic flow of the training main game will be described.

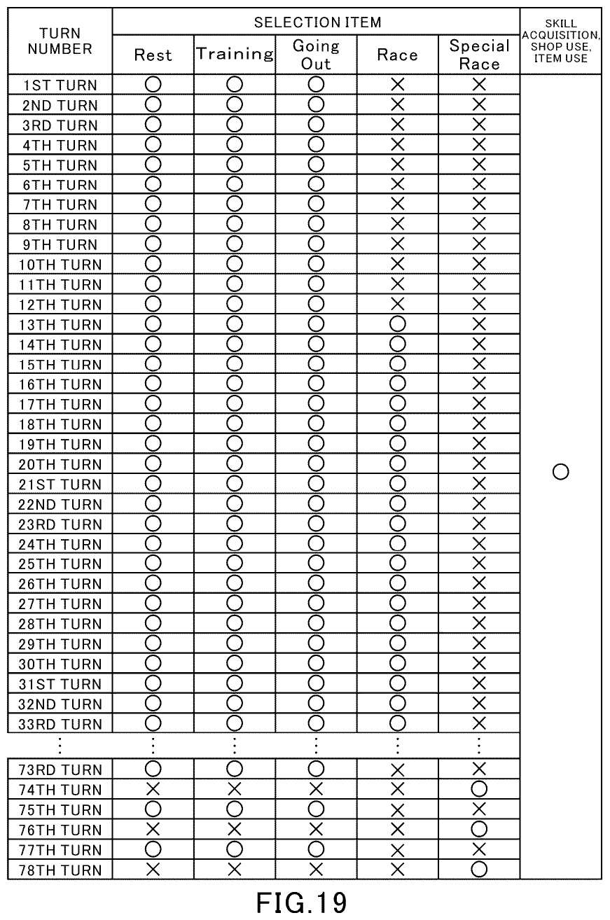

FIG. 19 is a diagram for explaining a selection item table. Note that, in this case, a common selection item table is employed for all training target characters. However, a selection item table may be provided for each of the training target character categories. As shown in FIG. 19, a training game consists of 1^{st} to 78^{th} turns, and the gaming properties thereof are such that various kinds of parameters are updated in accordance with results of selections made by the player in each turn. In addition, according to the selection item table, the items the player can select are set in advance for the respective turns.

FIG. 20A is a diagram for explaining the game screen 210. FIG. 20B is a diagram for explaining a special race screen 230. When the procedure proceeds to the training stage processing, the game screen 210 shown in FIG. 20A is displayed on the display 26. In a top section of the game screen 210, a physical-strength display portion 211 and a condition display portion 212 are displayed. The training target character is provided with a “physical strength” parameter. The “physical strength” parameter is mainly employed in calculating a failure rate, which is the probability of failing a training, described later. The physical-strength display portion 211 is displayed so that it is possible to visually ascertain the current remaining amount of the “physical strength” of the training target character relative to the upper limit value of the “physical strength”.

In addition, the training target character is provided with a “condition” parameter. The condition display portion 212 is displayed so that it is possible to visually ascertain the current “condition” of the training target character in a plurality of steps (five steps of very bad, bad, normal, good, and very good). Having a higher “condition” parameter makes the race development advantageous for the training target character and, in addition, increases the amounts by which the ability parameters increase as a result of the training.

In addition, as shown in FIG. 20A, in a center section of the game screen 210, an image of the training target character, a status display portion 213, a skill-point display portion 214 are displayed. The status display portion 213 shows the current status of the training target character in numerical values and a plurality of steps of ranks (16 steps of G+, F, F+, E, E+, D, D+, C, C+, B, B+, A, A+, S, SS, and SS+). Specifically, in this embodiment, the numerical values and the ranks are displayed for the respective ability parameters of “Speed”, “Stamina”, “Power”, “Spirit” (guts), and “Wisdom” (intelligence). In addition, the skill-point display portion 214 shows, in a numerical value, the remaining amount of the skill points that the training target character owns in the training game.

In addition, as shown in FIG. 20A, in a bottom section of the game screen 210, a rest operation portion 215 indicated as “Rest”, a training operation portion 216 indicated as “Training”, a skill operation portion 217 indicated as “Skill”, an outing operation portion 218 indicated as “Going Out”, an individual race operation portion 219 indicated as “Race”, and a shop operation portion 220 indicated as “Shop” are displayed. In addition, in the top section of the game screen 210, the current turn number is displayed. In addition, in the center section of the game screen 210, an item operation portion 221 is displayed.

As shown in FIG. 19, the player can select, in each turn, any one of “Rest” (rest operation portion 215), “Training” (training operation portion 216), “Going Out” (outing operation portion 218), “Race” (individual race operation portion 219), and “Special Race” (special race operation portion 231), described later. At this time, as shown in FIG. 19, the item that can be selected in each turn is set in advance.

When the “Rest” item is selected, the physical strength recovers and, when the “Going Out” item is selected, one of or both of the physical strength and the condition increase. In addition, when the “Training” item is selected, it becomes possible to execute a training, described later, when the “Race” item is selected, the training target character can be entered in an individual race, and, when the “Special Race” item is selected, the training target character can be entered in a special race, described later. When the game results are derived after the “Rest”, “Training”, “Going Out”, “Race”, or “Special Race” item is selected, the current turn is ended and the procedure proceeds to the next turn.

In this embodiment, turns in which the rest operation portion 215, the training operation portion 216, the outing operation portion 218, and the individual race operation portion 219 cannot be selected are set, such as the 74^{th} turn, the 76^{th} turn, and the 78^{th} turn shown in FIG. 19. In such a turn, the special race screen 230 is displayed on the display 26, as shown in FIG. 20B.

On the special race screen 230, the special race operation portion 231 indicated as “Special Race”, the skill operation portion 217, the shop operation portion 220, and the item operation portion 221 are displayed, and the player can select any one of the operation portions. When the special race operation portion 231 is selected, a special race, which is different from the individual race executed in the case in which the individual race operation portion 219 is selected, is executed. The special race takes place a total of three times, that is, one race each in the 74^{th} turn, the 76^{th} turn, and the 78^{th} turn and the overall victory is determined on the basis of an accumulated value of victory points, described later.

In contrast, the skill operation portion 217, the shop operation portion 220, and the item operation portion 221 are set to be always selectable in all turns. Note that, although the details will be described later, a turn does not end even if the skill acquisition, the shop utilization, and the item use are performed as a result of operating the skill operation portion 217, the shop operation portion 220, and the item operation portion 221.

In this embodiment, when an individual race or a special race is executed, the training target character can acquire the victory points and the special currency in accordance with the arrival order in the race. The acquisition amounts of the victory points and the special currency are set in each race according to the arrival order. The numerical values of the victory points and the special currency to be acquired increase as the arrival order increases.

In addition, greater amounts of the victory points and the special currency can be acquired in a race with a higher difficulty level. For example, among GI, GII, and GIII grades, greater amounts of the victory points and the special currency can be acquired in a race with a higher grade.

In the training game of this embodiment, a target point set in advance is set for each of prescribed turn sections. In this embodiment, the training game consists of the 1^{st} to 78^{th} turns. Here, from 1^{st} to 24^{th} turns are referred to as the early turn section, from the 25^{th} to 48^{th} turns are referred to as the mid turn section, the 49^{th} to 72^{nd} turns are referred to as the late turn section, and 73^{rd} to 78^{th} turns are referred to as the final turn section.

The target point is set for each of the early turn section, the mid turn section, and the late turn section. The amounts of the target point set for the respective turn sections may be the same or different. The player can advance the training game to the final turn section by sequentially achieving the respective target points by accumulating the victory points acquired in the respective turn sections.

In addition, the target points are set on the basis of the aptitude parameters related to the ground aptitudes of the training target character and the aptitude parameters related to the distance aptitudes thereof. For example, the target points of a training target character having a higher grass aptitude parameter than the dirt aptitude parameter is set to be greater than the target point of a training target character having a higher dirt aptitude parameter than the grass aptitude parameter. In addition, for example, different target points may be set in accordance with the category with the highest parameter among the aptitude parameters for short distance, mile, middle distance, and long distance. In addition, different target points may be set in accordance with combinations of the aptitude parameters related to the ground aptitude and the distance aptitude. Accordingly, there are cases in which the goal points set for the individual training target characters are different in accordance with the aptitude parameters related to the ground aptitude and the distance aptitude. Note that the target points may be set on the basis of the aptitude parameters related to the running style aptitude in addition to the ground aptitude and the distance aptitude of the training target characters.

In the top section of the game screen 210 shown in FIG. 20A, the target point for the current turn section and remaining victory points, which are victory points required to reach the target point are displayed. As a result of the target point and the remaining victory points being displayed, the player can ascertain the amount of the victory points he/she should acquire in the current turn section.

Note that the victory points that the player has acquired are reset in each of the early turn section, the mid turn section, and the late turn section. However, the victory points that the player has acquired may be sequentially accumulated without being reset in the respective turn sections.

When the target points are reached in all of the early turn section, the mid turn section, and the late turn section, the player can advance to the final turn section of the training game. In the final turn section, all three races (a first race, a second race, and a third race) of the special race are executed, and the final victory is determined on the basis of the accumulated value of the victory points in accordance with the race results.

As the special race proceeding advances, the amount of the victory points that can be acquired increases. Specifically, of all three races, the amount of the victory points that can be acquired by coming in the first place in the second race is greater than the amount of the victory points that can be acquired by coming in the first place in the first race, and the amount of the victory points that can be acquired by coming in the first place in the third race is greater than the amount of the victory points that can be acquired by coming in the first place in the second race.

In addition, so-called non player characters (hereinafter referred to as NPCs) that are entered in the races to compete against the training target character over the win or lose in all three races have the same character IDs. However, the parameters of the NPCs are set to increase as the special race proceeding advances. For example, in the order of the first race, the second race, and the third race, correction values to be added to the ability parameters of the NPCs are increased to increase the ability parameters of the NPCs. Note that, in the final turn section, the training game does not end even if the rank in the special race is equal to or below a prescribed rank (for example, the second place or below), and the special race can be continued.

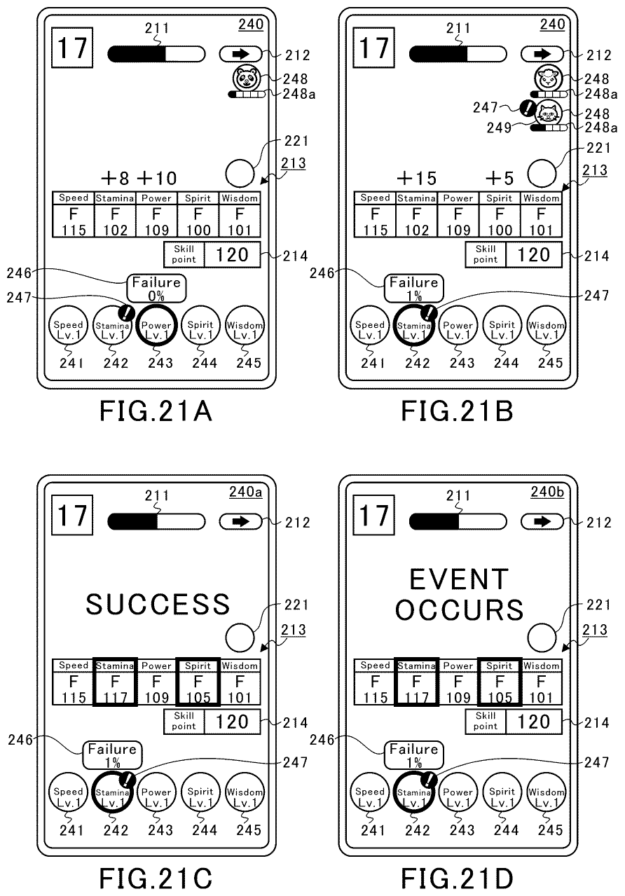

FIG. 21A is a first diagram for explaining a training screen 240. FIG. 21B is a second diagram for explaining the training screen 240. When the training operation portion 216 on the game screen 210 is operated, the training screen 240 is displayed on the display 26.

As shown in FIG. 21A, training items are displayed in a bottom section of the training screen 240. Here, a speed operation portion 241 indicated as “Speed”, a stamina operation portion 242 indicated as “Stamina”, a power operation portion 243 indicated as “Power”, a guts operation portion 244 indicated as “Spirit”, and an intelligence operation portion 245 indicated as “Wisdom” are displayed.

When the player taps one of the operation portions 241-245 once, the training item corresponding to the tapped operation portion 241, 242, 243, 244, or 245 is provisionally selected. At this time, the operation portion 241, 242, 243, 244, or 245 corresponding to the provisionally selected training item is displayed in an emphasized manner. FIG. 21A shows a state in which the power operation portion 243 is provisionally selected. In addition, FIG. 21B shows a state in which the stamina operation portion 242 is provisionally selected.

In addition, each of the operation portions 241-245 is displayed together with a training level of the training item. The training level is a parameter that increases in accordance with the number of times each training item is selected, and, as the training level increases, the amount by which the ability parameter increases when the training is executed increases. The training level is initially set at level 1 and increased to level 5 at a maximum.

In addition, with the provisionally selected operation portion 241, 242, 243, 244, or 245, a failure-rate display portion 246 indicated as “Failure” is displayed. The failure rate, which is indicated by a numerical value in the failure-rate display portion 246, is set so as to increase inversely proportional to the remaining amount of the physical strength displayed in the physical-strength display portion 211.

In addition, in the status display portion 213, the amounts by which the ability parameters increase in the case in which the training corresponding to the provisionally selected operation portion 241, 242, 243, 244, or 245 is executed and succeeds are displayed. For example, in the example shown in FIG. 21A, the power operation portion 243 is provisionally selected and “+8” is displayed for “Stamina” and “+10” is displayed for “Power” in the status display portion 213. In addition, in the example shown in FIG. 21B, the stamina operation portion 242 is provisionally selected and “+15” is displayed for “Stamina” and “+5” is displayed for “Spirit” in the status display portion 213.

In addition, in the case in which the training is executed and succeeds, an event notification display 247 is displayed in the operation portion 241, 242, 243, 244, or 245 corresponding to the training item in which a prescribed event occurs. Note that, in the event notification display 247, different display forms can be employed in accordance with the event categories.

Here, in the turns other than the 74^{th} turn, the 76^{th} turn, and the 78^{th} turn in the final turn section, in which the special races are executed, whether or not the support characters associated with the support cards included in the deck are deployed in each training is determined when starting a turn. In other words, whether or not the support cards or the support characters are associated with the training items is determined.

In addition, in the case in which the support characters are associated with the training items, the support characters are associated with any one of the five training items. As shown in FIG. 21B, in an upper right section of the training screen 240, deployed character icons 248 indicating the support characters deployed in the training are displayed for each of the training item of the provisionally selected operation portion 241, 242, 243, 244, or 245. When the support characters are deployed, the amounts by which the ability parameters increase when the training succeeds increase.

Here, a bond gauge is set for each support character. The bond gauge takes a value of, for example, 0 to 100. The current value of the bond gauge can be visually ascertained by means of a bond-gauge display portion 248a displayed for each deployed character icon 248.

The initial value of the bond gauge is 0 and the maximum value thereof is 100. However, depending on the support cards, the support effect that increases the initial value of the bond gauge, such as increasing the initial value by 10, is set. In this case, the initial values of the bond gauge are greater than 0 from the start of the training main game for the support characters associated with the support card having this support effect.

In addition, the bond gauge increases when increase conditions set in advance are met. The increase conditions include, for example, that the training in which the support character is deployed is selected (in this case, the training is assumed to be success). In addition, the increase conditions include, for example, that a prescribed item purchased in the shop, described later, is used or that a first event or a second event, described later, has occurred.

The amounts by which the ability parameters increase when the training in which the support characters are deployed (hereinafter referred to as joint training) succeeds increase, as the values of the bond gauges of the deployed support characters increase. In addition, in the joint training in which the support characters are deployed, there are cases in which a friendship training occurs. When the friendship training occurs, the amounts by which the ability parameters increase when the training succeeds increase by, for example, 10-50%.

The friendship training can simultaneously occur for a plurality of support characters. Therefore, when the friendship training simultaneously occurs for the plurality of support characters, for example, in one turn, it is possible to considerably increase the ability parameters in one round of training.

However, occurrence conditions are set for the friendship training. Although details will be described later, friendship-training occurrence conditions are different between the group support cards and other support cards. For the support cards other than the group support cards, set friendship-training occurrence conditions include that the values of the bond gauges of the support characters are equal to or greater than a prescribed value (for example, 80) and that the support characters are deployed in a prescribed training set for each support card.

Here, for the support cards other than the group support cards, a proficient training is set as the prescribed training serving as a friendship-training occurrence condition. In other words, with a support card with which only one support character is associated, the friendship training could occur only in the case in which the support character is deployed in the proficient training thereof. For example, with a support card in which the speed training is set as the proficient training, the friendship training could occur only in the case in which the support character associated with said support card is deployed in the speed training.

In contrast, the friendship-training occurrence conditions that are different from other support cards are set for the group support cards associated with the plurality of support characters. Although details will be described later, during the training main game, there are cases in which a bonus zone is set. In this bonus zone, the friendship training based on the group support card can occur. In the bonus zone, the friendship training occurs regardless of the training item in which the group support card is deployed. In other words, in the bonus zone, the friendship training based on the group support card occurs as a result of the group-support-card deployed training being executed regardless of the training item.

Note that, as has been described above, the plurality of characters are associated with the group support card as the support characters. However, the group support card is associated with each training as one card and the plurality of support characters are not separately associated with each training.

In addition, in the case in which the joint training succeeds, there are cases in which a prescribed event occurs in correspondence to a character for which the deployed character icon 248 is displayed. In this case, the event notification display 247 is displayed on the corresponding deployed character icon 248. In the following, the deployed character icon 248 on which the event notification display 247 is displayed will be referred to as the event deployed character icon 249.

Note that the characters to be deployed in the training may include characters other than the support characters corresponding to the support cards that the player has registered in the preparation stage processing. For example, the character to be deployed in the training may be selected by means of a random lottery from among all support characters implemented in the game. In that case, the character icons 248 indicating the characters other than the registered support characters are displayed on the training screen 240.

In addition, an event associated with a character other than the support characters that the player has registered may occur when the joint training is executed. Here, the occurrence rate of the event associated with the character that the player has not registered is lower than the occurrence rates of the events associated with the support characters that the player has registered. In this case also, the event notification display 247 may be displayed on the character icon 248 displayed on the training screen 240.

FIG. 21C is a diagram for explaining a training-result notification screen 240a. When the provisionally selected operation portion 241, 242, 243, 244, or 245 is tapped again, the training corresponding to the tapped operation portion 241, 242, 243, 244, or 245 is executed. When the training is executed, the training-result notification screen 240a, which notifies success or failure of the training, is displayed on the display 26. Here, the word “Success” is displayed and the success of the training is notified to the player.

In addition, at this time, the ability parameters are updated and displayed in the status display portion 213 on the basis of the success of the training. In other words, the ability parameters of the training target character corresponding to the training item that the player has selected are updated.

In this case, the amounts by which the ability parameters increase in the case in which the training displayed in the status display portion 213 in FIG. 21A or 21B succeeds are added. In addition, the display in the physical-strength display portion 211 is updated in accordance with the executed training item. In the case in which any one of the speed, stamina, power, and guts trainings succeeds, the physical strength decreases. On the other hand, in the case in which the intelligence training is executed, the physical strength recovers.

In addition, in the case in which the training fails, there are cases in which a prescribed penalty is imparted. The specific examples of the penalty include a reduction of the physical strength, a reduction in the numerical values of the ability parameters, and deterioration of the condition. Note that it is possible to set, for example, the penalty to be imparted when the failure rate is high to be more disadvantageous (for example, the physical strength is reduced by a greater amount, the ability parameters are reduced by greater amounts, and the condition deteriorates by a greater number of steps) than the penalty to be imparted when the failure rate is low.

In addition, the specifics of the penalty may be determined in accordance with the training items. For example, the speed ability parameter may be reduced in the case in which the speed training fails and the power ability parameter may be reduced in the case in which the power training fails. In addition, it is possible to configure some of the training items (for example, intelligence) such that the penalty is not imparted even if the training fails.

FIG. 21D is a diagram for explaining an event screen 240b. When the display of the training-result notification screen 240a is ended, the event screen 240b is displayed on the display 26. On the event screen 240b, various kinds of events are executed. Note that there are cases in which a plurality of events occur during one turn.

For example, in the case in which a first clue event or a second clue event has occurred, a skill clue is obtained. When the skill clue is obtained, the player can acquire a skill by using the skill points. A plurality of types of skills are provided, and there are cases in which a prescribed ability is activated for each skill. An activation condition and an effect are set for each skill and, in the case in which each activation condition is met, the effect that is set in advance is activated. There are cases in which the skills are activated while the individual races or the special races, described later, are being executed.

The events include, in addition the first and second clue events that allow the player to own a skill, an event that recovers the physical strength, an even that decreases the physical strength, first and second ability events that increase or decrease the ability parameters, an event that improves the condition, an event that worsens the condition, etc. Although details will be described later, the events include events for which turns in which the events occur are set in advance, and events that occur in the case in which a prescribed lottery is won. In addition, there are an event that occurs at the start of a turn and an event that occurs before a turn ends. When all events that have been determined to occur end, the game screen 210 related to the next turn is displayed.

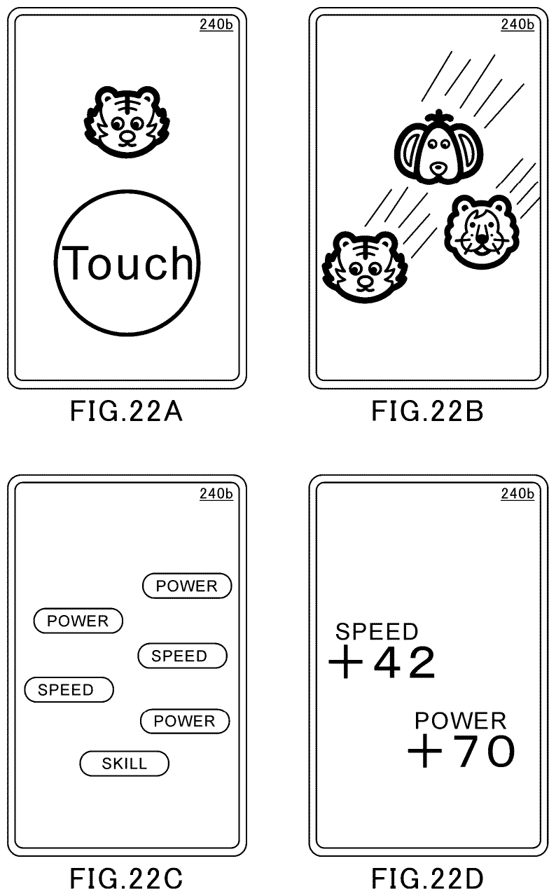

FIG. 22A is a first diagram for explaining an inheritance event. FIG. 22B is a second diagram for explaining the inheritance event. FIG. 22C is a third diagram for explaining the inheritance event. FIG. 22D is a fourth diagram for explaining the inheritance event. In the above-described factor activation turns, inheritance events occur in association with the start of the turns. Note that the inheritance events are common scenario events, described later, and always occur in the same turns regardless of the scenario that the player has selected. In this embodiment, although the 1^{st} turn, the 31^{st} turn, and the 55^{th} turn are set to be the factor activation turns, here, a case in which an inheritance event occurs in the 31^{st} turn will be described.

When the 31^{st} turn starts, first, as shown in FIG. 22A, the training target character and an operation portion indicated as “Touch” are displayed on the event screen 240b. When the operation portion displayed on the event screen 240b is tapped, animated images including the training target character and the two inheritance characters are displayed, as shown in FIG. 22B. In addition, when the operation portion is tapped, lotteries are performed to determine whether or not factors are activated with regard to all of the factors that a total of six trained characters in the first inheritance generation and the second inheritance generation possess.

Then, as shown in FIG. 22c, the factors for which the activation determination lotteries are won and the activation thereof are determined are displayed. Subsequently, as shown in FIG. 22D, the types of the ability parameters or the aptitude parameters that increase due to the factor activation and the amounts by which said parameters increase are displayed and the parameters are updated. When the inheritance event ends, the game screen 210 shown in FIG. 20A is displayed, and it becomes possible for the player to select one of the items. At this time, the status display portion 213 is in a state in which the amounts by which the ability parameters or the aptitude parameters increase, as displayed in the inheritance event, are added to the ability parameters or the aptitude parameters.

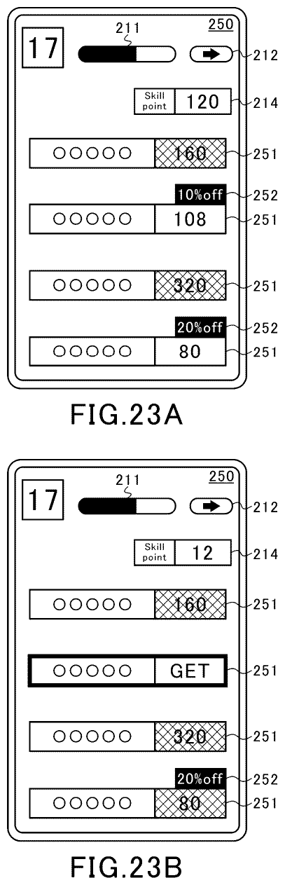

FIG. 23A is a first diagram for explaining a skill screen 250. FIG. 23B is a second diagram for explaining the skill screen 250. When the skill operation portion 217 on the game screen 210 is operated, the skill screen 250 shown in FIG. 23A is displayed on the display 26.

On the skill screen 250, skill display fields 251 are displayed. In the skill display fields 251, among others, acquired skills, owned skills set for the training target character in advance, and owned skills that are owned as a result of the occurrences of various kinds of events, etc. are displayed. In addition, in the case in which the first clue event or the second clue event occurs with respect to an owned skill, the skill points to be used to acquire said owned skill are discounted. Here, regarding the owned skills for which the clues are acquired, the skill points required to acquire said skills are displayed with discounts. At this time, discount-rate display icons 252 that indicate discount rates are displayed together in the skill display fields 251.

In addition, for the skills displayed on the skill screen 250, the activation conditions of the respective skills and the effects brought about when said skills are activated are displayed. In addition, in a top section of the skill screen 250, the physical-strength display portion 211, the condition display portion 212, and the skill-point display portion 214 are displayed. In addition, in the top section of the skill screen 250, the current turn number is displayed.

When the owned skills are acquired by using the skill points on the basis of the player operations, as shown in FIG. 23B, “GET” is displayed for the acquired skills to notify that the owned skills are acquired. In addition, in the skill-point display portion 214, the used skill points are subtracted from the displayed skill points.

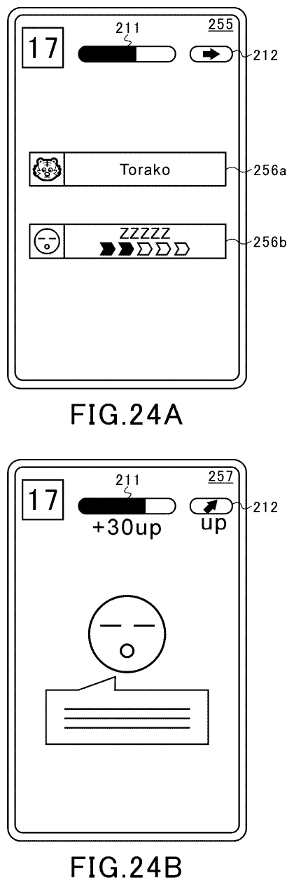

FIG. 24A is a first diagram for explaining an outing screen 255. When the outing operation portion 218 on the game screen 210 is operated, the outing screen 255 shown in FIG. 24A is displayed on the display 26. Here, as examples, a training-target-character selection operation portion 256a and a support-character selection operation portion 256b are displayed on the outing screen 255.

Here, the support cards other than the group support cards are classified into a normal character type and a friend character type. The normal-character-type support cards are the support cards that are associated with the characters that can be set to be the training target character. On the other hand, the friend-character-type support cards are the support cards that are associated with the characters that are different from the characters that can be set to be the training target character. In other words, friend-character-type support cards are associated with the characters that cannot be set to be the training target character. In the following, the characters that are associated with the friend-character-type support cards and that cannot be set to be the training target character will be referred to as the friend characters.

In the case in which the friend-character-type support cards are included in the deck, the outing screen 255 is displayed, as shown in FIG. 24A. The training-target-character selection operation portion 256a displayed on the outing screen 255 corresponds to the training target character. When the training-target-character selection operation portion 256a is tapped, a solo outing event in which the training target character goes out alone occurs. When the solo outing event occurs, a solo outing screen (not shown) is displayed.

A plurality (for example, three) of execution patterns are provided for the solo outing event. When the training-target-character selection operation portion 256a is tapped, the execution pattern of the solo outing event is determined by means of, for example, a lottery, and a solo outing screen corresponding to the determined execution pattern is displayed. The respective outing screens show contents indicating that the training target character goes out to different destinations from each other.

Accordingly, when the solo outing event occurs, the parameters of the training target character increase. The types of the parameters that increase due to the solo outing event and the amounts by which said parameters increase are set for each of the solo-outing-event execution patterns. Here, an execution pattern in which the condition of the training target character increases by two steps, and an execution pattern in which the condition of the training target character increases by one step and the physical strength increases by a prescribed value are included. Note that numerous execution patterns that are different from each other in terms of the amounts by which the condition and/or the physical strength increase may be provided. In addition, in the case in which the solo outing event occurs, the amounts by which the condition and/or the physical strength increase may be determined by means of lotteries.

FIG. 24B is a diagram for explaining a friend outing event screen 257. When the support-character selection operation portion 256b is tapped on the outing screen 255, a friend outing event occurs. When the friend outing event occurs, the friend outing event screen 257 is displayed, as shown in FIG. 24B. On the friend outing event screen 257, a friend character is displayed.

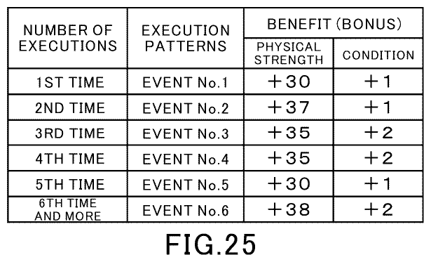

FIG. 25 is a diagram for explaining friend-outing-event execution patterns. Here, the friend-outing-event execution patterns to be determined are set in accordance with the number of times the friend outing events have been occurred, in other words, in accordance with the number of times the training target character has gone out with a friend character. In addition, as illustrated, benefits (bonuses) are set for the respective friend-outing-event execution patterns. As with the solo outing events, the physical strength and the condition are the target parameters of the benefits of the friend outing events.

However, the benefits brought about by the friend outing events are greater than the benefits brought about by the solo outing events. Note that the benefits brought about by the friend outing events and the solo outing events are mere examples. For example, the target parameters of the benefits may be different from each other between the two types of events. Alternatively, the target parameters of the benefits may be the same for the two types of events. Furthermore, the benefits brought about by the friend outing events may be set to be smaller than the benefits brought about by the solo outing events.

As shown in FIG. 24B, on the friend outing event screen 257, the friend character associated with the support card is displayed. In addition, on the friend outing event screen 257, the benefits brought about by the occurrence of the friend outing event are displayed (in this case, “+30 up” and “up”).

Note that a plurality of friend-character-type support cards are provided. On the friend outing event screen 257, different friend characters are displayed in accordance with the categories of the support cards. In addition, depending on the categories of the support cards, the execution patterns of the friend outing events that occur are different. However, the benefits brought about by the friend outing events may be the same for all of the support cards or may be different among the support cards.

Note that the player can include a plurality of friend-character-type support cards in the deck. In this case, on the outing screen 255, the support-character selection operation portions 256b are provided for the respective friend-character-type support cards.

In addition, when a group support card is included in the deck, the player can select the outing partner from among the support characters associated with the group support card. In the following, the support characters associated with the group support card will be referred to as the affiliated characters. In addition, five affiliated characters are associated with one group support card. The five affiliated characters will be referred to as the first affiliated character, the second affiliated character, the third affiliated character, the fourth affiliated character, and the fifth affiliated character.

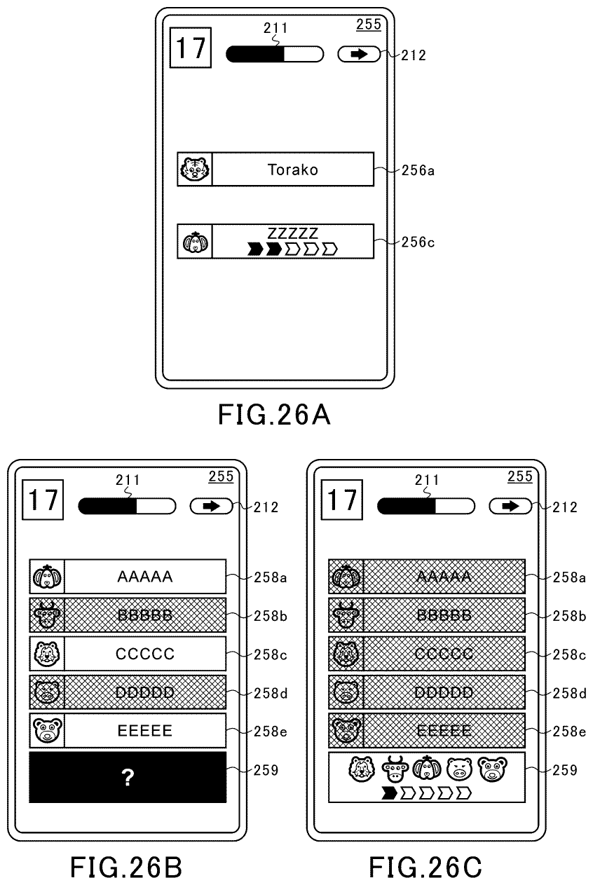

FIG. 26A is a second diagram for explaining the outing screen 255. FIG. 26B is a third diagram for explaining the outing screen 255. FIG. 26C is a fourth diagram for explaining the outing screen 255. FIG. 26A shows the outing screen 255 for the case in which the friend-character-type support cards are not included in the deck and a group support card is included in the deck.

In the case in which the group support card is included in the deck, the training-target-character selection operation portion 256a and a group-support-card selection operation portion 256c are displayed on the outing screen 255, as shown in FIG. 26A. Then, when the group-support-card selection operation portion 256c is tapped, a first affiliated-character selection operation portion 258a, a second affiliated-character selection operation portion 258b, a third affiliated-character selection operation portion 258c, a fourth affiliated-character selection operation portion 258d, a fifth affiliated-character selection operation portion 258e, and an all-affiliated-character selection operation portion 259 are displayed on the outing screen 255, as shown in FIG. 26B.

The first affiliated-character selection operation portion 258a, the second affiliated-character selection operation portion 258b, the third affiliated-character selection operation portion 258c, the fourth affiliated-character selection operation portion 258d, the fifth affiliated-character selection operation portion 258e correspond to the first affiliated character, the second affiliated character, the third affiliated character, the fourth affiliated character, and the fifth affiliated character, respectively. On the other hand, the all-affiliated-character selection operation portion 259 corresponds to all of the affiliated characters.

The player can select an affiliated character event that occurs by tapping one of the first affiliated-character selection operation portion 258a to the fifth affiliated-character selection operation portion 258e. In the affiliated character event, the training target character goes out together with the affiliated character. However, each affiliated character can be selected only once during one training game. For example, in the case in which the training target character has already gone out with the second affiliated character and the fourth affiliated character, the second affiliated-character selection operation portion 258b and the fourth affiliated-character selection operation portion 258d are grayed out, as shown in FIG. 26B. The grayed-out operation portions do not accept player operations.

However, the number of times each affiliated character can be selected is not limited to once and may be twice or more. In addition, the number of times each affiliated character can be selected may be different depending on the affiliated characters.

In addition, in this embodiment, a specific condition under which the all-affiliated-character selection operation portion 259 can be selected is provided. In this case, that all of the affiliated character events have occurred, in other words, the training target character has gone out with all of the affiliated characters, is set as the specific condition. As shown in FIG. 26B, in the state in which the specific condition is not met, “?” is displayed in the all-affiliated-character selection operation portion 259. In this state, the all-affiliated-character selection operation portion 259 does not accept player operations.

Also, as shown in FIG. 26C, when the specific condition is met, all of the affiliated characters are displayed in the all-affiliated-character selection operation portion 259. In this state, the operation input to the all-affiliated-character selection operation portion 259 is enabled. Note that the player can repeatedly select the all-affiliated-character selection operation portion 259. Specifically, the player first needs to go out with each of the first to fifth affiliated characters once. Then, when the player has gone out with all of the affiliated characters once each, thereafter, the player can go out with all of the affiliated characters together for any number of times.

The all-affiliated-character selection operation portion 259 shows, by means of rightward arrows, the number of times the all-affiliated-character selection operation portion 259 has been selected, in other words, the number of times the player has gone out with all of the affiliated characters. Note that, as indicated above, in the case in which a configuration in which each affiliated character can be selected twice or more times is employed, it is preferable that the number of times the player has gone with each of the affiliated characters be also indicated in the first affiliated-character selection operation portion 258a to the fifth affiliated-character selection operation portion 258e, as in the all-affiliated-character selection operation portion 259.

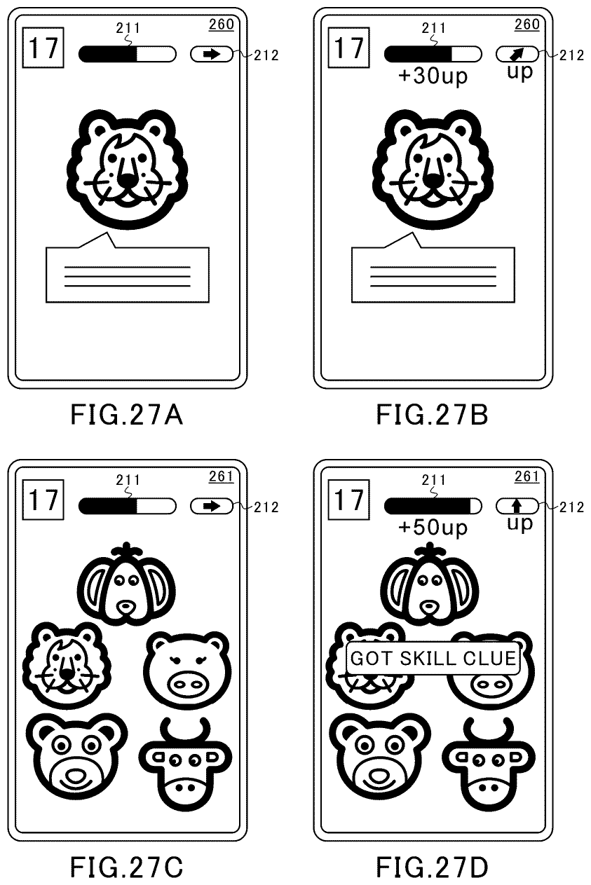

FIG. 27A is a first diagram for explaining an affiliated-character event screen 260. FIG. 27B is a second diagram for explaining the affiliated-character event screen 260. For example, assume that the third affiliated-character selection operation portion 258c is tapped and the third affiliated character is selected. In this case, as shown in FIG. 27A, the third affiliated character that the player has selected is displayed on the affiliated-character event screen 260. In addition, on the affiliated-character event screen 260, as shown in FIG. 27B, the benefits brought about as a result of the occurrence of the affiliated character event (in this case, “+30 up” and “up”) are displayed.

Note that, because a plurality of affiliated characters are provided, as many affiliated-character event screens 260 as the number of the affiliated characters are provided. In other words, the execution pattern of the affiliated character event that occurs is different depending on the affiliated character that the player has selected.

FIG. 27C is a first diagram for explaining an all-affiliated-character event screen 261. FIG. 27D is a second diagram for explaining the all-affiliated-character event screen 261. Assume that the all-affiliated-character selection operation portion 259 is tapped and all of the affiliated characters are selected. In this case, an all-affiliated-character event occurs. When the all-affiliated-character event occurs, as shown in FIG. 27C, the all-affiliated-character event screen 261 is displayed. On the all-affiliated-character event screen 261, all of the affiliated characters associated with the group support card are displayed.

In addition, on the all-affiliated-character event screen 261, as shown in FIG. 27D, the benefits brought about as a result of the occurrence of the all-affiliated-character event (in this case, “+50 up”, “up”, and “skill clue GET”) are displayed. Here, the training target character acquires the skill clue as the benefit due to the all-affiliated-character event; however, the training target character may own or acquire the skill.

Note that, here, all of the affiliated characters are displayed on the all-affiliated-character event screen 261. However, the contents of the all-affiliated-character event screen 261 are not limited in particular. For example, only some of the affiliated characters may be displayed on the all-affiliated-character event screen 261 and, in addition, two or more affiliated characters may be displayed.

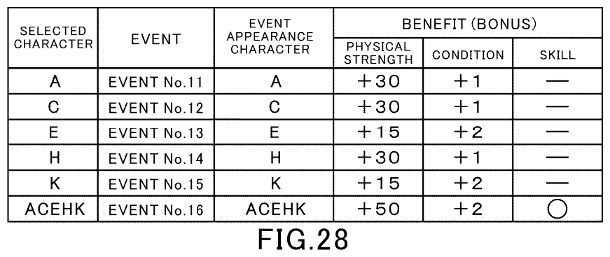

FIG. 28 is a diagram for explaining execution patterns of the affiliated character events and the all-affiliated-character event. As shown in FIG. 28, in an affiliated character event, the affiliated character that the player has selected is displayed on the affiliated-character event screen 260. In addition, in the all-affiliated-character event, all of the affiliated characters are displayed on the all-affiliated-character event screen 261.

In addition, as illustrated, benefits (bonuses) are set for the respective execution patterns of the affiliated character events and the all-affiliated-character event. In this case, different benefits are brought about depending on the execution patterns; however, the same benefits may be brought about by all of the execution patterns. In addition, when the all-affiliated-character event occurs, it becomes possible to own a prescribed skill. In this case, the prescribed owned skill is imparted when the all-affiliated-character event occurs for the first time. Accordingly, the benefits brought about by the all-affiliated-character event are greater than the benefits brought about by the affiliated character events. However, the benefits brought about by the all-affiliated-character events may be the same or smaller than the benefits brought about by the affiliated character event.

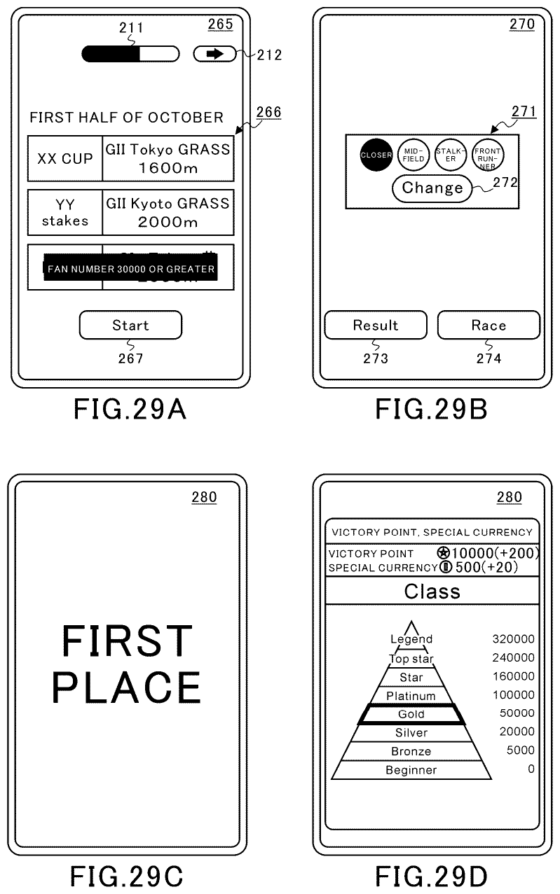

FIG. 29A is a first diagram for explaining an individual-race selection screen 265. When the individual race operation portion 219 on the game screen 210 is operated, the individual-race selection screen 265 shown in FIG. 29A is displayed. The individual race has gaming properties wherein the training target character races against the NPCs.

In a top section of the individual-race selection screen 265, the physical-strength display portion 211 and the condition display portion 212 are displayed. In addition, in a center section of the individual-race selection screen 265, individual-race-selection operation portions 266 for selecting the category of the race the training target character is to be entered are displayed. In the case in which a plurality of individual-race-selection operation portions (subcommands) 266 are displayed on the individual-race selection screen 265, individual races that are different from each other are set in the plurality of individual-race-selection operation portions 266. In addition, in a bottom section of the individual-race selection screen 265, a start operation portion 267 indicated as “Start” is displayed. Note that the races that can be selected via the individual-race-selection operation portions 266 on the individual-race selection screen 265 are set in advance for each turn.

In addition, entry conditions are set for each race, and the player can enter the training target character only in races for which the entry conditions are met. As has been indicated above, there are races in which the number of fans are specified as an entry condition. As shown in FIG. 29A, the entry condition is displayed in the individual-race-selection operation portion 266 for a race for which the specified number of fans is not satisfied, and it is notified that said race cannot be selected. In addition, in the turns in which clear-goal subject races are set, only the subject races are displayed on the individual-race selection screen 265 in a selectable manner.

FIG. 29B is a diagram for explaining an individual-race start screen 270. When the start operation portion 267 is operated in the state in which the race category of the individual race to be entered is selected in the individual-race-selection operation portion 266, the individual-race start screen 270 shown in FIG. 29B is displayed. A strategy display portion 271 is displayed in a center section of the individual-race start screen 270. In addition, in the strategy display portion 271, the currently selected strategy (closer, midfield, stalker, or front runner) is displayed in an emphasized manner and a change operation portion 272 indicated as “Change” is displayed. When the change operation portion 272 is operated, a strategy change screen (not shown) is displayed on the display 26. The player can change the strategy in the individual race to an arbitrary strategy via operations on the strategy change screen.

In addition, in a bottom section of the individual-race start screen 270, a result operation portion 273 indicated as “Result” and a race operation portion 274 indicated as “Race” are displayed.

In the case in which the race operation portion 274 is operated, a race screen (not shown) is displayed on the display 26. On the display 26, a race development movie (hereinafter, also referred to as the race movie) is displayed.

FIG. 29C is a first diagram for explaining an individual-race result screen 280. FIG. 29D is a second diagram for explaining the individual-race result screen 280. In the case in which the playback of the above-described race movie is ended and in the case in which the result operation portion 273 is operated, the individual-race result screen 280 is displayed on the display 26. On the individual-race result screen 280, as shown in FIG. 29C, the arrival order of the training target character in said individual race is displayed. In addition, on the individual-race result screen 280, as shown in FIG. 29D, the current class of the training target character is displayed.

In this embodiment, the class placement of the training target character is determined in accordance with the acquired number of fans. The ranges of the number of fans are set for the respective classes, and, in this case, the training target character is classified into one of eight-step classes depending on the number of fans. On the individual-race result screen 280, the number of fans, the victory points, and the special currency that are acquired in the current round of the individual race are displayed. In addition, on the individual-race result screen 280, an accumulated number of fans in which the number of newly acquired fans is added to the number of previously acquired fans is displayed. In addition, the current class corresponding to the accumulated number of fans is displayed in a distinguished manner. In addition, on the individual-race result screen 280, accumulated victory points in which the newly acquired victory points are added to the previously acquired victory points and the accumulated amount of the special currency in which the amount of the newly acquired special currency is added to the amount of the previously acquired special currency are displayed.

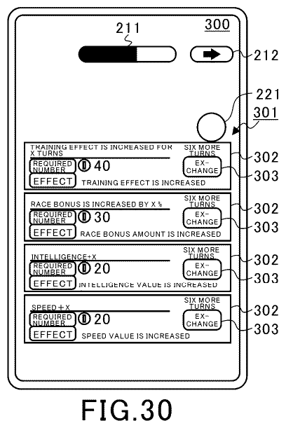

FIG. 30 is a diagram for explaining an example of an item exchange screen 300. For example, when the shop operation portion 220 on the game screen 210 shown in FIG. 20A is tapped, the item exchange screen 300 shown in FIG. 30 is displayed. On the item exchange screen 300, the player can use the special currency that the player has acquired to exchange the special currency with a prescribed item displayed on the item exchange screen 300. Note that, on the game screen 210 shown in FIG. 20A, the total amount of the special currency that the player possesses may be displayed in a bottom section of the shop operation portion 220 in a superimposed manner.

As shown in FIG. 30, on the item exchange screen 300, the item operation portion 221 and an item exchange list 301 are displayed. In the item exchange list 301, one or a plurality of item exchange tabs 302 are displayed.

In an item exchange tab 302, the name of the item (item name) that the player can exchange, the effect of the item, the amount of the special currency required for the exchange, the indication of the exchange deadline, and an item-exchange operation portion 303 are displayed. The exchange deadline is indicated in each item exchange tab 302 and indicates, for example, the number of turns remaining from the current turn during which the player can obtain the item through the exchange. On the item exchange screen 300, the items are replaced every certain period (prescribed number of turns). The exchange deadline is the number of turns remaining until the item replacement is performed. In addition, in the item exchange, a lottery may be performed every turn during the training game and a sale may occur at a certain probability. The period during which a sale occurs is, for example, a period from the turn in which the sale has occurred to the turn in which the next item replacement is performed. During the sale period, the amount of the special currency required for the item exchange is smaller than during the period other than the sale.

The items the player can acquire through the exchange include, for example, parameter change items, status imparting items, training-level change items, skill clue acquisition items, character redeployment items, training-effect change items, physical-strength use items, failure-rate change items, event parameter change items, etc.

The parameter change items change the parameters of the training target character. For example, the parameter change items increase, by a prescribed amount, the value of a target parameter among the speed, the stamina, the power, the guts, the intelligence, the physical strength, the physical-strength upper limit value, the condition, the skill point, and the number of fans of the training target character.

The status imparting items impart statuses to the training target character. For example, the status imparting items impart advantageous statuses or disadvantageous statuses to the training target character. The advantageous statuses include, for example, statuses that increase the amounts by which the various kinds of the parameters of the training target character are increased and statuses that decrease the amounts of skill points to be used for the skill acquisition. In addition, the disadvantageous statuses include, for example, statuses in which events, such as decreasing the various kinds of the parameters of the training target character, occur and statuses that prevent the various kinds of the parameters from being increased.

The training-level change items change the training levels of the respective training items. For example, the training-level change items increase, by a prescribed amount, the training level of a target training item among the speed, the stamina, the power, the guts, and the intelligence.

The skill clue acquisition items allow the training target character to own or acquire skills by causing skill events to occur. For example, the skill clue acquisition item can allow the training target character to own or acquire various skills shown in FIG. 6C.

The character redeployment items redeploy the characters deployed in the prescribed training, as shown in FIGS. 21A and 21B, in another training. The character redeployment will be described later.

The training-effect change items change the training effects due to the training during a certain period. Specifically, the training-effect change items increase, by prescribed amounts during a certain period, fixed increase amounts (described later) of the ability parameters of the training target character due to the training. For example, the training-effect change items increase the fixed increase amount of the ability parameter with respect to a target training among the respective training items (the speed, the power, the guts, the stamina, and the intelligence) by X % for X turns.

The physical-strength use items increase the training effects by increasing the amount of the physical-strength used in the training. Specifically, the physical-strength use items increase, by a prescribed amount, the fixed increase amount (described later) with respect to the increase in the ability parameters of the training target character due to the training. The physical-strength use items can increase the training enhancement effect by being used in combination with the training-effect change items.

The failure-rate change items change the failure rates of the target training items. For example, the failure-rate change items decrease, by a prescribed amount, the failure rate of a target training among the respective training items (the speed, the power, the guts, the stamina, and the intelligence).

The event parameter change items change the parameter change values of the training target character to be imparted when events have occurred after races. For example, the event parameter change items increase, by a prescribed amount, the amount by which a target parameter among the speed, the stamina, the power, the guts, the intelligence, the physical strength, the physical-strength upper limit value, the condition, the skill points, and the number of fans of the training target character is changed.

The item exchange list 301 shown in FIG. 30 displays examples of the training-effect change item, the event parameter change item, and the parameter change items. When the item-exchange operation portion 303 of each item exchange tab 302 is tapped, the required amount of the special currency indicated in the item exchange tab 302 is subtracted from the accumulated amount of the special currency that the player has acquired. In addition, at the same time, the item indicated in the item exchange tab 302 is imparted to the player.

Note that the items that can be exchanged by using the item exchange tabs 302 include items in which the number of times the items can be exchanged (in other words, the number of times the items can be purchased) is limited to be equal to or less than a prescribed number of times. In the case in which the number of times the finite item can be imparted has reached the upper limit, the player can no longer perform the exchange for the finite items even if the player possesses the special currency.

In addition, when the item operation portion 221 is tapped, an item use screen (not shown) is displayed on the display 26. On the item use screen, a list of items that the player owns is displayed. The item list includes the items that have been obtained through the exchanges by using the item exchange screen 300. In other words, on the item use screen, the items that have been exchanged with the special currency and imparted to the player are displayed. Note that, on the item use screen, items acquired in various kinds of events may be displayed. The player can use various kinds of items by performing tap operations on the items displayed on the item use screen.

In this embodiment, by operating the item operation portion 221, the player can use various items that have been exchanged with the special currency. When each of the items is used, for example, on the training screen 240 shown in FIG. 21A, an icon representing the effect currently exhibited due to the use of an item may be displayed. At this time, in a bottom section of the icon, the number of effect exhibited turns in which the effect is exhibited due to the use of the item may be displayed together. Note that, as shown in FIG. 30, exchangeable periods are set for the respective items. The player can exchange the special currency with the respective items during the exchangeable periods set for the respective items. Note that the respective items may not be provided with the exchangeable periods.

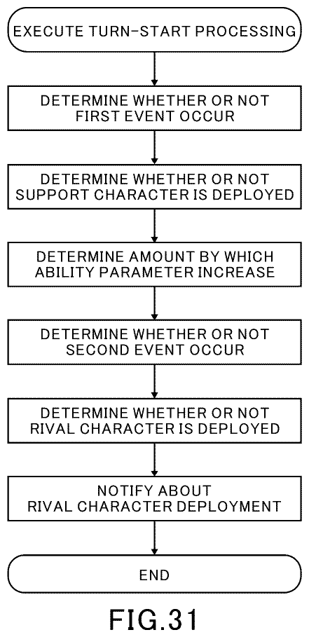

FIG. 31 is a diagram for explaining a rough flow of turn-start processing. The training stage processing includes the turn-start processing executed at the start of each turn of the training game. Although the details of the turn-start processing will be described later, here, the rough flow of the turn-start processing will be described.

During the training main game, processing for determining whether or not various kinds of events occur is performed in each turn. The events are roughly classified into three categories, namely, scenario events, the above-described character-owned events provided for each training target character, and support events. Note that, in each scenario, the scenario events, the character-owned events, and the support events that could occur during the training main game are set in advance.

A scenario event refers to an event set for each scenario of the training main game. In this embodiment, a plurality of scenarios are provided, and the player can select a scenario. The scenario events occur in accordance with the scenario that the player has selected. In other words, the scenario events that occur in the training main game are determined on the basis of the scenario that the player has selected.

Note that the scenario events may include a unique scenario event and a common scenario event. The unique scenario event refers to an event associated with only one scenario. For example, a unique scenario event associated with a first scenario occurs only when the first scenario is selected and does not occur when other scenarios are selected.

In addition, the common scenario event refers to an event that occurs in common among the plurality of scenarios. Therefore, a common scenario event occurs in the case in which the first scenario is selected as well as in the case in which a second scenario is selected

Here, it is assumed that scenario events include the unique scenario events and the common scenario events. However, only the unique scenario events or the common scenario events may be provided.

As has been described above, the character-owned events are set in advance for each of the characters. In the training main game, the character-owned events of the character that the player has registered as the training target character in the setting game, in other words, the preparation stage processing, occur.

As has been described above, the support events are set in advance for each of the support cards. In the training main game, the support events associated with the support cards the player has registered in the setting game occur. The support events include a first event that could occur at the start of a turn and a second event that could occur after the training is executed. Whether or not the first event occurs is determined on the basis of a randomly acquired number and a first event table at the start of a turn.

Whether or not the second event occurs is determined on the basis of a randomly acquired number and a second event table after determination processing of each support character deployed in the training is performed. Note that whether or not the second event occurs is determined for the deployed support characters only in the case in which the support characters are deployed in the training.

Note that, in this embodiment, it is assumed that the first event is selected, by mean of a lottery, from among the support events associated with the support cards that the player has registered in the deck in the preparation stage processing. However, it is not limited thereto, and it may be possible to select the support events associated with the support cards selected, by means of a lottery, from among all of the support cards implemented in the game. In this case, it is preferable that the selection probabilities of the support events associated with the support cards registered in the deck be higher than the selection probabilities of the support events associated with the support cards that are not registered in the deck.

Accordingly, whether or not the scenario events occur, etc. are determined on the basis of the scenarios. In addition, whether or not the character-owned events and the support events occur, etc. are respectively determined on the basis of the training target character and the support cards. These event categories are classified depending on the information referred to when determining whether or not the events occur, etc.

Regarding this feature, in this embodiment, the respective events are classified into six event classifications depending on the contents brought about by the occurrence of the events. Here, the respective events are classified into any one of event classifications among the first clue events, the second clue events, first ability events, second ability events, aptitude events, and story events.

As has been described above, the first clue events and the second clue events make it possible to own or acquire skills. In addition, the first ability events and the second ability events increase or decrease the ability parameters of the training target character. The aptitude events increase or decrease the aptitude parameters of the training target character. The story events display stories related to the characters that appear in the training game. Note that the story events include those that change the ability parameters and the aptitude parameters in addition to displaying the stories. The above-described outing events (the solo outing events, the friend outing events, the affiliated character events, and the all-affiliated-character events) correspond to the story events.

In this embodiment, the turn-start processing includes, in addition to the processing for determining the scenario events and the processing for determining the character-owned events, “first-event occurrence determination processing”, “support-character deployment determination processing”, “ability-parameter increase-amount determination processing”, “second-event occurrence determination processing”, “rival-character deployment determination processing”, and “rival-character-deployment notification processing” shown in FIG. 31. Note that, although additionally various other processing is executed in the turn-start processing, here, the processing shown in FIG. 31 will be described in order.

### <First-Event Occurrence Determination Processing>

The first events are selected by means of a lottery from among the support events (first events) associated with the support cards that the player has registered in the preparation stage processing. Specifically, at the start of a turn, a random number is acquired and whether or not a first event occurs and the contents of the first event are determined on the basis of the acquired random number and the first event table.

### <Support-Character Deployment Determination Processing>

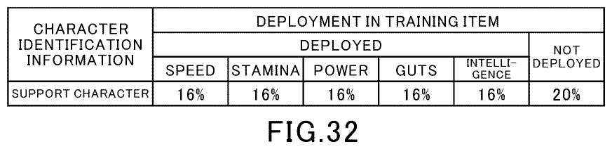

FIG. 32 is a diagram for explaining a deployment table. As shown in FIG. 32, on the deployment table, selection ratios of whether or not a support character is deployed in a training item (“deployed in one of the training items” or “not deployed”) are set. In this embodiment, the deployment is determined, on the basis of the deployment table shown in FIG. 32, for all of the support cards (support characters) that the player has registered in the preparation stage processing.

Specifically, as shown in FIG. 32, in this embodiment, a support character is “deployed” in one of the training items of the speed, the stamina, the power, the guts, and the intelligence at the probability of 16% and is “not deployed” in any of the training items at the probability of 20%. Note that, as indicated above, regarding the support card set for the proficient training, a correction is performed so that the proficient training is selected at a higher probability than other training items.

Note that, when the training items in which the support characters are deployed are determined, the support characters determined to be deployed and the determined training items may be associated with each other and may be stored in the server 1000. More specifically, association information in which the character ID of the support character or the support card ID of the support card associated with the support character is associated with a training ID representing the category of the training item may be stored in the server 1000.

### <Ability-Parameter Increase-Amount Determination Processing>

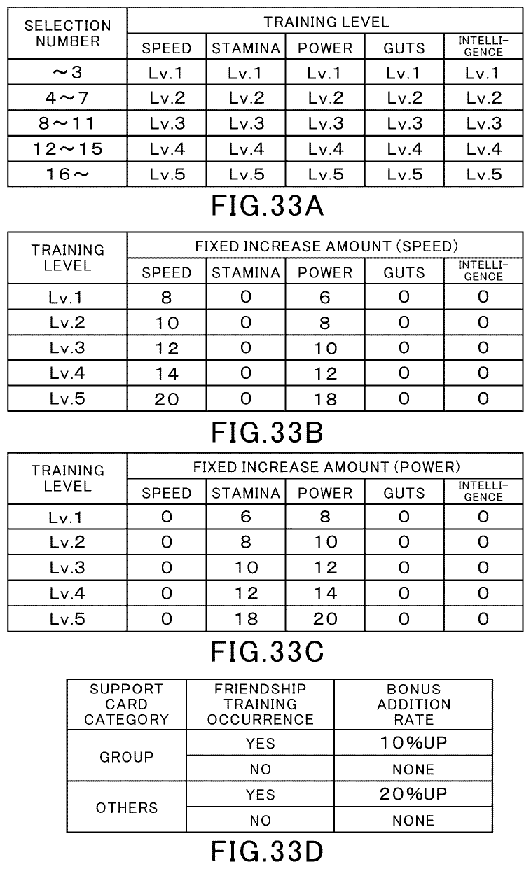

FIG. 33A is a diagram for explaining a training level table. As shown in FIG. 33A, the training level is set so as to increase in accordance with the number of times each training has been selected. Specifically, in the case in which the number of times each training has been selected is equal to or less than 3, the respective training levels related to the “Speed” (speed), the “Stamina” (stamina), the “Power” (power), the “Spirit” (guts), and the “Wisdom” (intelligence) are set to be “level 1”; in the case in which the number of times each training has been selected is 4 to 7, the respective training levels are set to be “level 2”; in the case in which the number of times each training has been selected is 8 to 11, the respective training levels are set to be “level 3”; in the case in which the number of times each training has been selected is 12 to 15, the respective training levels are set to be “level 4”; and, in the case in which the number of times each training has been selected is equal to or greater than 16, the respective training levels are set to be “level 5”.

In this embodiment, in the case in which the training that the player has selected is executed and succeeds, the values of the prescribed ability parameters are increased depending on the executed training items.

Specifically, in this embodiment, in the case in which the “Speed” (speed) training is executed and succeeds, the values of the “Speed” (speed) and “Power” (power) ability parameters are increased.

In addition, in the case in which the “Stamina” (stamina) training is executed and succeeds, the values of the “Stamina” (stamina) and “Spirit” (guts) ability parameters are increased.

In addition, in the case in which the “Power” (power) training is executed and succeeds, the values of the “Stamina” (stamina) and “Power” (power) ability parameters are increased.

In addition, in the case in which the “Spirit” (guts) training is executed and succeeds, the values of the “Speed” (speed), “Power” (power), and “Spirit” (guts) ability parameters are increased.

In addition, in the case in which the “Wisdom” (intelligence) training is executed and succeeds, the values of the “Speed” (speed) and “Wisdom” (intelligence) ability parameters are increased.

In this embodiment, the amounts by which the ability parameters are increased in the case in which the training succeeds are calculated by multiplying a fixed increase amount determined in correspondence to the executed training item and the training level thereof by a bonus addition rate, described later, and by adding the obtained value to the fixed increase amount.

FIG. 33B is a diagram for explaining a fixed increase amount table (speed). In addition, FIG. 33C is a diagram for explaining a fixed increase amount table (power). Specifically, FIG. 33B shows fixed increase amounts for the case in which the training item is “Speed” (speed). In addition, FIG. 33C shows the fixed increase amounts for the case in which the training item is “Power” (power).

As shown in FIGS. 33B and 33C, the fixed increase amount tables store the fixed increase amounts determined in correspondence with the executed training items and the training levels thereof. In addition, in this embodiment, as shown in FIGS. 33B and 33C, the fixed increase amounts are set so that the ability parameters are increased with a greater amounts as the training levels increase.

Note that, although the descriptions thereof will be omitted here, the fixed increase amount tables are respectively provided for the cases in which the “Stamina” (stamina), the “Spirit” (guts), and the “Wisdom” (intelligence) are selected as the training items.

In addition, in addition to the above-described fixed increase amount, the bonus addition rates are determined on the basis of the support cards (support characters) deployed in the respective training items. The bonus addition rates are set in the case in which the above-described friendship trainings occur.

FIG. 33D is a diagram for explaining a bonus addition rate. In this embodiment, for the respective support cards (support characters) determined to be deployed in the respective trainings, it is determined whether or not the friendship-training occurrence conditions are met. Also, the bonus addition rates are determined for the support cards for which it is determined that the friendship-training occurrence conditions are met.

Specifically, regarding the group support cards, the bonus addition rate is determined to be 10% as a result of the occurrence of the friendship trainings. In addition, regarding the support cards other than the group support cards, the bonus addition rate is determined to be 20%. Note that the bonus addition rates may change on the basis of the categories of the support cards and the bond gauge values thereof. For example, it is preferable that the bonus addition rates increase as the bond gauge values increase.

Also, the values obtained by multiplying the fixed increase amounts determined by using the fixed increase amount tables by the bonus addition rates are derived so as to serve as the bonus addition amounts. The values obtained by adding the bonus addition amounts to the fixed increase amounts are determined to be the amounts by which the values of the ability parameters increase in the case in which the training succeeds. Note that, regarding the training in which a plurality of support characters are deployed, the bonus addition amount of each of the deployed plurality of support characters is added to the fixed increase amounts.

Accordingly, the amounts by which the ability parameters of the training target character increase in the case in which the training succeeds are determined for all of the training items.

### <Second-Event Occurrence Determination Processing>

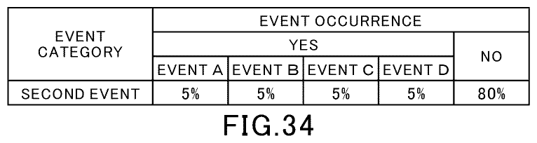

FIG. 34 is a diagram for explaining a second event table. The second events are selected by means of a lottery from among the support events (second events) associated with the support cards corresponding to the support characters deployed in the respective training items. Specifically, after the “support-character deployment determination processing”, a random number is acquired and whether or not a second event occurs is determined on the basis of the acquired random number and the second event table. On the second event table, selection ratios at which the second event “occurs” and “does not occur” are set.

For example, as shown in FIG. 34, the second events associated with the prescribed support cards include events in four categories of event A, event B, event C, and event D. For example, on the second event table, the probability at which each of the events (events A-D) “occurs” is set to be 5% and the probability at which a second event “does not occur” is set to be 80%. Note that the second-event selection ratio may separately be set for each support card, in other words, each support character.

In this embodiment, after the “support-character deployment determination processing”, the second-event occurrence determination processing is performed for all of the support characters deployed in the respective training items. Also, the event notification display 247 is displayed on the training screen 240 on the basis of the second-event occurrence determination.

In the case in which the player selects the training in which a support character, for which the second event has been determined to occur, is deployed, the second event occurs after the training execution. For example, in the case in which the second clue event has been determined to occur with respect to the support character deployed in the speed training, the second clue event always occurs after the training execution when the speed training is executed.

However, when a training other than that for the speed is executed, said second clue event does not occur after the training execution. In addition, in the case in which second events have been determined to occur with respect to two or more support characters deployed in the same training, which one of the second events occurs is determined by means of a lottery or on the basis of the degrees of priority or the like set in advance for the support events. In other words, a plurality of second events do not occur in a single turn.

For example, which one of the plurality of second events occurs is determined at an equal probability. However, it is not limited thereto, and weights may be set in accordance with the categories of the second events and which one of the plurality of second events occurs may be determined in accordance with the set weights. Note that, in the case in which the second events have been determined to occur for two or more characters, all of the determined second events may occur.

Here, for example, when the occurrences of second events are determined, occurrence information indicating whether or not the support events occur may be associated with the support cards or the support characters associated with the second events and may be stored in the server 1000. More specifically, association information in which the occurrence information is associated with the character IDs of the support characters or the support card IDs of the support cards associated with the support characters may be stored in the server 1000.

When the above-described “first-event occurrence determination processing”, the “support-character deployment determination processing”, the “ability-parameter increase-amount determination processing”, and the “second-event occurrence determination processing” are executed and the training operation portion 216 is operated, for example, the training screen 240 shown in FIG. 21B is displayed on the display 26.

As described above, on the training screen 240 shown in FIG. 21B, as a result of the “support-character deployment determination processing”, two types of the deployed character icons 248 deployed in the stamina training item are displayed.

In addition, on the training screen 240, the amounts by which the ability parameters are increased, determined by the “ability-parameter increase-amount determination processing”, are displayed in the status display portion 213. In addition, on the training screen 240, the event notification display 247 for notifying about the second event determined by the “second-event occurrence determination processing” is displayed.

As has been described above, the respective support cards are provided with at least the first events and the second events as the support events. However, depending on the support card categories, other events may be provided in addition to the first events and the second events. In this embodiment, the following events are associated with the group support cards.

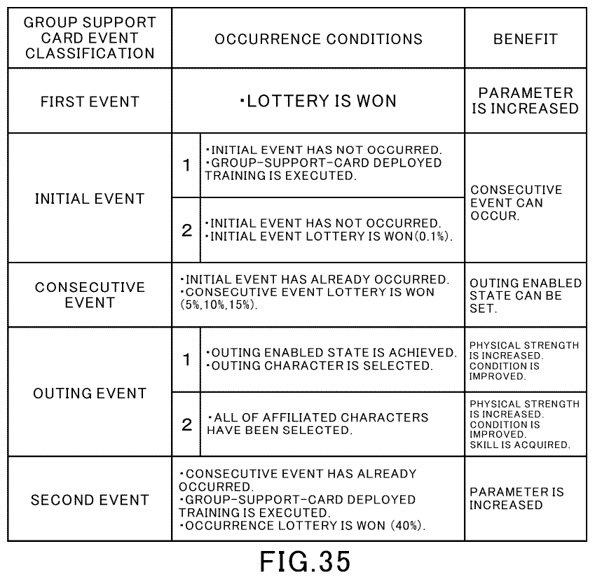

FIG. 35 is a diagram for explaining the events associated with the group support cards. The events associated with the group support cards are classified into first events, initial events, consecutive events, outing events, and second events. Note that occurrence conditions and benefits of the respective events shown in FIG. 35 are merely examples thereof.

The first events of group support cards occur as a result of winning a lottery at the start of a turn, as with those of other support cards. In the case in which said first events have occurred, various kinds of parameters, such as the ability parameters, are increased. Note that, although a detailed description will be omitted, the first events of the group support cards are roughly classified into repeated events and single-occurrence events. The repeated events can occur multiple times in one round of the training game. The single-occurrence event can occur only once in one round of the training game.

The initial events of the group support cards make it possible for consecutive events, described later, to occur. The initial events are provided with two occurrence conditions, namely, first occurrence conditions and second occurrence conditions. The first occurrence conditions are that an initial event has not occurred and that a group-support-card deployed training is executed. The second occurrence conditions are that the initial event has not occurred and that an initial event lottery is won.

Specifically, the initial event occurs in the case in which a group-support-card deployed joint training is executed or an initial event lottery is won in the state in which the initial event has not occurred in the training main game. Therefore, the initial event occurs only once in one round of the training game. Note that, according to the first occurrence conditions, in the case in which the joint training is executed first, the initial event always occurs. In addition, the initial event lottery is executed every turn in the state in which the initial event has not occurred. In addition, the initial event lottery is also executed in the case in which the group support card is not included in the deck.

Note that the initial event lottery may be executed only in the case in which the group support card is included in the deck. In addition, the group support card may be deployed in one of the training items as a result of winning a prescribed lottery, even in the case in which the group support card is not included in the deck.

The consecutive events of the group support cards make it possible to set an outing enabled state in which it is possible to go out with the affiliated characters associated with the group support cards. The occurrence conditions of the consecutive events are that the initial event has already occurred and that a consecutive event lottery is won. Note that, here, the winning probabilities of the consecutive event lottery are different depending on the bond gauge values of the group support cards. For example, the winning probabilities of the consecutive event lottery is 5% when the bond gauge value is less than 40, 10% when the bond gauge value is equal to or greater than 40 and less than 80, and 15% when the bond gauge value is equal to or greater than 80.

Note that, although a detailed description will be omitted, the consecutive events are story events and the contents thereof are such that the player is prompted to select one of a plurality of options during a story. At this time, when a prescribed option is selected, thereafter, the training main game is set in the outing enabled state until the training main game being played ends.

However, the contents of the consecutive events are not limited to those described above. For example, in the case in which the consecutive events have occurred, the game may always be set in the outing enabled state. In addition, the consecutive events may repeatedly occur or occur only once. In the case in which a consecutive event could occur only once, unless the player selects the prescribed option when the consecutive event occurs, thereafter, the game will not be set in the outing enabled state.

The outing events of the group support cards are above-described affiliated character events and all-affiliated-character events. The occurrence condition of the affiliated character events is that, in the outing enabled state, one of the first affiliated-character selection operation portion 258a to the fifth affiliated-character selection operation portion 258e is selected on the outing screen 255. In other words, the affiliated character events occur in the case in which, after the training main game is set in the outing enabled state, one of the affiliated characters is selected. As a result of the occurrences of the affiliated character events, the physical strength and the condition of the training target character increase.

In addition, in the all-affiliated-character events, that all of the affiliated characters have been selected, in other words, the training target character has gone out with all of the affiliated characters, is set as the occurrence condition. As a result of the occurrences of the all-affiliated-character events, the physical strength and the condition of the training target character increase. In addition, in the case in which an all-affiliated-character event has occurred for the first time, the training target character owns the owned skills.

As has been described above, in order for the outing events of the group support cards to occur, it is necessary for an initial event and a consecutive event to occur in a sequential manner. Then, the outing enabled state is set in association with the occurrence of the consecutive event, and thus, it becomes possible to go out with the affiliated characters thereafter.

Note that, here, it is assumed that, in order for the outing events to occur, it is necessary for the initial events and the consecutive events to occur and, in addition, it is necessary to achieve the outing enabled state. However, for example, in the case in which the group support cards are included in the deck, the outing events associated with the group support cards may be allowed to occur from the very start of the training main game or from a prescribed turn number.

The occurrence conditions of the second events of the group support cards are different from those of the other support cards. Specifically, that the consecutive events have already been occurred, that the group-support-card deployed training has been executed, and that an occurrence lottery is won are set as the second-event occurrence conditions. Note that, instead of or in addition to that the consecutive events have already been occurred, that the outing enabled state has been achieved may be provided as an occurrence condition. As a result of the occurrences of the second events, various kinds of parameters, such as the ability parameters, etc. increase. In addition, the second events are also roughly classified into the repeated events and the single-occurrence events as with the first events.

As has been described above, the initial events, the consecutive events, and the outing events provided as the support events of the group support cards are different from those of the other support cards. Also, the outing events include the affiliated character events provided for the respective affiliated characters, and the player can select one of the affiliated character events. Accordingly, the player can display a preferred affiliated character in the affiliated character event. In particular, a plurality of affiliated characters are associated with a group support card. Because of this, while the number of support cards that can be included in the deck is limited, a greater number of characters can be displayed. Accordingly, the game development is diversified and the game play motivation is enhanced.

In addition, when the player has gone out with all of the affiliated characters, it becomes possible for the all-affiliated-character events to occur. Accordingly, the player is motivated to experience all of the affiliated character events, and the game interest is further enhanced.

Furthermore, in this embodiment, a bonus zone (bonus state) could be set on the basis of the group support cards. In the bonus zone, the player can advance the training game in an advantageous manner. In the following, the bonus zone will be described.

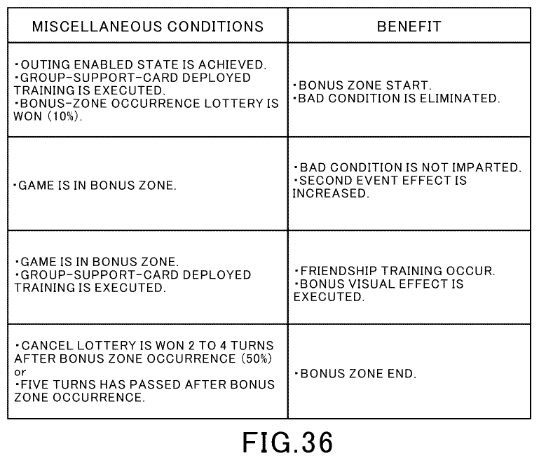

FIG. 36 is a diagram for explaining a bonus zone. In the case in which the game is set in the outing enabled state, a bonus-zone occurrence lottery is performed when a group-support-card deployed training is executed. Winning the bonus-zone occurrence lottery starts the bonus zone. However, in the bonus zone, the bonus-zone occurrence lottery is not performed. Therefore, not being in the bonus zone is also considered to be a bonus-zone occurrence condition.

Here, in the case in which a group-support-card deployed joint training is executed after the game is set in the outing enabled state, the bonus zone starts at a probability of 1/10. The bonus zone starts in the turn following the turn in which the joint training associated with the group support card is executed. When the bonus zone starts, as a benefit, bad conditions of the training target character are eliminated. Although a detailed description will be omitted, a bad condition refers to a state that is set for the training target character and that makes the proceeding of the training main game disadvantageous.

Note that the bonus zone is basically set on the premise that the group support card is included in the deck. However, as indicated above, even in the case in which the group support card is not included in the deck, an initial event occurs when the initial event lottery is won, and, thereafter, it becomes possible for a consecutive event to occur and it becomes possible for the outing enabled state to be set. Accordingly, in the case in which the outing enabled state is achieved and a group support card that is not included in the deck is deployed, the bonus zone could possibly occur. In addition, here, the winning probability of the bonus-zone occurrence lottery is assumed to be 10%; however, the winning probability can be set, as appropriate.

Also, the bonus zone brings about benefits such as that bad conditions are not imparted to the training target character and the effect of the second events that increases the ability parameters, etc. is further enhanced. In addition, in the bonus zone, when a group-support-card deployed training is executed, the friendship training based on the group support card occurs and the effect of increasing the ability parameters, etc. is further enhanced. In addition, at this time, a bonus visual effect that appears only in the bonus zone is executed. In other words, the appearance of the bonus visual effect notifies the friendship training occurrence and the training effect enhancement.

Ending conditions are set for the bonus zone, and the setting of the bonus zone is canceled as a result of the ending conditions being met. Here, that a cancel lottery is won and that 5 turns have passed after the bonus zone occurrence are set as the ending conditions. The cancel lottery is executed 2 to 4 turns after the bonus zone occurrence. Therefore, the bonus zone continues for 5 turns at the longest and ends in 1 turn at the shortest.

Note that, here, the winning probability of the cancel lottery is 50%; however, the winning probability can be set, as appropriate. In addition, the cancel lottery is not essential. For example, only the number of turns until the end of the bonus zone may be set as the bonus-zone ending condition.

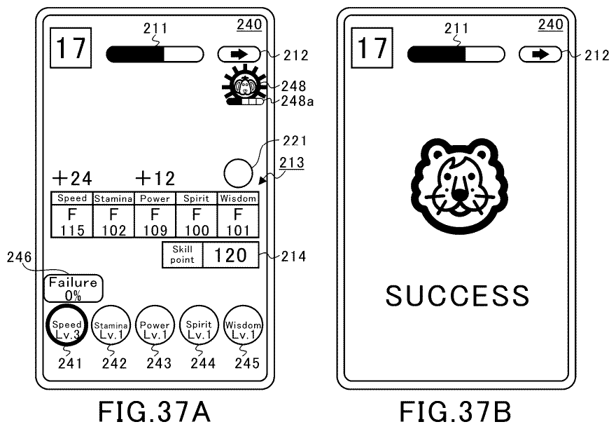

FIG. 37A is a diagram for explaining the deployed character icon 248 of the group support card. FIG. 37B is a diagram for explaining the bonus visual effect. As indicated above, the plurality of affiliated characters are associated with the group support cards; however, only one type of deployed character icon 248 corresponds to each of the group support cards. Here, the first affiliated character is displayed in the deployed character icon 248 corresponding to the group support card.

Also, in the bonus zone, when the group support card is deployed in the training, it becomes possible for the friendship training based on the group support card to occur as a result of selecting and executing the training in which said group support card is deployed. At this time, the friendship training can occur in any one of the training items. In the state in which the friendship training can occur, as shown in FIG. 37A, the deployed character icon 248 is displayed in an emphasized manner with an effect. FIG. 37A shows a case in which the group support card is deployed in the speed training. At this time, the amounts by which the ability parameters increase in the case in which the speed training succeeds are displayed near the status display portion 213. Here, the increase amount in which a bonus addition amount due to the occurrence of the friendship training is taken into consideration is displayed.

Also, when the speed training is selected in the state shown in FIG. 37A, the friendship training based on the group support card occurs. At this time, if the training succeeds, the bonus visual effect is executed. In the bonus visual effect, as shown in FIG. 37B, the affiliated character is displayed and the success of the training is notified.

Here, a plurality of bonus-visual-effect execution patterns are provided. In this embodiment, the bonus-visual-effect execution patterns are provided for the respective affiliated characters. Because five affiliated characters are associated with one group support card, five bonus-visual-effect execution patterns are provided. In each execution pattern, one affiliated character is always displayed, and, in addition, the voice of the displayed affiliated character is output.

In the case in which the friendship training based on the group support card occurs, the bonus-visual-effect execution pattern is determined by means of a lottery. Specifically, in the case in which the friendship training (bonus event) occurs, one of the plurality of affiliated characters associated with the group support card (prescribed game medium) is determined to be the character to be displayed in the bonus visual effect. Accordingly, the determined affiliated character is displayed in the bonus visual effect.

However, the bonus-visual-effect execution pattern may be selected, for example, in an order set in advance instead of a lottery. In addition, here, it is assumed that the bonus-visual-effect execution patterns are provided for the respective affiliated characters; however, the bonus-visual-effect execution patterns corresponding only to some of the affiliated characters may be provided. Alternatively, bonus-visual-effect execution patterns in which the plurality of affiliated characters are displayed may be provided.

As has been described above, in a bonus visual effect, one of the plurality of affiliated characters is displayed. Accordingly, even while the number of the support cards that can be included in the deck is limited, the game development is diversified and the game interest is enhanced. In addition, in the case in which the game is in the bonus zone, a visual effect that is different from the visual effect in the case in which the game is not in the bonus zone can be executed as the bonus visual effect, and a bonus is imparted, such as increasing the parameter increase amounts. Accordingly, the game interest is further enhanced.

### <Rival-Character Deployment Determination Processing>

In the turn-start processing, whether or not the rival character is deployed is determined. A rival character is an NPC that appears in an individual race and competes against the training target character in said individual race. The rival character has the same character ID as an NPC that appears in a normal individual race in which the rival character does not appear (hereinafter referred to as the normal NPC).

However, the rival character has higher parameters than the normal NPC. For example, a rival character has ability parameters in which the ability parameters of a normal NPC having the same character ID are multiplied by a prescribed factor (for example, 1.1). Accordingly, an individual race in which a rival character has appeared has gaming properties of basically the rival character and the training target character competing for ranking (first place).

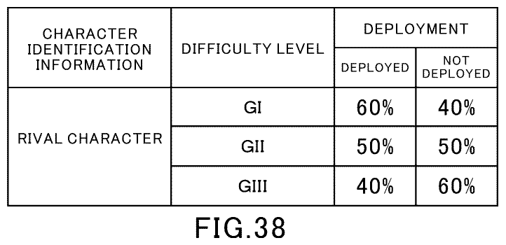

FIG. 38 is a diagram for explaining a deployment table. As shown in FIG. 38, in the deployment table, selection ratios for whether or not a rival character is deployed (“deployed” or “not deployed”) are set. In this embodiment, whether or not a rival character is deployed is determined on the basis of the deployment table shown in FIG. 38.

In this embodiment, the rival character deployment is executed in the case in which the individual races that appear in the current turn include a race in which the aptitude parameters related to the ground aptitude and the distance aptitude of the current training target character are equal to or greater than a prescribed value (for example, equal to or higher than C). Accordingly, in the “rival-character deployment determination processing”, first, whether or not the individual races (race categories) that appear in the current turn include a race in which the aptitude parameters related to the ground aptitude and the distance aptitude of the current training target character are equal to or greater than a prescribed value (hereinafter referred to as the compatible race) is determined.

As shown in FIG. 38, in this embodiment, the rival-character selection ratios change in accordance with the difficulty level of the compatible race. Specifically, as shown in FIG. 38, in the case in which the difficulty level (grade) of the compatible race is GI, the rival character is “deployed” at a probability of 60% and is “not deployed” at a probability of 40%.

In addition, in the case in which the difficulty level of the compatible race is GII, the rival character is “deployed” at a probability of 50% and is “not deployed” at a probability 50%. In addition, in the case in which the difficulty level of the compatible race is GIII, the rival character is “deployed” at a probability of 40% and is “not deployed” at a probability of 60%. However, the rival-character selection ratios may not change in accordance with the difficulty level of the compatible race. For example, the rival-character selection ratios may be uniform regardless of the difficulty level of the compatible race.

When it is determined that the rival character is deployed, the category (character ID) of the rival character to be deployed is randomly selected by means of a lottery. At this time, from among the characters having the aptitude parameters related to the ground aptitude and the distance aptitude that are equal to or higher than the prescribed value (for example, equal to or higher than C) with respect to the ground, such as grass or dirt, and the distance, such as short distance, mile, middle distance, or long distance, that are set for the compatible race, one character is randomly selected by means of a lottery so as to serve as the rival character. However, in the case in which there are a plurality of compatible races in one turn, the rival characters are randomly selected by means of lotteries so that the same rival character (character ID) is not selected among the plurality of compatible races. In addition, the random selection of the rival character by means of a lottery is performed by excluding the training target character serving as the training target.

Here, the rival character parameters may change in accordance with the difficulty level of the compatible race. For example, the rival character may have higher parameters as the difficulty level of the compatible race increases. In addition, the rival character parameters may take certain values regardless of the difficulty level of the compatible race.

The rival character parameters are set so as to increase as the training game turns progress. Specifically, the rival character parameters may be set so as to increase in the order of the early turn section, the mid turn section, and the late turn section. More specifically, in the case of the early turn section, the rival character ability parameters are 1.1 times the ability parameters of the normal NPC of the same character ID; in the case of the mid turn section, the rival character ability parameters are 1.3 times the ability parameters of the normal NPC of the same character ID; and, in the case of the late turn section, the rival character ability parameters are 1.5 times the ability parameters of the normal NPC of the same character ID.

When the training target character enters the compatible race, basic rewards are imparted to the player. In addition, when the training target character wins the compatible race against the rival character, additional rewards are imparted to the player in addition to the basic rewards. However, the additional rewards may be imparted when the training target character enters the compatible race regardless of the result of the competition against the rival character. The basic rewards refer to the rewards the player can obtain regardless of the result of the competition against the rival character. The additional rewards refer to the rewards that are imparted to the training target character aside from the basic rewards, and examples thereof include skill clues related to the ground of the compatible race, skill clues related to the distance of the compatible race, and skill clues related to the running style of the training target character.

In addition, the additional rewards may be that a prescribed event is displayed on the display 26. In said prescribed event, for example, the rival character is displayed. In addition, the additional rewards include skill clues and parameters associated with the training target character. Said skill clues may be determined on the basis of the parameters of the training target character, such as the ground aptitude, the distance aptitude, the running style aptitude, etc.

### <Rival-Character-Deployment Notification Processing>

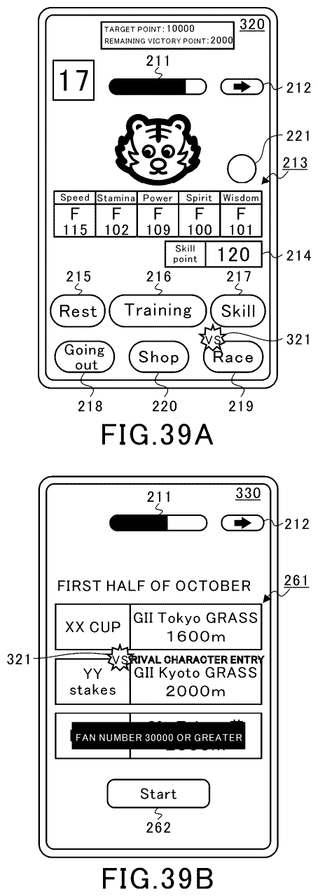

FIG. 39A is a diagram for explaining a rival character deployment notification on a game screen 320. FIG. 39B is a diagram for explaining a rival character deployment notification on an individual-race selection screen 330.

When it is determined that the rival character is deployed by the “rival-character deployment determination processing”, as shown in FIG. 39A, a rival character notification display 321 is displayed in a superimposed manner on the individual race operation portion 219 of the game screen 320.

When the individual race operation portion 219 on which the rival character notification display 321 is displayed is tapped, the individual-race selection screen 330 shown in FIG. 39B is displayed on the display 26. Among the race categories in the individual-race-selection operation portions 266 on the individual-race selection screen 330, the rival character notification display 321 indicated as “rival character entry” is displayed in a superimposed manner on the race category (compatible race) in which it is determined that the rival character is deployed.

Note that, in this embodiment, an example in which, in the case in which it is determined that the rival character is deployed, the rival character notification display 321 shown in FIGS. 39A and 39B is displayed on the display 26 has been described; however, it is not limited thereto and the rival character notification display 321 may include, for example, a text or an image with which the character type of the rival character can be identified.

In this embodiment, when the final turn ends in each of the early turn section, the mid turn section, and the late turn section, a bonus event occurs in the case in which the training target character has achieved prescribed conditions. The prescribed conditions are, for example, that the obtained victory points exceed the target point by a certain amount or more, that the first place is achieved for a prescribed number of times or more in races of a prescribed difficulty level (for example, GI), and that victory is achieved against the rival character for a prescribed number of times or more.

The bonus events include low bonus events and high bonus events and the types of bonus events that occur changes in accordance with the achievement status of the prescribed conditions. The low bonus events refer to, for example, events that increase the level of a unique skill set for the training target character. The high bonus events refer to, for example, events that increase the parameters of the training target character by a prescribed amount and events that increase the skill point by a prescribed amount, in addition to events that increase the level of a unique skill set for the training target character.

In this embodiment, the low bonus events occur in the case in which only basic conditions are met among the prescribed conditions, and the high bonus events occur in the case in which additional conditions are met in addition to the basic conditions among the prescribed conditions. With the high bonus events, the event contents change on the basis of the turn section category.

For example, in the case in which the turn section category is the early turn section, the high bonus event that occurs increases the level of the unique skill set for the training target character, increases one type of parameter randomly selected from among the parameters of the training target character by a prescribed amount (for example, +10), and increases the skill point by a prescribed amount (for example, +20).

In addition, in the case in which the turn section category is the mid turn section, the high bonus event that occurs increases the level of the unique skill set for the training target character, increases all of the parameters of the training target character by a prescribed amount (for example, +5), and increases the skill point by a prescribed amount (for example, +30).

In addition, in the case in which the turn section category is the late turn section, the high bonus event that occurs increases the level of the unique skill set for the training target character, increases all of the parameters of the training target character by a prescribed amount (for example, +10), and increases the skill point by a prescribed amount (for example, +30).

In addition, in this embodiment, aside from the above-described bonus events that occur when the turn sections end, bonus events also occur in the case in which the training target character has satisfied special conditions. An example of the special conditions is that the training target character wins the first place in a specific race among the individual races. Specifically, the special conditions are that the first place is achieved for a prescribed number of times in the individual races for which a specific ground and a specific distance are set, that the first place is achieved for a prescribed number of times in the individual races in a specific region, and that the training target character wins the first place in a specific race among the GI races having a high difficulty level. The bonus events refer to, for example, events that increase the parameters of the training target character by prescribed amounts.

When all of the turns end in the above-described training main game, the training game ends. In addition, in the case in which the player could not achieve the goal set for each of the characters and the target point set for each of the prescribed turn sections in the middle of the training main game, the training game ends at that point in time.

Here, when the training game ends, the training target character that was trained in the training game is stored as a trained character. More strictly, information related to the trained character that was trained in the training game (hereinafter referred to as the trained character information) is stored in association with the player ID. Note that the trained character information is stored in both the player terminal 1 and the server 1000. The trained character information stored in association with the player ID contains the ability parameters, the aptitude parameters, the acquired skills, the inheritance information, etc.

In addition, when the training game ends, evaluation points of the trained character that has been trained are calculated. Here, the evaluation points are calculated on the basis of the ability parameters, the aptitude parameters, the acquired skills, the individual race records, etc. at the point in time at which the training game ended. Note that an evaluation point calculation method, in other words, a calculation formula for calculating the evaluation points, is prepared in advance and the evaluation points are calculated on the basis of a prescribed calculation formula. Note that the evaluation point calculation method and the calculation formula are not particularly limited. For example, the evaluation points may be calculated only on the basis of the parameters that affect the race result when the trained character enters races in the team competition games and other races, such as the ability parameters, the aptitude parameters, and the acquired skills at the point in time at which the training game ended.

In addition, a training rank is set for the trained character on the basis of the evaluation points. The training rank is an indicator that indicates the strength of the trained character, and an evaluation point range is associated with each training rank. For example, the training rank of “A+” is imparted to the trained character having 13000-14499 evaluation points and the training rank of “S” is imparted to the trained character having 14500-15499 evaluation points. Accordingly, as a result of imparting the training rank on the basis of the evaluation points, it becomes easy to ascertain an approximate strength of the trained character. Note that the trained character information also contains the evaluation points and the training rank.

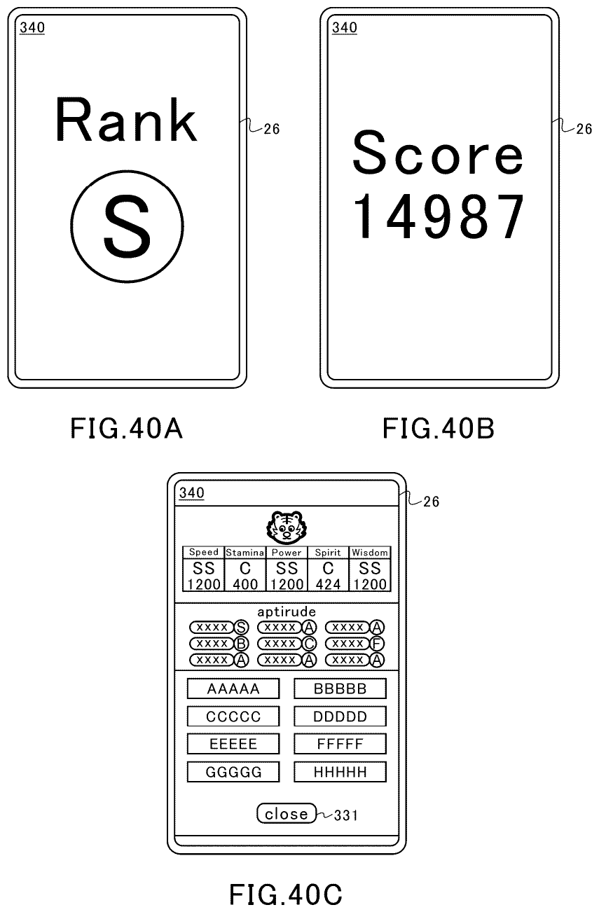

FIG. 40A is a first diagram for explaining a training completion screen 340. FIG. 40B is a second diagram for explaining the training completion screen 340. FIG. 40C is a third diagram for explaining the training completion screen 340. When the training game ends, as shown in FIG. 40A, the training completion screen 340 is displayed on the display 26. On the training completion screen 340, first, the training rank of the trained character that has been trained is displayed, and, subsequently, the evaluation points are displayed, as shown in FIG. 40B.

In addition, when a prescribed amount of time passes after the evaluation points are displayed, as shown in FIG. 40C, the ability parameters, the aptitude parameters, and the acquired skills of the trained character are displayed on the training completion screen 340. At this time, a close operation portion 331 is provided on the training completion screen 340. When the close operation portion 331 is tapped, the training completion screen 340 becomes hidden and the home screen 100 is displayed on the display 26.

Note that, when the training game ends, a lottery is performed to determine the factors that the training target character acquires, and the factor information is stored in association with the trained character. Although the illustration is omitted, on the training completion screen 340, the player can display the factor information acquired by the trained character.

Next, the functional configurations of the player terminal 1 and the server 1000 for executing the above-described training game will be described. Note that, in the following, in particular, the processing related to the group support cards of the training game will be descried in detail and the descriptions of other processing will be omitted.

### (Functional Configuration of the Player Terminal 1)

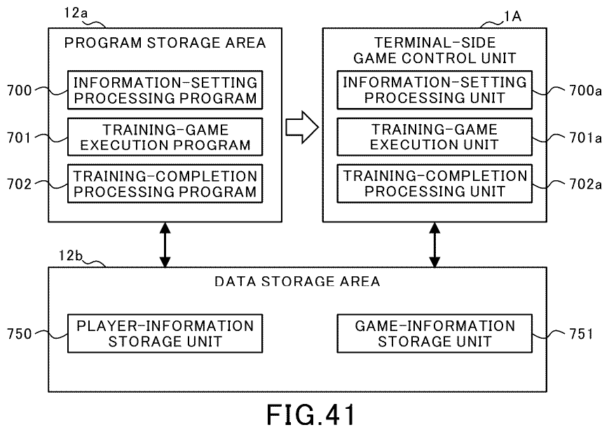

FIG. 41 is a diagram for explaining the configuration of the memory 12 in the player terminal 1 and the function thereof as a computer. The memory 12 is provided with a program storage area 12a and a data storage area 12b. When the game is started, the CPU 10 stores terminal-side game-controlling programs (modules) in the program storage area 12a.

The terminal-side game-controlling programs include an information-setting processing program 700, a training-game execution program 701, and a training-completion processing program 702. Note that the programs listed in FIG. 41 are examples and the terminal-side game-controlling programs are provided with numerous other programs.

The data storage area 12b is provided with a player-information storage unit 750 and a game-information storage unit 751 as storage units that store data. Note that the data storage area 12b is provided with numerous other storage units. Here, information directly related to the game (hereinafter referred to as the game information), such as the training game, is stored in the game-information storage unit 751.

Note that the game-information storage unit 751 also performs temporary storage of various kinds of information during processing of the respective games, such as the training game. Therefore, all information related to the trained character trained in the training game is stored in the game-information storage unit 751. In addition, all information other than the game information, for example, information about the player or other players and setting information of the player terminal 1, is assumed to be player information. The player information is stored in the player-information storage unit 750.

The CPU 10 runs the respective programs stored in the program storage area 12a and updates the data in the respective storage units in the data storage area 12b. Also, the CPU 10 causes the player terminal 1 (computer) to function as a terminal-side game control unit 1A by running the respective programs stored in the program storage area 12a. The terminal-side game control unit 1A contains an information-setting processing unit 700a, a training-game execution unit 701a, and a training-completion processing unit 702a.

Specifically, the CPU 10 runs the information-setting processing program 700 to cause the computer to function as the information-setting processing unit 700a. Similarly, the CPU 10 runs the training-game execution program 701 and the training-completion processing program 702 to cause the computer to function as the training-game execution unit 701a and the training-completion processing unit 702a, respectively.

In the case in which various kinds of information is set in the player terminal 1, the information-setting processing unit 700a stores, as the player information, the information related to the setting in the player-information storage unit 750. In addition, in the case in which the information in the player-information storage unit 750 is updated, the information-setting processing unit 700a transmits the updated information to the server 1000.

The training-game execution unit 701a executes all of the processing related to the training game. Specifically, the training-game execution unit 701a executes the preparation stage processing and the training stage processing.

The training-completion processing unit 702a stores, when the training game is completed, the trained character information containing the ability parameters, the aptitude parameters, the acquired skills, the inheritance information, and the factor information of the trained character, the categories of the characters used in the training, etc.

### (The Functional Configuration of Server 1000)

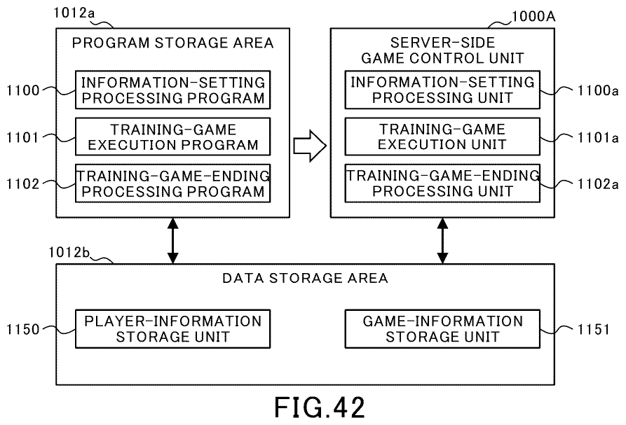

FIG. 42 is a diagram for explaining the configuration of the memory 1012 in the server 1000 and the function thereof as a computer. The memory 1012 is provided with a program storage area 1012a and a data storage area 1012b. When the game is started, the CPU 1010 stores server-side game-controlling programs (modules) in the program storage area 1012a.

The server-side game-controlling programs include an information-setting processing program 1100, a training-game execution program 1101, and a training-game-ending processing program 1102. Note that the programs listed in FIG. 42 are examples and the server-side game-controlling programs are provided with numerous other programs.

The data storage area 1012b is provided with a player-information storage unit 1150 and a game-information storage unit 1151 as storage units that store data. Note that the data storage area 1012b is provided with numerous other storage units. Here, the game information of all of the players is stored in the game-information storage unit 1151 in association with the player IDs. In addition, the player information of all of the players is stored in the player-information storage unit 1150 in association with the player IDs.

The CPU 1010 runs the respective programs stored in the program storage area 1012a and updates the data in the respective storage units in the data storage area 1012b. Also, the CPU 1010 causes the server 1000 (computer) to function as a server-side game control unit 1000A by running the respective programs stored in the program storage area 1012a. The server-side game control unit 1000A contains an information-setting processing unit 1100a, a training-game execution unit 1101a, and a training-game-ending processing unit 1102a.

Specifically, the CPU 1010 runs the information-setting processing program 1100 to cause the computer to function as the information-setting processing unit 1100a. Similarly, the CPU 1010 runs the training-game execution program 1101 and the training-game-ending processing program 1102 to cause the computer to function as the training-game execution unit 1101a and the training-game-ending processing unit 1102a, respectively.

In the case in which various kinds of information is set in the player terminal 1, the information-setting processing unit 1100a updates the player information in the player-information storage unit 1150 on the basis of the updated information received from the player terminal 1. In addition, the information-setting processing unit 1100a keeps track of time and updates the game points of the respective players.

The training-game execution unit 1101a executes all of the processing related to the training game.

When the training game ends, the training-game-ending processing unit 1102a derives, regarding the trained character that was trained, the evaluation points, the training rank, etc. In addition, the training-game-ending processing unit 1102a determines the factors that the trained character acquires by means of a lottery. Also, the game-information storage unit 1151 stores the trained character information containing the ability parameters, the aptitude parameters, the acquired skills, the inheritance information, and the factor information of the trained character, the categories of the characters used in the training, etc. in association with the player ID.

Note that, although the information-setting processing unit 700a in the player terminal 1 and the information-setting processing unit 1100a in the server 1000 have a commonality in that both store the player information, the specific processing contents and the range of the player information to be stored differ from each other. In addition, although the training-game execution unit 701a in the player terminal 1 and the training-game execution unit 1101a in the server 1000 have a commonality in that both executes the processing related to the training game, the roles of the two units, in other words, the scope of allocated tasks are different.

The processing executed by the respective functional units in the above-described player terminal 1 and server 1000 will be described below by employing flowcharts.

### (Processing in the Player Terminal 1 and the Server 1000)

### <Processing Related to the Training Game>

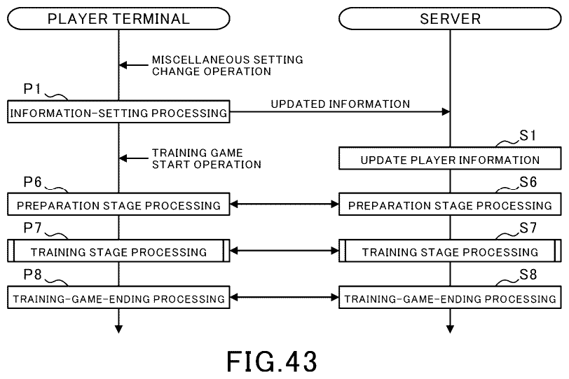

FIG. 43 is a sequence diagram for explaining the processing in the player terminal 1 and the server 1000 related to the training game. Note that, in the following description, the processing in the player terminal 1 will be indicated as Pn (n is an arbitrary integer). In addition, the processing in the server 1000 will be indicated as Sn (n is an arbitrary integer).

When the player performs various kinds of setting change operations in the player terminal 1, the information-setting processing unit 700a of the player terminal 1 performs information-setting processing (P1) for updating the player-information storage unit 750 on the basis of the operation inputs from the player. In this information-setting processing, the updated information is transmitted to the server 1000. In the server 1000, when the updated information is received, the information-setting processing unit 1100a updates the player information in the player-information storage unit 1150 (S1).

Note that the player information updated in P1 and S1 is, for example, the profile information that the player can set. In addition, for example, when an operation for adding another player as a friend or an operation for removing a friend is input as a setting change operation, friend information, which is information related to the friends, is updated. Note that, in P1 and S1, the information-setting processing unit 700a and the information-setting processing unit 1100a respectively manage the game points to be used to execute the training game. In the case in which the game points are less than the upper limit value, the information-setting processing units 700a and 1100a keep track of time and impart a prescribed amount of game points to the player each time a prescribed amount of time passes.

When a training-game start operation for starting the training game is input in the player terminal 1, the training-game execution unit 701a executes preparation stage processing (P6). In addition, during this preparation stage processing, communication processing is performed between the player terminal 1 and the server 1000. In the server 1000, the training-game execution unit 1101a executes preparation stage processing (S6) on the basis of the information received from the player terminal 1. In the preparation stage processing (P6 and S6), the setting and the registration of the training target character and the deck that includes the inheritance characters and the support cards are performed on the basis of the player operations.

When the preparation stage processing (P6) ends, the training-game execution unit 701a executes training stage processing (P7). In addition, during this training stage processing, communication processing is performed between the player terminal 1 and the server 1000. In the server 1000, the training-game execution unit 1101a executes training stage processing (S7) on the basis of the information received from the player terminal 1. Note that, actually, different tasks are allocated to the player terminal 1 and the server 1000, and the training main game proceeds due to the training stage processing (P7) in the player terminal 1 and the training stage processing (S7) in the server 1000.

However, part of or all of the respective processing in the training stage processing (P7) (described later) in the player terminal 1 may be executed in the training stage processing (S7) in the server 1000 or part of or all of the respective processing in the training stage processing (S7) in the server 1000 may be executed in the training stage processing (P7) in the player terminal 1.

When the training stage processing (P7) ends, the training-completion processing unit 702a executes training-game-ending processing (P8) in the player terminal 1. Similarly, when the training stage processing (S7) ends, the training-game-ending processing unit 1102a executes training-game-ending processing (S8) in the server 1000. In the training-game-ending processing (P8, S8), the training target character trained in the training stage processing is saved as a trained character. At this time, the factor information to be imparted to the trained character is determined by means of a lottery and is stored in association with the trained character. In the following, the training stage processing (P7, S7) will be described in detail.

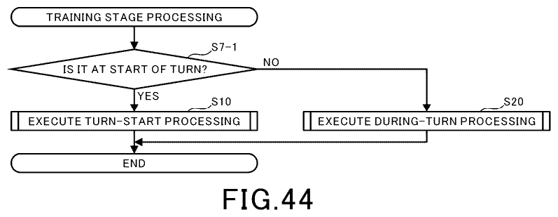

FIG. 44 is a flowchart for explaining the training stage processing in the server 1000. The training-game execution unit 1101a in the server 1000 executes turn-start processing (S10) if it is at the start of a turn (“YES” in S7-1), and executes during-turn processing (S20) if it is not at the start of a turn.

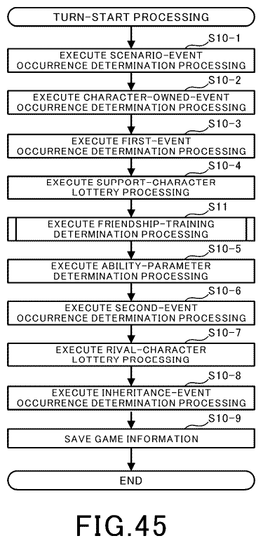

FIG. 45 is a flowchart for explaining the turn-start processing in the server 1000. As shown in FIG. 45, first, the training-game execution unit 1101a in the server 1000 executes scenario-event occurrence determination processing (S10-1). Here, in the case in which there is a scenario event that always occurs in the current turn number, the training-game execution unit 1101a determines that said scenario event occurs. In the case in which there is no scenario event that always occurs in the current turn number, the training-game execution unit 1101a determines, by means of a lottery, whether or not a scenario event occurs and the category of the scenario event that occurs.

In addition, the training-game execution unit 1101a executes character-owned-event occurrence determination processing (S10-2). Here, in the case in which there is a character-owned event that always occurs in the current turn number, the training-game execution unit 1101a determines that said character-owned event occurs. In addition, in the case in which there is no character-owned event that always occurs in the current turn number, the training-game execution unit 1101a determines, by means of a lottery, whether or not a character-owned event occurs and the category of the character-owned event that occurs.

In addition, the training-game execution unit 1101a executes first-event occurrence determination processing (S10-3). Here, at the start of a turn, a random number is acquired and whether or not a first event occurs and the category of the first event that occurs are determined on the basis of the acquired random number and the first event table.

In addition, the training-game execution unit 1101a executes support-character lottery processing (S10-4). Specifically, the training-game execution unit 1101a determines, by means of a lottery, whether or not a support character is deployed in each of the training items with reference to the deployment table shown in FIG. 32. This processing is executed for each of the support characters.

Note that, in the case in which it is determined that a support character is deployed in a training item, the training-game execution unit 1101a associates the support card ID (or the support character ID) with the training ID provided for each of the training items.

In addition, the training-game execution unit 1101a executes friendship-training determination processing (S11) for determining whether or not a friendship training occurs.

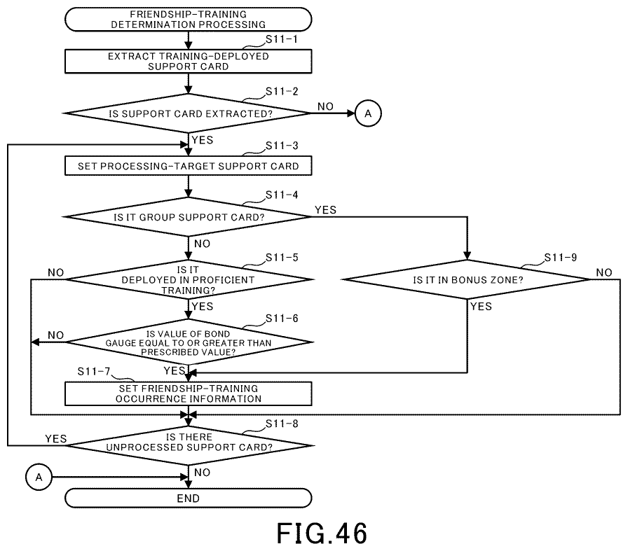

FIG. 46 is a flowchart for explaining the friendship-training determination processing in the server 1000. The training-game execution unit 1101a extracts a support card associated with one of the training items in S10-4 (S11-1). In the case in which a support card is extracted (“YES” in S11-2), the training-game execution unit 1101a sets the support card that serves as the processing target for determining whether or not a friendship training occurs (S11-3).

In the case in which the support card set in S11-3 is not a group support card (“NO” in S11-4), the training-game execution unit 1101a determines whether or not the training item in which said support card is deployed is the proficient training set in said support card (S11-5). In the case in which the support card is deployed in the proficient training (“YES” in S11-5) and the value of the bond gauge of said support card is equal to or greater than a prescribed value (80) (“YES” in S11-6), the training-game execution unit 1101a sets friendship-training occurrence information, which indicates the occurrence of the friendship training, in association with said support card (S11-7).

On the other hand, in the case in which the support card set in S11-3 is a group support card (“YES” in S11-4) and the game is in the bonus zone (“YES” in S11-9) also, the training-game execution unit 1101a sets the friendship-training occurrence information (S11-7). Note that in the case in which there is an unprocessed support card for which the processing from S11-3 to S11-9 has not been executed among the support cards deployed in the training items, the training-game execution unit 1101a repeats the processing from S11-3.

Returning to FIG. 45, the training-game execution unit 1101a executes ability-parameter determination processing (S10-5). The ability-parameter determination processing determines the amounts by which the ability parameters of the training target character increase in the case in which the respective training items are executed and succeed. Specifically, the training-game execution unit 1101a determines, with reference to the training level table shown in FIG. 33A, the fixed increase amount table shown in FIGS. 33B and 33C, and the bonus addition rate table shown in FIG. 33D, the amounts by which the ability parameters of the training target character increase in the case in which the training succeeds, with respect to all of the training items. Accordingly, in the case in which a friendship training has occurred, the amounts by which the ability parameters increase are increased.

In this case, here, the training-game execution unit 1101a determines the amount by which the physical strength decreases or the amount by which the physical strength recovers in the case in which the respective training items are executed, with reference to a physical strength table (not shown). In addition, the training-game execution unit 1101a calculates the training failure rates for the respective training items on the basis of the physical strength of the training target character.

In addition, the training-game execution unit 1101a executes second-event occurrence determination processing (S10-6). Specifically, the training-game execution unit 1101a determines whether or not a second event occurs with reference to the second event table shown in FIG. 34. Specifically, after the support-character lottery processing (S10-4), a random number is acquired and whether or not a second event occurs is determined on the basis of the acquired random number and the second event table. Here, for example, the training-game execution unit 1101a performs an imparting lottery for determining whether or not to allow the occurrence of a support event set in advance in the support card associated with the training item in S10-4.

Note that, here, in the case in which it is determined that a second event occurs, benefits brought about by the occurrence of the second event are determined. At this time, if the game is in the bonus zone, the training-game execution unit 1101a executes computation processing so that the benefits brought about by the occurrence of the second event increase.

In addition, the training-game execution unit 1101a executes rival-character lottery processing (S10-7). Specifically, the training-game execution unit 1101a determines, by means of a lottery, whether or not the rival characters are deployed in the respective compatible races with reference to the deployment table shown in FIG. 38.

In addition, the training-game execution unit 1101a executes inheritance-event occurrence determination processing (S10-8). Specifically, the training-game execution unit 1101a determines that an inheritance event occurs in the case in which the current turn is a factor activation turn. In this case, the training-game execution unit 1101a determines whether or not the respective factors are activated on the basis of the factor information of the inheritance characters registered in the deck in the preparation stage processing in S6. Accordingly, the ability parameters or the aptitude parameters increase and the skill clues are acquired in accordance with the factors determined to be activated.

The training-game execution unit 1101a saves, in the game-information storage unit 1151, game information including information related to the lottery results in S10-1 to S10-8 (S10-9). In addition, the training-game execution unit 1101a executes processing for causing the player terminal 1 to receive the game information saved in the game-information storage unit 1151.

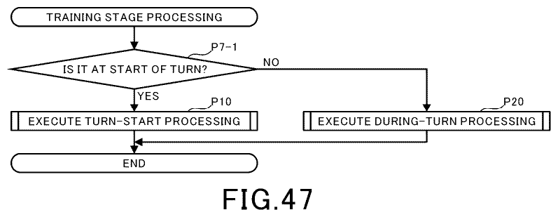

FIG. 47 is a flowchart for explaining the training stage processing in the player terminal 1. The training-game execution unit 701a of the player terminal 1 executes turn-start processing (P10) if the game is at the start of a turn (“YES” in P7-1) and executes during-turn processing (P20) if the game is not at the start of a turn.

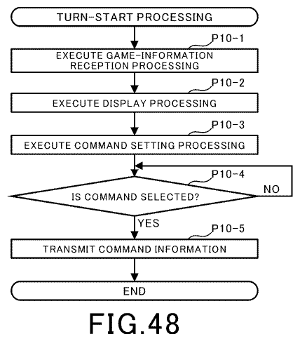

FIG. 48 is a flowchart for explaining the turn-start processing in the player terminal 1. The turn-start processing (P10) in the player terminal 1 starts as a result of the turn-start processing (S10) being executed in the server 1000 and the game information being set in S10-9.

The training-game execution unit 701a accesses the game-information storage unit 1151 in the server 1000 and receives the game information saved in S10-9 from the server 1000 (P10-1). In addition, the training-game execution unit 701a executes display processing (P10-2) for displaying the game screen 210, etc. on the basis of the received game information. Also, the training-game execution unit 701a executes command setting processing (P10-3) for allowing the player to select various kinds of commands related to the training stage processing.

Specifically, the training-game execution unit 701a executes processing for allowing the player to select various kinds of commands, such as the operations of the rest operation portion 215, the training operation portion 216, the skill operation portion 217, the outing operation portion 218, the individual race operation portion 219, the shop operation portion 220, the item operation portion 221, etc., on the basis of the current turn number, for example, with reference to the selection item table shown in FIG. 19. In addition, the training-game execution unit 701a executes processing for allowing the player to select the plurality of individual-race-selection operation portions 266 associated with the individual race operation portion 219.

In addition, in the command processing, the training-game execution unit 701a allows the player to select the commands, such as the operations of the speed operation portion 241, the stamina operation portion 242, the power operation portion 243, the guts operation portion 244, and the intelligence operation portion 245 corresponding to the respective training items, the skill display field 251, the training-target-character selection operation portion 256a, the support-character selection operation portion 256b, one of the first affiliated-character selection operation portion 258a to the fifth affiliated-character selection operation portion 258e, the all-affiliated-character selection operation portion 259, the result operation portion 273, the race operation portion 274, the item-exchange operation portion 303, etc. The training-game execution unit 701a executes processing for allowing the player to select one command from among said plurality of commands.

Note that, as a result of receiving release information (described later) from the server 1000, the training-game execution unit 701a makes it possible to select the all-affiliated-character selection operation portion 259 thereafter.

Subsequently, when the player selects one of the commands (“YES” in P10-4), the training-game execution unit 701a transmits, to the server 1000, command information with which the command that the player has selected can be identified (P10-5).

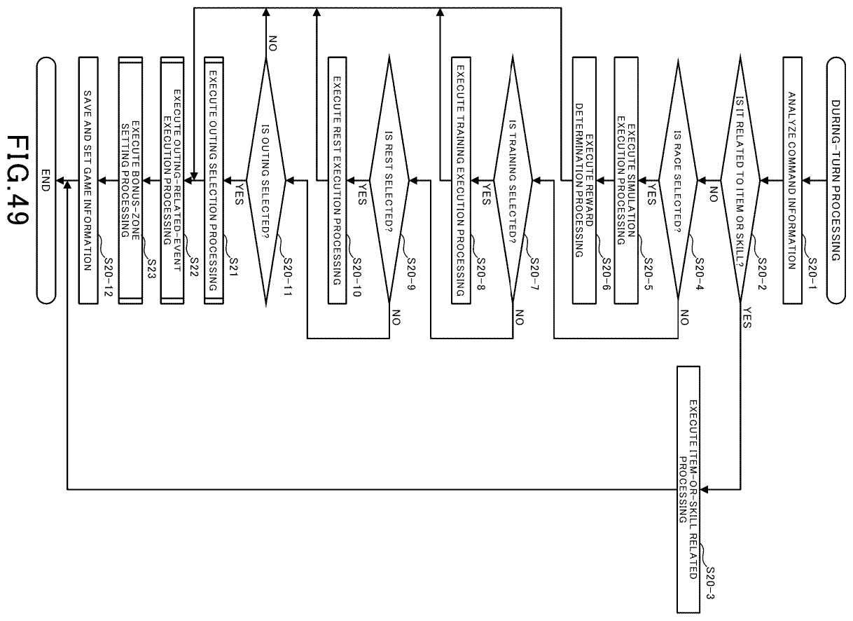

FIG. 49 is a flowchart for explaining the during-turn processing in the server 1000. The during-turn processing (S20) in the server 1000 starts as a result of the turn-start processing (P10) being executed in the player terminal 1 and the command information being transmitted in P10-5.

The training-game execution unit 1101a analyzes the transmitted command information (S20-1). In the case in which command information related to the item or skill acquisition is received (“YES” in S20-2), the training-game execution unit 1101a executes item-and-skill related processing (S20-3) for allowing the acquisition of the items or the skills.

In addition, in the case in which command information related to the race execution is received (“YES” in S20-4), the training-game execution unit 1101a derives the race results by means of the simulation execution processing (S20-5) and determines the rewards (S20-6).

In addition, in the case in which command information indicating one of the training items is received (“YES” in S20-7), the training-game execution unit 1101a executes training execution processing (S20-8). Here, success or failure of the training is determined and the ability parameters are updated. In addition, here, in the case in which a support card is associated with the executed training, processing for updating the value of the bond gauge is executed.

In addition, in the case in which command information indicating the rest operation portion 215 is received (“YES” in S20-9), the training-game execution unit 1101a executes rest execution processing (S20-10). Here, the amount by which the physical strength increases is determined and the determined increase amount is added to the current physical strength.

In addition, in the case in which the outing is selected, in other words, in the case in which command information indicating the training-target-character selection operation portion 256a, the support-character selection operation portion 256b, one of the first affiliated-character selection operation portion 258a to the fifth affiliated-character selection operation portion 258e, or the all-affiliated-character selection operation portion 259 is received (“YES” in S20-11), the training-game execution unit 1101a performs outing selection processing (S21).

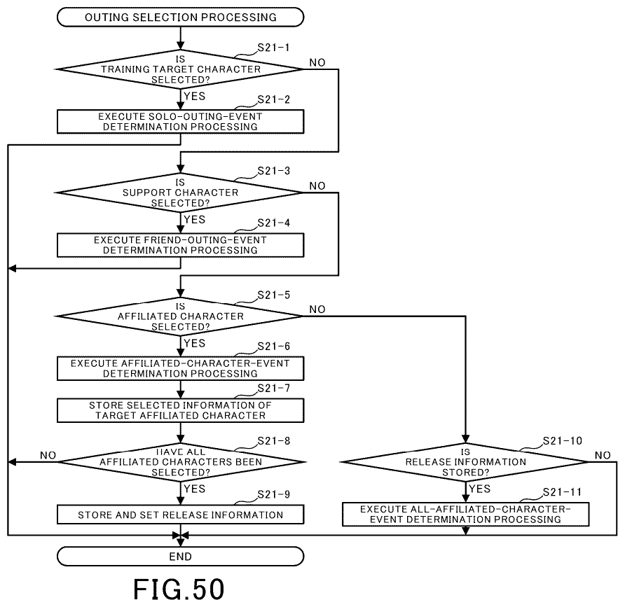

FIG. 50 is a flowchart for explaining the outing selection processing in the server 1000. In the case in which command information indicating the training-target-character selection operation portion 256a is received (“YES” in S21-1), the training-game execution unit 1101a executes solo-outing-event determination processing (S21-2). Here, the solo-outing-event execution pattern is determined. In addition, the parameters are updated on the basis of the determined execution pattern.

In the case in which command information indicating the support-character selection operation portion 256b is received (“YES” in S21-3), the training-game execution unit 1101a executes friend-outing-event determination processing (S21-4). Here, the friend-outing-event execution pattern is determined. In addition, the parameters are updated on the basis of the determined execution pattern.

In addition, in the case in which one of the affiliated characters is selected (“YES” in S21-5), the training-game execution unit 1101a determines the affiliated-character-event execution pattern (S21-6). Here, the parameters are updated on the basis of the determined execution pattern.

In addition, the training-game execution unit 1101a stores selected information of the affiliated character that the player has selected (S21-7). Then, in the case in which the selected information is stored for all of the affiliated characters associated with a group support card (“YES” in S21-8), the training-game execution unit 1101a stores and sets release information indicating the release of the all-affiliated-character selection operation portion 259 (S21-9).

In addition, in the case in which the all-affiliated-character selection operation portion 259 is selected (“NO” in S21-5) and the release information is stored (“YES” in S21-10), the training-game execution unit 1101a determines the all-affiliated-character-event execution pattern (S21-11). Here, the parameters are updated on the basis of the determined execution pattern. In addition, here, in the case in which the occurrence of the all-affiliated-character event is determined for the first time, processing for imparting the owned skills is executed.

Returning to FIG. 49, in the case in which processing associated with the turn ending is executed, outing-related-event execution processing (S22) is executed.

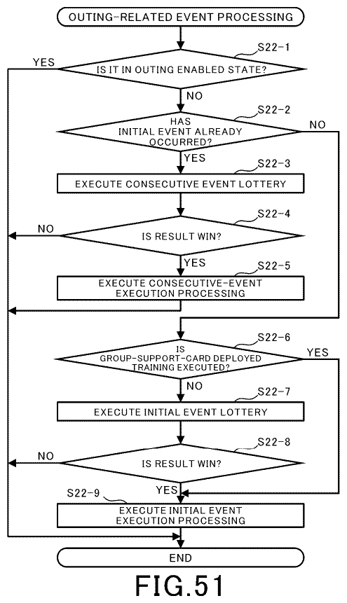

FIG. 51 is a flowchart for explaining the outing-related-event execution processing in the server 1000. In the case in which the outing enabled state has not been achieved (“NO” in S22-1) and an initial event has already occurred (“YES” in S22-2), the training-game execution unit 1101a executes a consecutive event lottery (S22-3). Here, the winning probability of the consecutive event lottery is set on the basis of the current bond gauge value of the group support card. When the consecutive event lottery is won (“YES” in S22-4), the training-game execution unit 1101a executes consecutive-event execution processing (S22-5) for executing a consecutive event.

Accordingly, the consecutive event is executed in the player terminal 1. Note that, although a description of specific processing will be omitted, if the player selects a prescribed option in the player terminal 1 when the consecutive event is executed, the outing enabled state is set in the player terminal 1 and the server 1000.

In addition, in the case in which an initial event has not occurred (“NO” in S22-2), the training-game execution unit 1101a determines whether or not the group-support-card deployed training in S20-8 has been executed (S22-6). In the case in which the group-support-card deployed training has been executed (“YES” in S22-6), the training-game execution unit 1101a executes initial-event execution processing (S22-9) for executing an initial event. Accordingly, the initial event is executed in the player terminal 1.

In the case in which the group-support-card deployed training has not been executed (“NO” in S22-6), the training-game execution unit 1101a executes an initial event lottery (S22-7). In the case in which the initial event lottery is won (“YES” in S22-8), the training-game execution unit 1101a executes the initial-event execution processing (S22-9).

Returning to FIG. 49, the training-game execution unit 1101a executes bonus-zone setting processing (S23), following the outing-related-event execution processing.

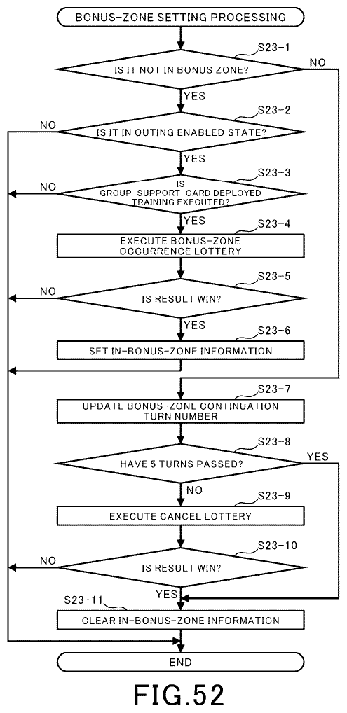

FIG. 52 is a flowchart for explaining the bonus-zone setting processing in the server 1000. In the case in which the game is not in the bonus zone (“YES” in S23-1), the outing enabled state has been set (“YES” in S23-2), and the group-support-card deployed training has been executed (“YES” in S23-3), the training-game execution unit 1101a executes a bonus-zone occurrence lottery (S23-4). When the bonus-zone occurrence lottery is won (“YES” in S23-5), the training-game execution unit 1101a sets in-bonus-zone information indicating that the game is in the bonus zone (S23-6). Note that the in-bonus-zone information may be associated with any one of the training game, the training target character, and the group support card.

In addition, if the game is in the bonus zone (“NO” in S23-1), the training-game execution unit 1101a updates the bonus-zone continuation turn number (S23-7). Here, the number of times the processing for a turn has been executed after the bonus zone has started is counted. If the bonus-zone continuation turn number is 5 (“YES” In S23-8), the training-game execution unit 1101a clears the in-bonus-zone information (S23-11). Accordingly, the bonus zone is canceled, in other words, the bonus zone ends.

In addition, if the bonus-zone continuation turn number is not 5 (“NO” in S23-8), the training-game execution unit 1101a executes a cancel lottery (S23-9). In the case in which the cancel lottery is won (“YES” in S23-10), the training-game execution unit 1101a clears the in-bonus-zone information (S23-11).

Returning to FIG. 49, the training-game execution unit 1101a saves the game information on the basis of the results of each of the above-described processing procedures in the during-turn processing (S20) and causes the player terminal 1 to receive said information.

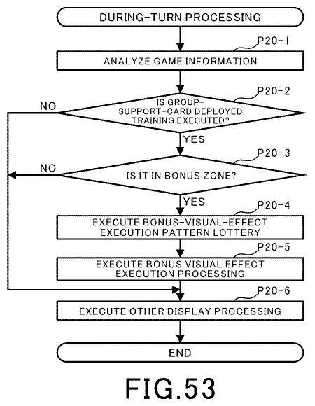

FIG. 53 is a flowchart for explaining the during-turn processing in the player terminal 1. The during-turn processing (P20) in the player terminal 1 starts as a result of the during-turn processing (S20) being executed in the server 1000 and the game information being set in S20-12. The training-game execution unit 701a analyzes the received game information (P20-1). Also, in the case in which the group-support-card deployed training has been executed (“YES” in P20-2) and the game is in the bonus zone (“YES” in P20-3), the bonus-visual-effect execution pattern is determined by means of a lottery (P20-4).

Also, the training-game execution unit 701a executes the bonus visual effect in accordance with the execution pattern determined in P20-4 (P20-5). In addition, the training-game execution unit 701a displays the various kinds of game screens, such as the event screen, on the basis of the analysis results in P20-1 (P20-6). Here, in the case in which the execution patterns of various kinds of events are determined in the server 1000, the training-game execution unit 701a causes the events to occur in accordance with the determined execution patterns.

As a result of the above processing, the above-described training game is realized. Note that the above-described processing procedures in the player terminal 1 and the server 1000 are merely examples. In addition, each of the above-described processing procedures may be executed only in the player terminal 1 or may be executed only in the server 1000.

As above, an aspect of the embodiment has been described with reference to the drawings; however, it is needless to say that the present invention is not limited to the above-described embodiment. It is clear that a person skilled in the art could conceive of various kinds of modifications or corrected examples thereof within the scope of the disclosures in the claims, and it is understood that such modifications or corrected examples also naturally belong to the technical scope of the present invention.

The gaming properties and the processing procedures in the player terminal 1 and the server 1000 described in the above-described embodiment are merely examples. In any case, it suffices that information processing programs cause a computer (in this embodiment, one of or both of the player terminal 1 and the server 1000) to execute the following processing.

### (Processing to be Executed by Computer)

Processing for allowing, in the training game constituted of a plurality of turns, the player to select a plurality of commands (in this embodiment, examples thereof are the respective training items) in each turn (in this embodiment, an example thereof is P10-3).

Processing for associating a game medium (in this embodiment, an example thereof is the support card) associated with the character identification information (in this embodiment, an example thereof is the character ID) with one of the plurality of commands (in this embodiment, an example thereof is S10-4).

Processing for updating the parameters of the training target character on the basis of the command that the player has selected and the game medium associated with the selected command (in this embodiment, an example thereof is S20-8).

Processing for starting a bonus state (in this embodiment, an example thereof is the bonus zone) when start conditions (in this embodiment, examples thereof are that the outing enabled state is achieved, that a group-support-card deployed training is executed, and that the bonus-zone occurrence lottery is won) that include at least that the command associated with the prescribed game medium (in this embodiment, an example thereof is the group support card) is selected are met (in this embodiment, an example thereof is S23-6).

Processing for causing, on the basis of the selection of a command associated with the prescribed game medium during the bonus state, a bonus event (in this embodiment, an example thereof is the friendship training) including the execution of the bonus visual effect and the imparting of the bonuses to occur (in this embodiment, examples thereof are S11-7 and P20-5).

In addition, the following processing may be executed in addition to the above-described processing.

Processing for determining, in the case in which a bonus event occurs, one of a plurality of characters (in this embodiment, examples thereof are the affiliated characters) associated with the prescribed game medium to be the character to be displayed in the bonus visual effect (in this embodiment, an example thereof is P20-4).

Processing for canceling the setting of a specific section when ending conditions (in this embodiment, an example thereof is that the cancel lottery is won or that five turns have passed) that include at least that a prescribed number of turns have passed from when the bonus state is set are met (in this embodiment, an example thereof is S23-11).

Note that in the above-described embodiment, the number and the types of commands that the player can select are merely examples and the designs thereof can be changed, as appropriate.

In addition, in the above-described embodiment, the prescribed game medium is assumed to be the group support card; however, the prescribed game medium is not limited to the group support card. Specifically, the support card with which one character is associated may be set as the prescribed game medium for starting the bonus state.

In addition, the start conditions for starting the bonus zone (bonus state) in the above-described embodiment are merely examples. For example, the bonus zone may always occur in the case in which the training associated with the prescribed game medium is executed regardless of whether or not the outing enabled state has been achieved. In any case, it suffices that the start conditions for starting the bonus state include at least that the command associated with the prescribed game medium is selected, and other conditions can be set, as appropriate.

Therefore, for example, the computer may be caused to execute the processing (in this embodiment, an example thereof is S20-8) for updating a specific parameter (in this embodiment, an example thereof is the bond gauge) on the basis of the selection of the command associated with the prescribed game medium (in this embodiment, an example thereof is the group support card) and the processing for determining whether or not to start the bonus state (in this embodiment, an example thereof is the bonus zone) on the basis of the value of the specific parameter, and the specific section may be started assuming that the start conditions are met in the case in which it is determined that the bonus state starts.

Specifically, in the above-described embodiment, the lottery for determining whether or not the bonus zone starts is performed in the case in which the group-support-card deployed training has been executed, and the bonus zone is started in the case in which said lottery is won. In this case, it is preferable that the winning probability be set so as to increase as the value of the bond gauge increases.

In addition, in the above-described embodiment, it is assumed that, as the bonus event, the friendship training occurs and the bonus visual effect is executed. However, the contents of the bonus event are not limited thereto, and, in addition, the bonuses to be imparted due to the bonus event can also be set as appropriate.

In addition, in the above-described embodiment, it is assumed that the bonus-visual-effect execution pattern (affiliated character to be displayed) is determined by means of a lottery. However, the bonus-visual-effect execution pattern may be just one pattern, and, in addition, in the case in which a plurality of patterns are provided, the execution patterns may be determined according to the order set in advance.

In addition, in the above-described embodiment, the ending conditions for ending the bonus zone are merely examples. For example, the bonus zone may continue until the end of the training game without providing the ending conditions. In addition, the bonus zone may end only in the case in which the cancel lottery is won, without providing the maximum number of turns for which the bonus zone continues. Alternatively, the bonus zone may end only in the case in which a prescribed number of turns have passed without executing the cancel lottery.

In addition, the bonus zone may be managed as a status associated with the training target character or the training game. In addition, whether or not the bonus zone starts may be determined by means of a lottery in the case in which a command other than the training is selected. In addition, for example, selection operations by the player may be involved in starting or ending the bonus zone. In addition, for example, the bonus zone may start at a timing set in advance, such as the number of turns that have passed from the start of the training game and the number of turns that have passed since the outing enabled state has been achieved.

Note that the information processing programs for executing the processing in the above-described embodiment and various kinds of modifications thereof may be stored in a computer-readable, non-transitory storage medium and may be provided in the form of the storage medium. Furthermore, a game terminal device containing said storage medium may be provided. In addition, the above-described embodiment and various kinds of modifications thereof may be employed in an information processing method for realizing the respective functions and the steps shown in the flowcharts.

What is claimed is:

1. A non-transitory computer readable medium storing a program causing a computer to execute:
processing for setting, in a training game including a plurality of turns, a plurality of commands that can be selected by a player, in each of the plurality of turns;
processing for associating one or more game mediums associated with character identification information with one or more of the plurality of commands;
processing for updating a parameter of a training target character on the basis of a command selected by the player among the plurality of commands and a game medium associated with the command selected by the player;
processing for starting a bonus state when a command associated with a prescribed game medium is selected; and
processing for causing, on the basis of the selection of the command associated with the prescribed game medium during the bonus state, a bonus event including the execution of a bonus visual effect and the imparting of a bonus to occur.

2. The non-transitory computer readable medium according to claim 1, wherein the program further causes the computer to execute processing for determining, in the case in which the bonus event occurs, one of a plurality of characters associated with the prescribed game medium to be a character to be displayed in the bonus visual effect, and,
in the bonus visual effect, the determined character is displayed.

3. The non-transitory computer readable medium according to claim 1, wherein the program further causes the computer to execute processing for canceling a setting of a specific section when a prescribed number of turns have passed from when the bonus state is set.

4. The non-transitory computer readable medium according to claim 1, wherein the program further causes the computer to execute:
processing for updating a specific parameter on the basis of the selection of the command associated with the prescribed game medium; and
processing for determining whether or not to start the bonus state on the basis of a value of the specific parameter, and
in the processing for starting the bonus state, a specific section is started when it is determined that the bonus state starts.

5. An information processing method executed by at least one computer, wherein the at least one computer executes:
processing for setting, in a training game including a plurality of turns, a plurality of commands that can be selected by a player, in each of the plurality of turns;
processing for associating one or more game mediums associated with character identification information with one or more of the plurality of commands;
processing for updating a parameter of a training target character on the basis of a command selected by the player among the plurality of commands and a game medium associated with the command selected by the player;
processing for starting a bonus state when a command associated with a prescribed game medium is selected; and
processing for causing, on the basis of the selection of the command associated with the prescribed game medium during the bonus state, a bonus event including the execution of a bonus visual effect and the imparting of a bonus to occur.

6. A gaming device in which at least one computer executes:
processing for setting, in a training game including a plurality of turns, a plurality of commands that can be selected by a player, in each of the plurality of turns;
processing for associating one or more game mediums associated with character identification information with one or more of the plurality of commands;
processing for updating a parameter of a training target character on the basis of a command selected by the player among the plurality of commands and a game medium associated with the command selected by the player;
processing for starting a bonus state when a command associated with a prescribed game medium is selected; and
processing for causing, on the basis of the selection of the command associated with the prescribed game medium during the bonus state, a bonus event including the execution of a bonus visual effect and the imparting of a bonus to occur.
